(19) United States
(12) Patent Application Publication
(10) Pub. No.: US 2026/0230605 A1
(43) Pub. Date: Aug. 6, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Lei ZHAO, Beijing (CN); Kai ZHANG, Los Angeles, CA (US); Li ZHANG, Los Angeles, CA (US)

(21) Appl. No.: 19/575,638

(22) Filed: Mar. 23, 2026

Related U.S. Application Data
(63) Continuation of application No. PCT/CN2024/119535, filed on Sep. 18, 2024.

(30) Foreign Application Priority Data
Sep. 22, 2023 (WO) PCT/CN2023/120892

(51) Int. Cl. H04N 19/107; H04N 19/136; H04N 19/176; H04N 19/70

(52) U.S. Cl. CPC H04N 19/107; H04N 19/136; H04N 19/176; H04N 19/70

(57) ABSTRACT

Embodiments of the present disclosure provide a solution for video processing. A method for video processing is proposed. In the method, for a conversion between a current video block of a video and a bitstream of the video, information regarding applying a subblock-boundary based deblocking or filtering process to the current video block is determined based on a slice type. The conversion is performed based on the information. The information indicates at least one of: whether a kind of subblock-boundary based deblocking or filtering process is applied, or how the kind of subblock-boundary based deblocking or filtering process is applied.

### CROSS-REFERENCE

This application is a continuation of International Application No. PCT/CN2024/119535, filed on Sep. 18, 2024, which claims the benefit of International Application No. PCT/CN2023/120892 filed on Sep. 22, 2023. The entire contents of these applications are hereby incorporated by reference in their entireties.

### FIELDS

Embodiments of the present disclosure relates generally to video processing techniques, and more particularly, to subblock motion compensation in video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a current video block of a video and a bitstream of the video, information regarding applying a subblock-boundary based deblocking or filtering process to the current video block based on a slice type; and performing the conversion based on the information, wherein the information indicates at least one of: whether a kind of subblock-boundary based deblocking or filtering process is applied, or how the kind of subblock-boundary based deblocking or filtering process is applied. The method in accordance with the first aspect of the present disclosure determines whether to and/or how to apply the subblock-boundary based deblocking or filtering process based on the slice type.

In a second aspect, another method for video processing is proposed. The method comprises: determining, for a conversion between a current video block of a video and a bitstream of the video, a usage of at least one of an interweaved affine prediction or a template matching affine based on at least one of: a slice type, a frame type, or a picture order count (POC) distance between a slice or a frame and its nearest reference frame; and performing the conversion based on the usage of the at least one of the interweaved affine prediction or the template matching affine. The method in accordance with the second aspect of the present disclosure enables a usage of interweaved affine prediction or template matching affine based on slice type, frame type or POC.

In a third aspect, another method for video processing is proposed. The method comprises: determining, for a conversion between a current video block of a video and a bitstream of the video, a usage of an interweaved prediction on an affine mode based on a sequence resolution or a frame resolution; and performing the conversion based on the usage of the interweaved prediction. The method in accordance with the third aspect of the present disclosure enables the usage of interweaved prediction on affine mode based on sequence/frame resolution.

In a fourth aspect, an apparatus for video processing is proposed. The apparatus comprises a processor and a non-transitory memory with instructions thereon. The instructions upon execution by the processor, cause the processor to perform a method in accordance with the first, second, or third aspect of the present disclosure.

In a fifth aspect, a non-transitory computer-readable storage medium is proposed. The non-transitory computer-readable storage medium stores instructions that cause a processor to perform a method in accordance with the first, second, or third aspect of the present disclosure.

In a sixth aspect, another non-transitory computer-readable recording medium is proposed. The non-transitory computer-readable recording medium stores a bitstream of a video which is generated by a method performed by an apparatus for video processing. The method comprises: determining information regarding applying a subblock-boundary based deblocking or filtering process to a current video block of the video based on a slice type; and generating the bitstream based on the information, wherein the information indicates at least one of: whether a kind of subblock-boundary based deblocking or filtering process is applied, or how the kind of subblock-boundary based deblocking or filtering process is applied.

In a seventh aspect, another non-transitory computer-readable recording medium is proposed. The non-transitory computer-readable recording medium stores a bitstream of a video which is generated by a method performed by an apparatus for video processing. The method comprises: determining a usage of at least one of an interweaved affine prediction or a template matching affine based on at least one of: a slice type, a frame type, or a picture order count (POC) distance between a slice or a frame and its nearest reference frame; and generating the bitstream based on the usage of the at least one of the interweaved affine prediction or the template matching affine.

In an eighth aspect, another non-transitory computer-readable recording medium is proposed. The non-transitory computer-readable recording medium stores a bitstream of a video which is generated by a method performed by an apparatus for video processing. The method comprises: determining a usage of an interweaved prediction on an affine mode based on a sequence resolution or a frame resolution; and generating the bitstream based on the usage of the interweaved prediction.

In a ninth aspect, a method for storing a bitstream of a video is proposed. The method comprises: determining information regarding applying a subblock-boundary based deblocking or filtering process to a current video block of the video based on a slice type; generating the bitstream based on the information; and storing the bitstream in a non-transitory computer-readable recording medium, wherein the information indicates at least one of: whether a kind of subblock-boundary based deblocking or filtering process is applied, or how the kind of subblock-boundary based deblocking or filtering process is applied.

In a tenth aspect, a method for storing a bitstream of a video is proposed. The method comprises: determining a usage of at least one of an interweaved affine prediction or a template matching affine based on at least one of: a slice type, a frame type, or a picture order count (POC) distance between a slice or a frame and its nearest reference frame; generating the bitstream based on the usage of the at least one of the interweaved affine prediction or the template matching affine; and storing the bitstream in a non-transitory computer-readable recording medium.

In an eleventh aspect, a method for storing a bitstream of a video is proposed. The method comprises: determining a usage of an interweaved prediction on an affine mode based on a sequence resolution or a frame resolution; generating the bitstream based on the usage of the interweaved prediction; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates positions of spatial and temporal neighboring blocks used in AMVP/merge candidate list construction;

FIG. 5 illustrates positions of non-adjacent candidate in ECM;

FIG. 6 illustrates control point based affine motion model;

FIG. 7 illustrates an example affine MVF per subblock;

FIG. 8 illustrates locations of inherited affine motion predictors;

FIG. 9 illustrates control point motion vector inheritance;

FIG. 10 illustrates locations of Candidates position for constructed affine merge mode;

FIG. 11 illustrates spatial neighbors for deriving affine merge candidates;

FIG. 12 illustrates from non-adjacent neighbors to constructed affine merge candidates;

FIG. 13 illustrates an example of generating an HAPC;

FIG. 14 illustrates an illustration of regression based affine merge candidate derivation;

FIG. 15 illustrates template matching performs on a search area around initial MV;

FIG. 16 illustrates template and the corresponding reference template;

FIG. 17 illustrates template and reference template for block with sub-block motion using the motion information of the subblocks of current block;

FIG. 18 illustrates deriving sub-CU motion field obtained by applying a motion shift based on the neighboring motion information;

FIG. 19 illustrates an example of interweaved prediction;

FIG. 20A-FIG. 20G illustrate exemplary dividing patterns for a 16×16 block;

FIG. 21A-FIG. 21D illustrate examples of partial interweaved prediction. Interweaved prediction is not applied on shaded areas;

FIG. 22A-FIG. 22C illustrate examples of deriving MVs for one dividing pattern from another dividing pattern;

FIG. 23A-FIG. 23C illustrate examples of choosing dividing patterns depending on block dimensions;

FIG. 24A and FIG. 24B illustrate examples of deriving MVs of sub-blocks in one component within a dividing pattern from MVs of sub-block in another component within another dividing pattern;

FIG. 25 illustrates examples of CU level OBMC;

FIG. 26 illustrates a flowchart of a method for video processing in accordance with embodiments of the present disclosure;

FIG. 27 illustrates a flowchart of another method for video processing in accordance with embodiments of the present disclosure;

FIG. 28 illustrates a flowchart of another method for video processing in accordance with embodiments of the present disclosure; and

FIG. 29 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment.

Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

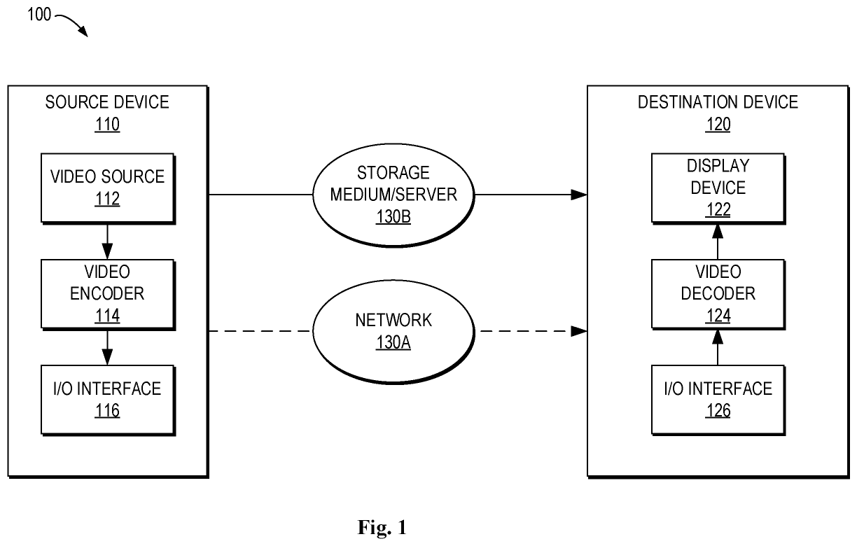

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

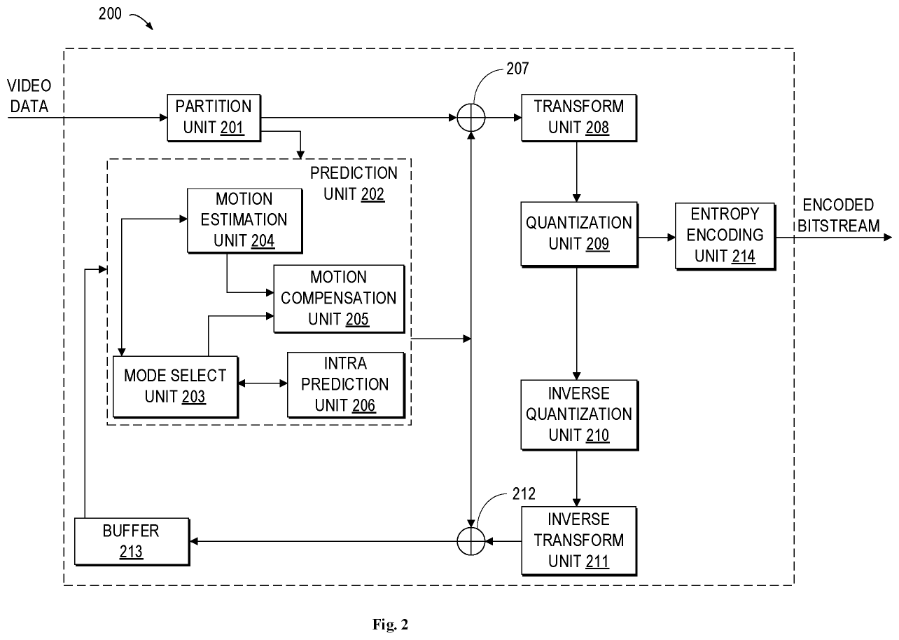

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components.

The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video coding technologies. Specifically, it is about Affine motion prediction method in video coding. The ideas may be applied individually or in various combination, to any video coding standard or non-standard video codec.

### 2. Introduction

The exponential increasing of multimedia data poses a critical challenge for video coding. To satisfy the increasing demands for more efficient compression technology, ITU-T and ISO/IEC have developed a series of video coding standards in the past decades. In particular, the ITU-T produced H.261 and H.263, ISO/IEC produced MPEG-1 and MPEG-4 visual, and the two organizations jointly developed the H.262/MPEG-2 Video, H.264/MPEG-4 Advanced Video Coding (AVC), H.265/HEVC and the latest VVC standards. Since H.262/MPEG-2, hybrid video coding framework is employed wherein in intra/inter prediction plus transform coding are utilized.

### 2.1. MVP in Video Coding

Inter prediction aims to remove the temporal redundancy between adjacent frames, which serves as an indispensable component in the hybrid video coding framework. Specifically, inter prediction makes use of the contents specified by motion vector (MV) as the predicted version of the current to-be-coded block, thus only residual signals and motion information are transmitted in the bitstream. To reduce the cost for MV signaling, motion vector prediction (MVP) came into being as an effective mechanism to convey motion information. Early strategies simply use the MV of a specified neighboring block or the median MV of neighboring blocks as MVP. In H.265/HEVC, competing mechanism was involved where the optimal MVP is selected from multiple candidates through rate distortion optimization (RDO). In particular, advanced MVP (AMVP) mode and merge mode are devised with different motion information signaling strategy. With the AMVP mode, a reference index, a MVP candidate index referring to an AMVP candidate list and motion vector difference (MVD) is signaled. Regarding the merge mode, only a merge index referring to a merge candidate list is signaled, and all the motion information associated with the merge candidate is inherited. Both AMVP mode and merge mode need to construct MVP candidate list, and the details of the construction process for these two modes are described as follows.

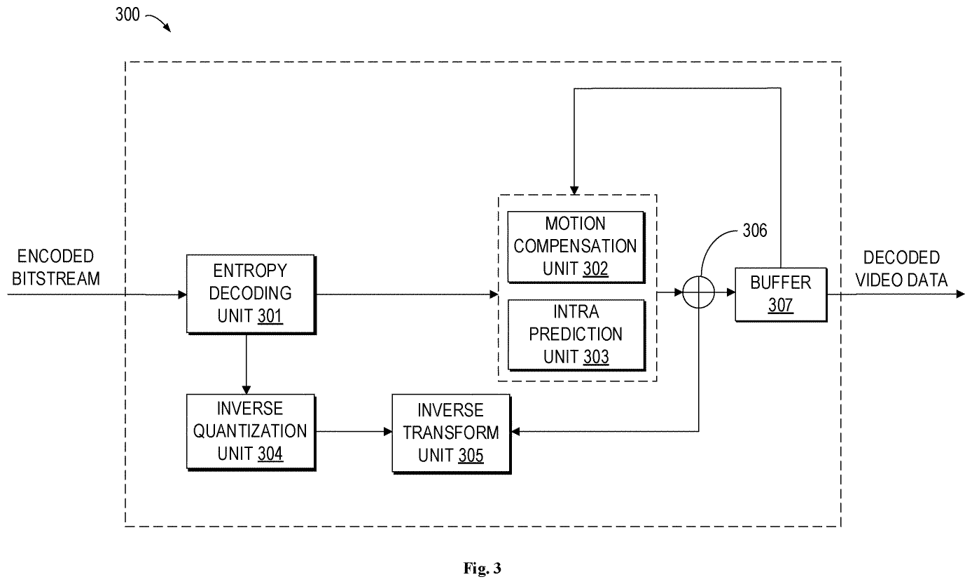

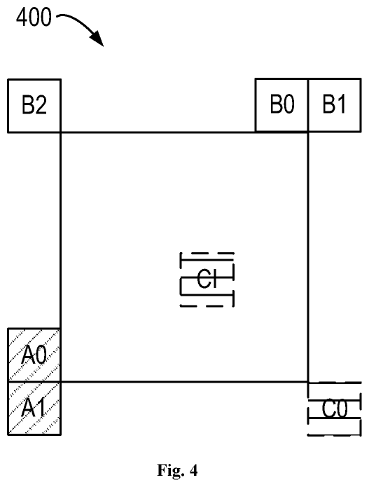

AMVP mode: AMVP exploits spatial-temporal correlation of motion vector with neighboring blocks, which is used for explicit transmission of motion parameters. For each reference picture list, a motion vector candidate list is constructed by firstly checking availability of left, above temporally neighboring positions, removing redundant candidates and adding zero vector to make the candidate list to be constant length. FIG. 4 illustrates positions of spatial and temporal neighboring blocks used in AMVP/merge candidate list construction. For spatial motion vector candidate derivation, two motion vector candidates are eventually derived based on motion vectors of blocks located in five different positions as depicted in FIG. 4. The five neighboring blocks located at B0, B1, B2, and A0, A1 are classified into two groups, where Group A includes the three above spatial neighboring blocks and Group B includes the two left spatial neighboring blocks. The two MV candidates are respectively derived with the first available candidate from Group A and Group B in a predefined order. For temporal motion vector candidate derivation, one motion vector candidate is derived based on two different collocated positions (bottom-right (C0) and central (C1)) checked in order, as depicted in FIG. 4. To avoid redundant MV candidates, duplicated motion vector candidates in the list are abandoned. If the number of potential candidates is smaller than two, additional zero motion vector candidates are added to the list.

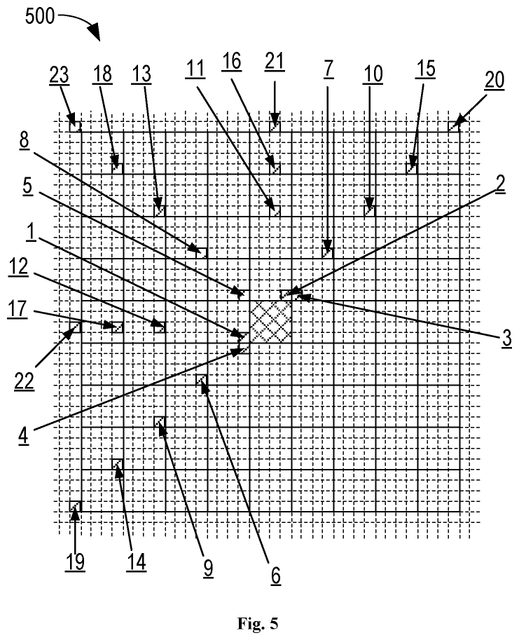

FIG. 5 illustrates positions of non-adjacent candidate in ECM.

Merge mode: Similar to AMVP mode, MVP candidate list for merge mode comprises of spatial and temporal candidates as well. For spatial motion vector candidate derivation, at most four candidates are selected with order A1, B1, B0, A0 and B2 after performing availability and redundant checking. For temporal merge candidate (TMVP) derivation, at most one candidate is selected from two temporal neighboring blocks (C0 and C1). When there are not enough merge candidates with spatial and temporal candidates, combined bi-predictive merge candidates and zero MV candidates are added to MVP candidate list. Once the number of available merge candidates reaches the signaled maximally allowed number, the merge candidate list construction process is terminated.

In VVC, the construction process for merge mode is further improved by introducing the history-based MVP (HMVP), which incorporates the motion information of previously coded blocks which may be far away from current block. In VVC, HMVP merge candidates are appended to merge list after the spatial MVP and TMVP. In this method, the motion information of a previously coded block is stored in a table and used as MVP for the current CU. The table with multiple HMVP candidates is maintained with first-in-first-out strategy during the encoding/decoding process. Whenever there is a non-subblock inter-coded CU, the associated motion information is added to the last entry of the table as a new HMVP candidate.

During the standardization of VVC, Non-adjacent MVP was proposed to facilitate better motion information derivation by exploiting the non-adjacent area. In ECM software, Non-adjacent MVP are inserted between TMVP and HMVP, where the distances between non-adjacent spatial candidates and current coding block are based on the width and height of current coding block as depicted in FIG. 5.

### 2.2. Affine Motion Compensated Prediction

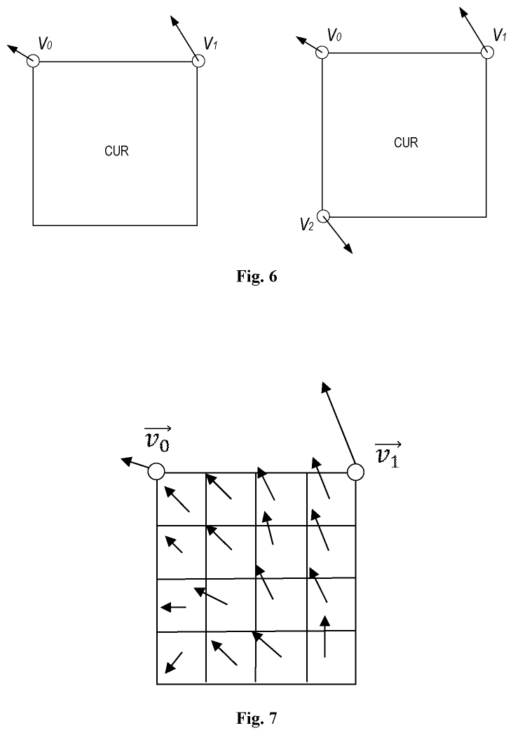

In HEVC, only translation motion model is applied for motion compensation prediction (MCP). While in the real world, there are many kinds of motion, e.g., zoom in/out, rotation, perspective motions and the other irregular motions. In VVC, a block-based affine transform motion compensation prediction is applied. FIG. 6 illustrates control point based affine motion model, for example (a) 4 parameter affine model and (b) 6 parameter affine model. As shown in FIG. 6, the affine motion field of the block is described by motion information of two control point (4-parameter) or three control point motion vectors (6-parameter).

For 4-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{1 y} - {mv}_{0 y}}{W} y + {mv}_{0 x} \\ {mv}_{y} = \frac{{mv}_{1 y} - {mv}_{0 y}}{W} x + \frac{{mv}_{1 y} - {mv}_{0 x}}{W} y + {mv}_{0 y}\end{matrix} . \qquad ( 1 )$$

For 6-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} . \qquad ( 2 )$$

Where (mv0x, mv0y) is motion vector of the top-left corner control point, (mv1x, mv1y) is motion vector of the top-right corner control point, and (mv2x, mv2y) is motion vector of the bottom-left corner control point.

To simplify the motion compensation prediction, block based affine transform prediction is applied. FIG. 7 illustrates an example affine MVF per subblock. To derive motion vector of each 4×4 luma subblock, the motion vector of the center sample of each subblock, as shown in FIG. 7, is calculated according to above equations, and rounded to 1/16 fraction accuracy. Then the motion compensation interpolation filters are applied to generate the prediction of each subblock with derived motion vector. The subblock size of chroma-components is also set to be 4×4. The MV of a 4×4 chroma subblock is calculated as the average of the MVs of the top-left and bottom-right luma subblocks in the collocated 8×8 luma region.

As done for translational motion inter prediction, there are also two affine motion inter prediction modes: affine merge mode and affine AMVP mode.

### 2.2.1. Affine Merge Prediction

Affine merge mode can be applied for CUs with both width and height larger than or equal to 8. In this mode the CPMVs of the current CU is generated based on the motion information of the spatial neighboring CUs. There can be up to five CPMVP candidates and an index is signalled to indicate the one to be used for the current CU. In VVC, the following three types of CPVM candidate are used to form the affine merge candidate list:
Inherited affine merge candidates that extrapolated from the CPMVs of the neighbor CUs.
Constructed affine merge candidates CPMVPs that are derived using the translational MVs of the neighbor CUs.
Zero MVs.

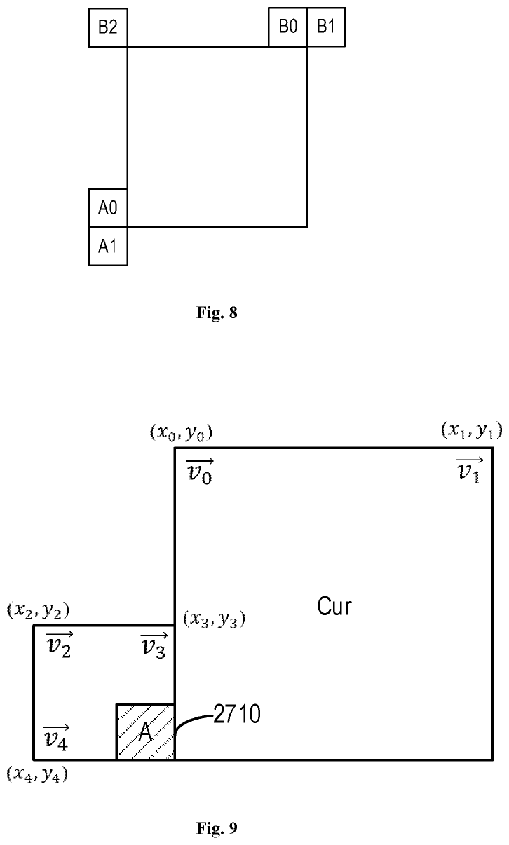

In VVC, there are maximum two inherited affine candidates, which are derived from affine motion model of the neighboring blocks, one from left neighboring CUs and one from above neighboring CUs. FIG. 8 illustrates locations of inherited affine motion predictors. The candidate blocks are shown in FIG. 8. For the left predictor, the scan order is A0→A1, and for the above predictor, the scan order is B0→B1→B2. Only the first inherited candidate from each side is selected. No pruning check is performed between two inherited candidates. When a neighboring affine CU is identified, its control point motion vectors are used to derive the CPMVP candidate in the affine merge list of the current CU. FIG. 9 illustrates control point motion vector inheritance. As shown in FIG. 9, if the neighbor left bottom block A is coded in affine mode, the motion vectors v₂, v₃ and v₄ of the top left corner, above right corner and left bottom corner of the CU which contains the block A are attained. When block A is coded with 4-parameter affine model, the two CPMVs of the current CU are calculated according to v₂, and v₃. In case that block A is coded with 6-parameter affine model, the three CPMVs of the current CU are calculated according to v₂, v₃ and v₄.

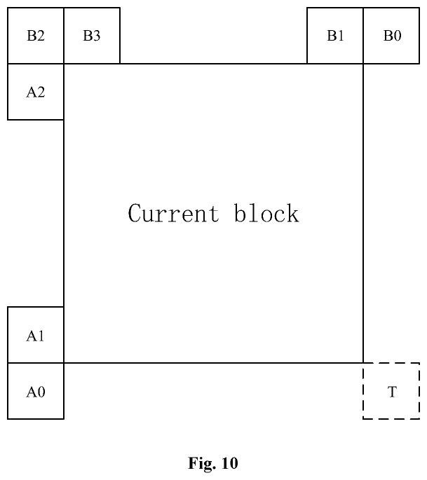

Constructed affine candidate means the candidate is constructed by combining the neighbor translational motion information of each control point. The motion information for the control points is derived from the specified spatial neighbors and temporal neighbor shown in FIG. 10. CPMVk (k=1, 2, 3, 4) represents the k-th control point.

For CPMV1, the B2→B3→A2 blocks are checked and the MV of the first available block is used. For CPMV2, the B1→B0 blocks are checked and for CPMV3, the A1→A0 blocks are checked. For TMVP is used as CPMV4 if it's available.

After MVs of four control points are attained, affine merge candidates are constructed based on those motion information. The following combinations of control point MVs are used to construct in order: {CPMV1, CPMV2, CPMV3}, {CPMV1, CPMV2, CPMV4}, {CPMV1, CPMV3, CPMV4}, {CPMV2, CPMV3, CPMV4}, {CPMV1, CPMV2}, {CPMV1, CPMV3}.

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

FIG. 10 illustrates locations of Candidates position for constructed affine merge mode.

After inherited affine merge candidates and constructed affine merge candidate are checked, if the list is still not full, zero MVs are inserted to the end of the list.

### 2.2.2. Affine AMVP Prediction

Affine AMVP mode can be applied for CUs with both width and height larger than or equal to 16. An affine flag in CU level is signalled in the bitstream to indicate whether affine AMVP mode is used and then another flag is signalled to indicate whether 4-parameter affine or 6-parameter affine. In this mode, the difference of the CPMVs of current CU and their predictors CPMVPs is signalled in the bitstream. The affine AMVP candidate list size is 2 and it is generated by using the following four types of CPVM candidate in order:
Inherited affine AMVP candidates that extrapolated from the CPMVs of the neighbor CUs.
Constructed affine AMVP candidates CPMVPs that are derived using the translational MVs of the neighbor CUs.
Translational MVs from neighboring CUs.
Zero MVs.

The checking order of inherited affine AMVP candidates is same to the checking order of inherited affine merge candidates. The only difference is that, for AMVP candidate, only the affine CU that has the same reference picture as in current block is considered. No pruning process is applied when inserting an inherited affine motion predictor into the candidate list.

Constructed AMVP candidate is derived from the specified spatial neighbors shown in FIG. 10. The same checking order is used as done in affine merge candidate construction. In addition, reference picture index of the neighboring block is also checked. The first block in the checking order that is inter coded and has the same reference picture as in current CUs is used. There is only one When the current CU is coded with 4-parameter affine mode, and mv0 and mv1 are both available, they are added as one candidate in the affine AMVP list. When the current CU is coded with 6-parameter affine mode, and all three CPMVs are available, they are added as one candidate in the affine AMVP list. Otherwise, constructed AMVP candidate is set as unavailable.

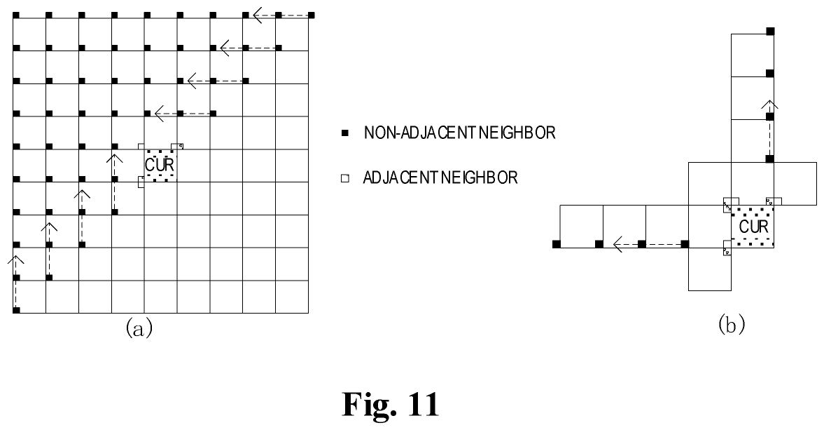

FIG. 11 illustrates spatial neighbors for deriving affine merge candidates: (a) for deriving inherited affine merge candidates (b) for deriving constructed affine merge candidates.

If affine AMVP list candidates are still less than 2 after valid inherited affine AMVP candidates and constructed AMVP candidate are inserted, mv0, mv1 and mv2 will be added, in order, as the translational MVs to predict all control point MVs of the current CU, when available. Finally, zero MVs are used to fill the affine AMVP list if it is still not full.

### 2.2.3. New Affine Candidates Derivation Methods in ECM-8.0

In ECM-6.0, 3 additional Affine merge and AMVP candidate derivation methods are integrated, which are non-adjacent spatial candidates, History-parameter-based candidates, Regression based affine candidates and Pixel based affine motion compensation.

### 2.2.3.1. Non-Adjacent Spatial Candidates

In ECM-6.0, non-adjacent spatial neighbors are investigated to provided candidates for both Affine merge and Affine AMVP. The pattern of obtaining non-adjacent spatial candidates is shown in FIG. 11. Same as the non-adjacent regular merge candidates, the distances between non-adjacent spatial candidates and current coding block are also defined based on the width and height of current CU.

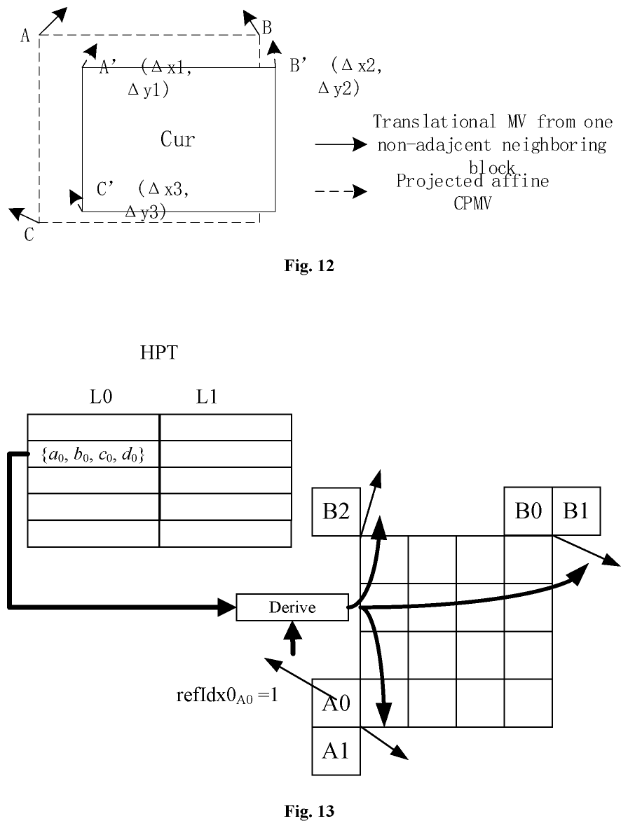

The motion information of the non-adjacent spatial neighbors in FIG. 11 is utilized to generate additional inherited and constructed affine merge candidates. Specifically, to generate inherited candidates, the non-adjacent spatial neighbors are checked based on their distances to the current block, i.e., from near to far. At a specific distance, only the first available neighbor which is coded with Affine mode from each side (e.g., the left and above) of the current block is included. As indicated in (a) of FIG. 11, the checking of the neighbors on the left and above sides are performed from bottom-to-up and right-to-left, respectively. For constructed candidates, as shown in (b) of FIG. 11, the positions of one left and above non-adjacent spatial neighbors are firstly determined independently; After that, the location of the top-left neighbor can be determined accordingly to form a rectangular virtual block together with the left and above non-adjacent neighbors. The motion information of the three non-adjacent neighbors is used to form the CPMVs at the top-left (A), top-right (B) and bottom-left (C) of the virtual block, which is projected to the current CU to generate the corresponding constructed candidates, as shown in FIG. 12.

### 2.2.3.2. History-Parameter-Based Affine Candidates

History-parameter-based affine model inheritance (HAMI) allows the affine model to be inherited from a previously affine-coded block which may not be neighboring to the current block. A history-parameter table (HPT) is established. An entry of HPT stores a set of affine parameters: a, b, c and d, each of which is represented by a 16-bit signed integer. Entries in HPT is categorized by reference list and reference index. Five reference indices are supported for each reference list in HPT. In a formular way, the category of HPT (denoted as HPTCat) is calculated as

$$HPTCat ( RefList , RefIdx ) = 5 \times RefList + min ( RefIdx , 4 ) \qquad ( 3 )$$

wherein RefList and RefIdx represents a reference picture list (0 or 1) and a reference index, respectively. For each category, at most seven entries can be stored, resulting in 70 entries totally in HPT. At the beginning of each CTU row, the number of entries for each category is initialized as zero. After decoding an affine-coded CU with reference list RefListcur and RefIdxcur, the affine parameters are utilized to update entries in the category HPTCat(RefListcur, RefIdxcur) in a way similar to HMVP table updating.

A history-affine-parameter-based candidate (HAPC) is derived from a neighbouring 4×4 block denoted as A0, A1, B0, B1 or B2 in FIG. 13 and a set of affine parameters stored in a corresponding entry in HPT. The MV of a neighbouring 4×4 block served as the base MV. In a formulating way, the MV of the current block at position (x, y) is calculated as:

$$\{ \begin{matrix}{mv}^{h} ( x , y ) = a ( x - {x}_{base} ) + c ( y - {y}_{base} ) + {mv}_{base}^{h} \\ {mv}^{v} ( x , y ) = b ( x - {x}_{base} ) + d ( y - {y}_{base} ) + {mv}_{base}^{v}\end{matrix} \qquad ( 4 )$$

where (mvhbase, mvvbase) represents the MV of the neighbouring 4×4 block, (xbase, ybase) represents the center position of the neighbouring 4×4 block. (x, y) can be the top-left, top-right and bottom-left corner of the current block to obtain the corner-position MVs (CPMVs) for the current block, or it can be the center of the current block to obtain a regular MV for the current block.

FIG. 13 shows an example of how to derive an HAPC from block AG. The affine parameters {a0, b0, c0, d0} are directly fetched from one entry of category HPTIdx(RefListA0, refIdx0A0) in HPT. The affine parameters from HPT, with the center position of AG as the base position, and the MV of block AG as the base MV, are used together to derive the CPMVs for an affine merge HAPC, or an affine AMVP HAPC. They can also be used to derive MVs located at the center of the current block, as regular merge candidates. A HAPC can be put into the sub-block-based merge candidate list, the affine AMVP candidate list or the regular merge candidate list. As a response to new HAPCs being introduced, the size of sub-block-based merge candidate list is increased from five to ten and twelve for random access and low-delay B configurations, respectively. Besides, the size of regular merge candidate list is increased from ten to eleven for random access configurations to accommodate the newly added regular merge candidates.

FIG. 13 illustrates an example of generating an HAPC.

### 2.2.3.3. Regression Based Affine Candidate

In ECM-6.0, the regression based affine merge candidates are derived and added to the affine merge list. Subblock motion field from a previously coded affine CU and motion information from adjacent subblocks of a current CU are used as the input to the regression process to derive proposed affine candidates.

The previously coded affine CU can be identified from scanning through non-adjacent positions and the affine HMVP table. FIG. 14 illustrates an illustration of regression based affine merge candidate derivation. Adjacent subblock information of current CU is fetched from 4×4 sub-blocks represented by the grey zone as depicted in FIG. 14. For each sub-block, given a reference list, the corresponding motion vector and center coordinate of the sub-block may be used.

For each affine CU, up to 2 affine candidates can be derived. One with adjacent subblock information and one without. All the linear-regression-generated candidates are pruned and collected into one candidate sub-group, TM cost based ARMC process is applied when ARMC is enabled. Afterwards, up to N linear-regression-generated candidates are added to the affine merge list when N affine CUs are found.

### 2.2.3.4. Pixel Based Affine Motion Compensation

With pixel based affine motion compensation, minimum affine subblock size is set to lxi for luma component when OBMC is not applied, minimum subblock size is always set to lxi for chroma components.

### 2.3. Template Matching Merge/AMVP Mode in ECM

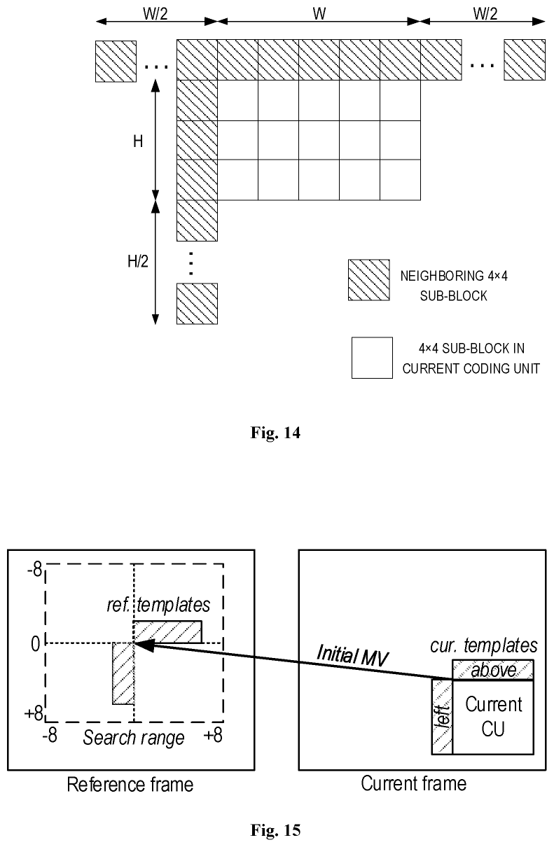

Template matching (TM) merge/AMVP mode is a decoder-side MV derivation method to refine the motion information of the current CU by finding the closest match between a template (i.e., top and/or left neighboring blocks of the current CU) in the current picture and a block (i.e., same size to the template) in a reference picture. FIG. 15 illustrates template matching performs on a search area around initial MV. As illustrated in FIG. 15, a better MV is to be searched around the initial motion of the current CU within a [−8, +8]-pel search range.

In AMVP mode, an MVP candidate is determined based on the template matching error to pick up the one which reaches the minimum difference between the current block and the reference block templates, and then TM performs only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode. This search process ensures that the MVP candidate still keeps the same MV precision as indicated by adaptive motion vector resolution (AMVR) mode after TM process.

In the merge mode, similar search method is applied to the merge candidate indicated by the merge index. TM merge may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check. When BM and TM are both enabled for a CU, the search process of TM stops at half-pel MVD precision and the resulted MVs are further refined by using the same model-based MVD derivation method as in DMVR.

### 2.4. Adaptive Reorder of Merge Candidates (ARMC)

Inspired by the spatial correlation between reconstructed neighboring pixels and the current coding block, adaptive reorder of merge candidates (ARMC) was proposed to refine the candidates order in a given candidate list. The underlying assumption is that the candidates with less template matching cost have higher probability to be chosen through RDO process, hence should be placed in front positions within the list to reduce the signaling cost.

The reordering method is applied to regular merge mode, template matching (TM) merge mode, and affine merge mode (excluding the SbTMVP candidate). For the TM merge mode, merge candidates are reordered before the refinement process.

After a merge candidate list is constructed, merge candidates are divided into several subgroups. The subgroup size is set to 5. Merge candidates in each subgroup are reordered ascendingly according to cost values based on template matching. For simplification, merge candidates in the last but not the first subgroup is not reordered.

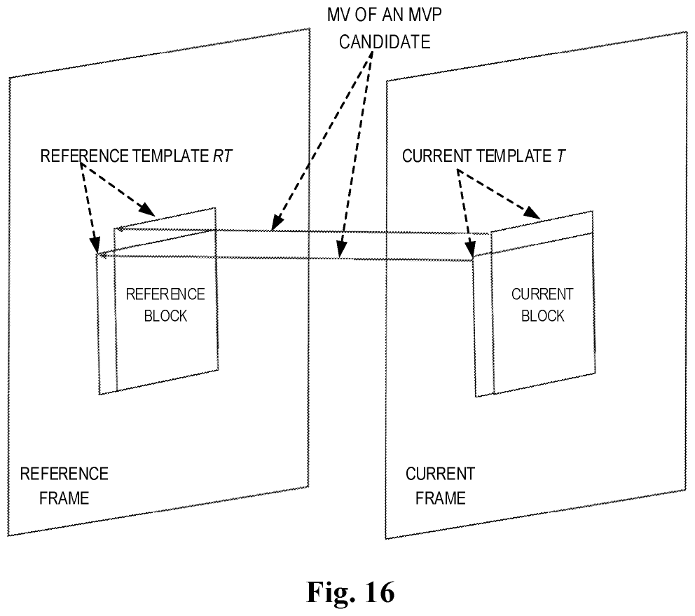

The template matching cost is measured by the sum of absolute differences (SAD) between samples of a template of the current block and their corresponding reference template. FIG. 16 illustrates template and the corresponding reference template. The template comprises a set of reconstructed samples neighboring to the current block, while reference template is located by the same motion information of the current block, as illustrated in FIG. 16. When a merge candidate utilizes bi-directional prediction, the reference samples of the template of the merge candidate are also generated by bi-prediction.

For subblock-based merge candidates with subblock size equal to Wsub*Hsub, the above template comprises several sub-templates with the size of Wsub×K, and the left template comprises several sub-templates with the size of K×Hsub. FIG. 17 illustrates template and reference template for block with sub-block motion using the motion information of the subblocks of current block. As shown in FIG. 17, the motion information of the subblocks in the first row and the first column of current block is used to derive the reference samples of each sub-template.

### 2.5. Subblock-Based Temporal Motion Vector Prediction (SbTMVP)

VVC supports the subblock-based temporal motion vector prediction (SbTMVP) method. Similar to the TMVP, SbTMVP takes advantage of the motion field in the collocated picture to facilitate more precise MVP derivation. The same collocated picture used by TMVP is used for SbTMVP. SbTMVP differs from TMVP mainly in two aspects. Firstly, SbTMVP enables sub-CU level motion prediction whereas TMVP predicts motion at CU level; Secondly, compared with TMVP that fetches the temporal MV from the collocated block in the collocated picture (the collocated block is the bottom-right or center block relative to the current CU), SbTMVP applies a motion shift before fetching the temporal motion information from the collocated picture, where the motion shift is obtained by re-using the MV from one of the spatial neighboring blocks of the current CU.

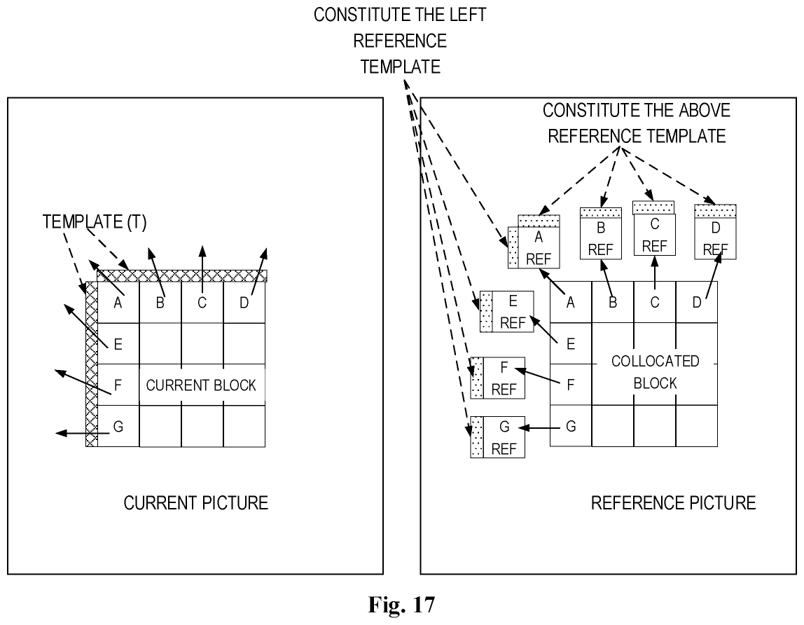

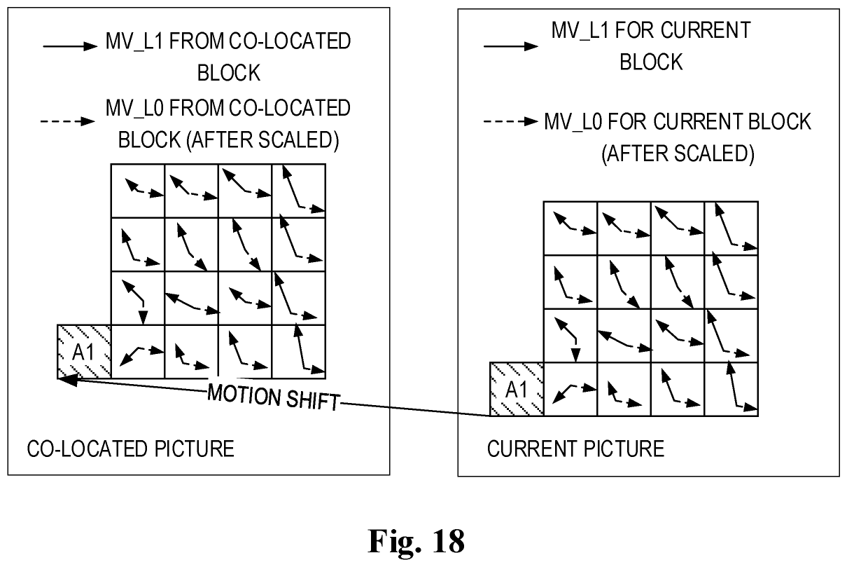

FIG. 18 illustrates the derivation process of the sub-block level motion field for SbTMVP. In particular, the motion information of left-bottom sub-block A1 is firstly fetched, if either of the MVs in reference list0 and list1 points to the collocated frame, then the corresponding MV will be identified as motion shift. Otherwise, zero my will be used as motion shift.

Once the motion shift is determined, the specified region in the collocated frame is employed to derive sub-block level motion field. Assuming A1′ motion is used as motion shift as depicted in FIG. 18. Then for each sub-CU, the motion information of its corresponding block (the smallest motion grid that covers the center sample) in the collocated picture is fetched to provide motion information, where MV scale operation is firstly performed to align the reference frames of the temporal motion vectors to those of the current CU.

In VVC and ECM, in addition to CU level MVP candidate list, a sub-CU level MVP candidate list is also constructed to provide more precise motion prediction for the current CU, which comprises the motion fields produced by both SbTMVP and AFFINE methods. In particular, only one SbTMVP candidate is included and is always placed in the first entry of the constructed sub-CU level MVP candidate list, whereas multiple AFFINE candidates are included in the list after performing template matching-based reordering, where those with smaller costs are placed in fronter positions.

### 2.6. Deblocking Process in VVC

### 8.6.2 Deblocking Filter Process

### 8.6.2.1 General

Inputs to this process are the reconstructed picture prior to deblocking, i.e., the array recPictureL and, when ChromaArrayType is not equal to 0, the arrays recPictureCb and recPictureCr.

Outputs of this process are the modified reconstructed picture after deblocking, i.e., the array recPictureL and, when ChromaArrayType is not equal to 0, the arrays recPictureCb and recPictureCr.

The vertical edges in a picture are filtered first. Then the horizontal edges in a picture are filtered with samples modified by the vertical edge filtering process as input. The vertical and horizontal edges in the CTBs of each CTU are processed separately on a coding unit basis. The vertical edges of the coding blocks in a coding unit are filtered starting with the edge on the left-hand side of the coding blocks proceeding through the edges towards the right-hand side of the coding blocks in their geometrical order. The horizontal edges of the coding blocks in a coding unit are filtered starting with the edge on the top of the coding blocks proceeding through the edges towards the bottom of the coding blocks in their geometrical order.

NOTE—Although the filtering process is specified on a picture basis in this Specification, the filtering process can be implemented on a coding unit basis with an equivalent result, provided the decoder properly accounts for the processing dependency order so as to produce the same output values.

The deblocking filter process is applied to all coding subblock edges and transform block edges of a picture, except the following types of edges:
Edges that are at the boundary of the picture,
Edges that coincide with tile boundaries when loop_filter_across_tiles_enabled_flag is equal to 0,
Edges that coincide with upper or left boundaries of tile groups with tile_group_loop_filter_across_tile_groups_enabled_flag equal to 0 or tile_group_deblocking_filter_disabled_flag equal to 1,
Edges within tile groups with tilegroup_deblocking_filter_disabled_flag equal to 1,
Edges that do not correspond to 8×8 sample grid boundaries of the considered component,
Edges within chroma components for which both sides of the edge use inter prediction,
Edges of chroma transform blocks that are not edges of the associated transform unit.

[Ed. (BB): Adapt syntax once tiles are integrated].

The edge type, vertical or horizontal, is represented by the variable edgeType as specified in Table 8 17.

TABLE 8 17
Name of association to edgeType

| edgeType | Name of edgeType |
|---|---|
| 0 (vertical edge) | EDGE_VER |
| 1 (horizontal edge) | EDGE_HOR |

When tile_group_deblocking_filter_disabled_flag of the current tile group is equal to 0, the following applies:
The variable treeType is derived as follows:
If tile_group_type is equal to I and qtbtt_dual_tree_intra_flag is equal to 1, treeType is set equal to DUAL_TREE_LUMA.
Otherwise, treeType is set equal to SINGLE_TREE.
The vertical edges are filtered by invoking the deblocking filter process for one direction as specified in clause 8.6.2.2 with the variable treeType, the reconstructed picture prior to deblocking, i.e., the array recPictureL and, when ChromaArrayType is not equal to 0 or treeType is equal to SINGLE_TREE, the arrays recPictureCb and recPictureCr, and the variable edgeType set equal to EDGE_VER as inputs, and the modified reconstructed picture after deblocking, i.e., the array recPictureL and, when ChromaArrayType is not equal to 0 or treeType is equal to SINGLE_TREE, the arrays recPictureCb and recPictureCr as outputs.
The horizontal edge are filtered by invoking the deblocking filter process for one direction as specified in clause 8.6.2.2 with the variable treeType, the modified reconstructed picture after deblocking, i.e., the array recPictureL and, when ChromaArrayType is not equal to 0 or treeType is equal to SINGLE_TREE, the arrays recPictureCb and recPictureCr, and the variable edgeType set equal to EDGE_HOR as inputs, and the modified reconstructed picture after deblocking, i.e., the array recPictureL and, when ChromaArrayType is not equal to 0 or treeType is equal to SINGLE_TREE, the arrays recPictureCb and recPictureCr as outputs.
When tile_group_type is equal to I and qtbtt_dual_tree_intra_flag is equal to 1, the following applies:
The variable treeType is set equal to DUAL_TREE_CHROMA.
The vertical edges are filtered by invoking the deblocking filter process for one direction as specified in clause 8.6.2.2 with the variable treeType, the reconstructed picture prior to deblocking, i.e., the arrays recPictureCb and recPictureCr, and the variable edgeType set equal to EDGE_VER as inputs, and the modified reconstructed picture after deblocking, i.e., the arrays recPictureCb and recPictureCr as outputs.
The horizontal edge are filtered by invoking the deblocking filter process for one direction as specified in clause 8.6.2.2 with the variable treeType, the modified reconstructed picture after deblocking, i.e., the arrays recPictureCb and recPictureCr, and the variable edgeType set equal to EDGE_HOR as inputs, and the modified reconstructed picture after deblocking, i.e., the arrays recPictureCb and recPictureCr as outputs.

### 8.6.2.2 Deblocking Filter Process for One Direction

Inputs to this process are:
the variable treeType specifying whether a single tree (SINGLE_TREE) or a dual tree is used to partition the CTUs and, when a dual tree is used, whether the luma (DUAL_TREE_LUMA) or chroma components (DUAL_TREE_CHROMA) are currently processed,
when treeType is equal to SINGLE_TREE or DUAL_TREE_LUMA, the reconstructed picture prior to deblocking, i.e., the array recPictureL,
when ChromaArrayType is not equal to 0 and treeType is equal to SINGLE_TREE or DUAL_TREE_CHROMA, the arrays recPictureCb and recPictureCr,
a variable edgeType specifying whether a vertical (EDGE_VER) or a horizontal (EDGE_HOR) edge is filtered.

Outputs of this process are the modified reconstructed picture after deblocking, i.e:
when treeType is equal to SINGLE_TREE or DUAL_TREE_LUMA, the array recPictureL,
when ChromaArrayType is not equal to 0 and treeType is equal to SINGLE_TREE or DUAL_TREE_CHROMA, the arrays recPictureCb and recPictureCr.

For each coding unit with coding block width log 2CbW, coding block height log 2CbH and location of top-left sample of the coding block (xCb, yCb), when edgeType is equal to EDGE_VER and xCb % 8 is equal 0 or when edgeType is equal to EDGE_HOR and yCb % 8 is equal to 0, the edges are filtered by the following ordered steps:

1. The coding block width nCbW is set equal to 1<<log 2CbW and the coding block height nCbH is set equal to 1<<log 2CbH.

2. The variable filterEdgeFlag is derived as follows:
If edgeType is equal to EDGE_VER and one or more of the following conditions are true, filterEdgeFlag is set equal to 0:
The left boundary of the current coding block is the left boundary of the picture.
The left boundary of the current coding block is the left boundary of the tile and loop_filter_across_tiles_enabled_flag is equal to 0.
The left boundary of the current coding block is the left boundary of the tile group and tile_group_loop_filter_across_tile_groups_enabled_flag is equal to 0.
Otherwise if edgeType is equal to EDGE_HOR and one or more of the following conditions are true, the variable filterEdgeFlag is set equal to 0:
The top boundary of the current luma coding block is the top boundary of the picture.
The top boundary of the current coding block is the top boundary of the tile and loop_filter_across_tiles_enabled_flag is equal to 0.
The top boundary of the current coding block is the top boundary of the tile group and tile_group_loop_filter_across_tile_groups_enabled_flag is equal to 0.
Otherwise, filterEdgeFlag is set equal to 1.

[Ed. (BB): Adapt syntax once tiles are integrated].

3. All elements of the two-dimensional (nCbW)×(nCbH) array edgeFlags are initialized to be equal to zero.

4. The derivation process of transform block boundary specified in clause 8.6.2.3 is invoked with the location (xB0, yB0) set equal to (0, 0), the block width nTbW set equal to nCbW, the block height nTbH set equal to nCbH, the variable treeType, the variable filterEdgeFlag, the array edgeFlags, and the variable edgeType as inputs, and the modified array edgeFlags as output.

5. The derivation process of coding subblock boundary specified in clause 8.6.2.4 is invoked with the location (xCb, yCb), the coding block width nCbW, the coding block height nCbH, the array edgeFlags, and the variable edgeType as inputs, and the modified array edgeFlags as output.

6. The picture sample array recPicture is derived as follows:
If treeType is equal to SINGLE_TREE or DUAL_TREE_LUMA, recPicture is set equal to the reconstructed luma picture sample array prior to deblocking recPictureL.
Otherwise (treeType is equal to DUAL_TREE_CHROMA), recPicture is set equal to the reconstructed chroma picture sample array prior to deblocking recPictureCb.

7. The derivation process of the boundary filtering strength specified in clause 8.6.2.5 is invoked with the picture sample array recPicture, the luma location (xCb, yCb), the coding block width nCbW, the coding block height nCbH, the variable edgeType, and the array edgeFlags as inputs, and an (nCbW)×(nCbH) array verBs as output.

8. The edge filtering process is invoked as follows:
If edgeType is equal to EDGE_VER, the vertical edge filtering process for a coding unit as specified in clause 8.6.2.6.1 is invoked with the variable treeType, the reconstructed picture prior to deblocking, i.e., when treeType is equal to SINGLE_TREE or DUAL_TREE_LUMA, the array recPictureL and, when ChromaArrayType is not equal to 0 and treeType is equal to SINGLE_TREE or DUAL_TREE_CHROMA, the arrays recPictureCb and recPictureCr, the location (xCb, yCb), the coding block width nCbW, the coding block height nCbH, and the array verBs as inputs, and the modified reconstructed picture, i.e., when treeType is equal to SINGLE_TREE or DUAL_TREE_LUMA, the array recPictureL and, when ChromaArrayType is not equal to 0 and treeType is equal to SINGLE_TREE or DUAL_TREE_CHROMA, the arrays recPictureCb and recPictureCr, as output.
Otherwise if edgeType is equal to EDGE_HOR, the horizontal edge filtering process for a coding unit as specified in clause 8.6.2.6.2 is invoked with the variable treeType, the modified reconstructed picture prior to deblocking, i.e., when treeType is equal to SINGLE_TREE or DUAL_TREE_LUMA, the array recPictureL and, when ChromaArrayType is not equal to 0 and treeType is equal to SINGLE_TREE or DUAL_TREE_CHROMA, the arrays recPictureCb and recPictureCr, the location (xCb, yCb), the coding block width nCbW, the coding block height nCbH, and the array horBs as inputs and the modified reconstructed picture, i.e., when treeType is equal to SINGLE_TREE or DUAL_TREE_LUMA, the array recPictureL and, when ChromaArrayType is not equal to 0 and treeType is equal to SINGLE_TREE or DUAL_TREE_CHROMA, the arrays recPictureCb and recPictureCr, as output.

### 8.6.2.3 Derivation Process of Transform Block Boundary

Inputs to this process are:
a location (xB0, yB0) specifying the top-left sample of the current block relative to the top left sample of the current coding block,
a variable nTbW specifying the width of the current block,
a variable nTbH specifying the height of the current block,
a variable treeType specifying whether a single tree (SINGLE_TREE) or a dual tree is used to partition the CTUs and, when a dual tree is used, whether the luma (DUAL_TREE_LUMA) or chroma components (DUAL_TREE_CHROMA) are currently processed,
a variable filterEdgeFlag,
a two-dimensional (nCbW)×(nCbH) array edgeFlags,
a variable edgeType specifying whether a vertical (EDGE_VER) or a horizontal (EDGE_HOR) edge is filtered.

Output of this process is the modified two-dimensional (nCbW)×(nCbH) array edgeFlags.

The maximum transform block size maxTbSize is derived as follows:

$$max TbSize = ( treeType = = DUAL\_TREE \_CHROMA ) ? Max TbSizeY / 2 : Max TbSizeY . \qquad ( 8862 )$$

Depending on maxTbSize, the following applies:
If nTbW is greater than maxTbSize or nTbH is greater than maxTbSize, the following ordered steps apply.

1. The variables newTbW and newTbH are derived as follows:

$$newTbW = ( nTbW > max TbSize ) ? ( nTbW / 2 ) : nTbW \qquad ( 8863 )$$

$$newTbH = ( nTbH > max TbSize ) ? ( nTbH / 2 ) : nTbH . \qquad ( 8864 )$$

2. The derivation process of transform block boundary as specified in this clause is invoked with the location (xB0, yB0), the variables nTbW set equal to newTbW and nTbH set equal to newTbH, the variable filterEdgeFlag, the array edgeFlags, and the variable edgeType as inputs, and the output is the modified version of array edgeFlags.

3. If nTbW is greater than maxTbSize, the derivation process of transform block boundary as specified in this clause is invoked with the luma location (xTb0, yTb0) set equal to (xTb0+newTbW, yTb0), the variables nTbW set equal to newTbW and nTbH set equal to newTbH, the variable filterEdgeFlag, the array edgeFlags and the variable edgeType as inputs, and the output is the modified version of array edgeFlags.

4. If nTbH is greater than maxTbSize, the derivation process of transform block boundary as specified in this clause is invoked with the luma location (xTb0, yTb0) set equal to (xTb0, yTb0+newTbH), the variables nTbW set equal to newTbW and nTbH set equal to newTbH, the variable filterEdgeFlag, the array edgeFlags and the variable edgeType as inputs, and the output is the modified version of array edgeFlags.

5. If nTbW is greater than maxTbSize and nTbH is greater than maxTbSize, the derivation process of transform block boundary as specified in this clause is invoked with the luma location (xTb0, yTb0) set equal to (xTb0+newTbW, yTb0+newTbH), the variables nTbW set equal to newTbW and nTbH set equal to newTbH, the variable filterEdgeFlag, the array edgeFlags and the variable edgeType as inputs, and the output is the modified version of array edgeFlags.
Otherwise, the following applies:
If edgeType is equal to EDGE_VER, the value of edgeFlags[xB0][yB0+k] for k=0 . . . nTbH−1 is derived as follows:
If xB0 is equal to 0, edgeFlags[xB0][yB0+k] is set equal to filterEdgeFlag.
Otherwise, edgeFlags[xB0][yB0+k] is set equal to 1.
Otherwise (edgeType is equal to EDGE_HOR), the value of edgeFlags[xB0+k][yB0] for k=0 . . . nTbW−1 is derived as follows:
If yB0 is equal to 0, edgeFlags[xB0+k][yB0] is set equal to filterEdgeFlag.
Otherwise, edgeFlags[xB0+k][yB0] is set equal to 1.

### 8.6.2.4 Derivation Process of Coding Subblock Boundary

Inputs to this process are:
a location (xCb, yCb) specifying the top-left sample of the current coding block relative to the top-left sample of the current picture,
a variable nCbW specifying the width of the current coding block,
a variable nCbH specifying the height of the current coding block,
a two-dimensional (nCbW)×(nCbH) array edgeFlags,
a variable edgeType specifying whether a vertical (EDGE_VER) or a horizontal (EDGE_HOR) edge is filtered.

Output of this process is the modified two-dimensional (nCbW)×(nCbH) array edgeFlags.

The number of coding subblock in horizontal direction numSbX and in vertical direction numSbY are derived as follows:
If CuPredMode[xCb][yCb]==MODE_INTRA, numSbX and numSbY are both set equal to 1.
Otherwise, numSbX and numSbY are set equal to NumSbX[xCb][yCb] and NumSbY[xCb][yCb], respectively.

Depending on the value of edgeType the following applies:
If edgeType is equal to EDGE_VER and numSbX is greater than 1, the following applies for i=1 . . . min((nCbW/8)−1, numSbX−1), k=0 . . . nCbH−1:

$$edgeFlags [ i * Max ( 8 , nCbW / numSbX ) ] [ k ] = 1. \qquad ( 8865 )$$

Otherwise if edgeType is equal to EDGE_HOR and numSbY is greater than 1, the following applies for j=1 . . . min((nCbH/8)−1, numSbY−1), k=0 . . . nCbW−1:

$$edgeFlags [ k ] [ j * Max ( 8 , nCbH / numSbY ) ] = 1. \qquad ( 8866 )$$

### 8.6.2.5 Derivation Process of Boundary Filtering Strength

Inputs to this process are:
a picture sample array recPicture,
a location (xCb, yCb) specifying the top-left sample of the current coding block relative to the top-left sample of the current picture,
a variable nCbW specifying the width of the current coding block,
a variable nCbH specifying the height of the current coding block,
a variable edgeType specifying whether a vertical (EDGE_VER) or a horizontal (EDGE_HOR) edge is filtered,
a two-dimensional (nCbW)×(nCbH) array edgeFlags.

Output of this process is a two-dimensional (nCbW)×(nCbH) array bS specifying the boundary filtering strength.

The variables xDi, yDj, xN and yN are derived as follows:
If edgeType is equal to EDGE_VER, xDi is set equal to (i<<3), yDj is set equal to (j<<2), xN is set equal to Max(0, (nCbW/8)−1) and yN is set equal to (nCbH/4)−1.
Otherwise (edgeType is equal to EDGE_HOR), xDi is set equal to (i<<2), yDj is set equal to (j<<3), xN is set equal to (nCbW/4)−1 and yN is set equal to Max(0, (nCbH/8)−1).

For xDi with i=0 . . . xN and yDj with j=0 . . . yN, the following applies:
If edgeFlags[xDi][yDj] is equal to 0, the variable bS[xDi][yDj] is set equal to 0.
Otherwise, the following applies:
The sample values p0 and q0 are derived as follows:
If edgeType is equal to EDGE_VER, p0 is set equal to recPicture [xCb+xDi−1][yCb+yDj] and q0 is set equal to recPicture [xCb+xDi][yCb+yDj].
Otherwise (edgeType is equal to EDGE_HOR), p0 is set equal to recPicture [xCb+xDi][yCb+yDj−1] and q0 is set equal to recPicture [xCb+xDi][yCb+yDj].
The variable bS [xDi][yDj] is derived as follows:
If the sample p0 or q0 is in the coding block of a coding unit coded with intra prediction mode, bS[xDi][yDj] is set equal to 2.
Otherwise, if the block edge is also a transform block edge and the sample p0 or q0 is in a transform block which contains one or more non-zero transform coefficient levels, bS [xDi][yDj] is set equal to 1.
Otherwise, if one or more of the following conditions are true, bS[xDi][yDj] is set equal to 1:
For the prediction of the coding subblock containing the sample p0 different reference pictures or a different number of motion vectors are used than for the prediction of the coding subblock containing the sample q0.

NOTE 1—The determination of whether the reference pictures used for the two coding subblocks are the same or different is based only on which pictures are referenced, without regard to whether a prediction is formed using an index into reference picture list 0 or an index into reference picture list 1, and also without regard to whether the index position within a reference picture list is different.

NOTE 2—The number of motion vectors that are used for the prediction of a coding subblock with top-left sample covering (xSb, ySb), is equal to PredFlagL0[xSb][ySb]+PredFlagL1[xSb][ySb].
One motion vector is used to predict the coding subblock containing the sample p0 and one motion vector is used to predict the coding subblock containing the sample q0, and the absolute difference between the horizontal or vertical component of the motion vectors used is greater than or equal to 4 in units of quarter luma samples.
Two motion vectors and two different reference pictures are used to predict the coding subblock containing the sample p0, two motion vectors for the same two reference pictures are used to predict the coding subblock containing the sample q0 and the absolute difference between the horizontal or vertical component of the two motion vectors used in the prediction of the two coding subblocks for the same reference picture is greater than or equal to 4 in units of quarter luma samples.
Two motion vectors for the same reference picture are used to predict the coding subblock containing the sample p0, two motion vectors for the same reference picture are used to predict the coding subblock containing the sample q0 and both of the following conditions are true:
The absolute difference between the horizontal or vertical component of list 0 motion vectors used in the prediction of the two coding subblocks is greater than or equal to 4 in quarter luma samples, or the absolute difference between the horizontal or vertical component of the list 1 motion vectors used in the prediction of the two coding subblocks is greater than or equal to 4 in units of quarter luma samples.
The absolute difference between the horizontal or vertical component of list 0 motion vector used in the prediction of the coding subblock containing the sample p0 and the list 1 motion vector used in the prediction of the coding subblock containing the sample q0 is greater than or equal to 4 in units of quarter luma samples, or the absolute difference between the horizontal or vertical component of the list 1 motion vector used in the prediction of the coding subblock containing the sample p0 and list 0 motion vector used in the prediction of the coding subblock containing the sample q0 is greater than or equal to 4 in units of quarter luma samples.
Otherwise, the variable bS [xDi][yDj] is set equal to 0.

### 8.6.2.6 Edge Filtering Process

### 8.6.2.6.1 Vertical Edge Filtering Process

Inputs to this process are:
a variable treeType specifying whether a single tree (SINGLE_TREE) or a dual tree is used to partition the CTUs and, when a dual tree is used, whether the luma (DUAL_TREE_LUMA) or chroma components (DUAL_TREE_CHROMA) are currently processed,
when treeType is equal to SINGLE_TREE or DUAL_TREE_LUMA, the reconstructed picture prior to deblocking, i.e., the array recPictureL,
when ChromaArrayType is not equal to 0 and treeType is equal to SINGLE_TREE or DUAL_TREE_CHROMA, the arrays recPictureCb and recPictureCr,
a location (xCb, yCb) specifying the top-left sample of the current coding block relative to the top-left sample of the current picture,
a variable nCbW specifying the width of the current coding block,
a variable nCbH specifying the height of the current coding block.

Outputs of this process are the modified reconstructed picture after deblocking, i.e:
when treeType is equal to SINGLE_TREE or DUAL_TREE_LUMA, the array recPictureL,
when ChromaArrayType is not equal to 0 and treeType is equal to SINGLE_TREE or DUAL_TREE_CHROMA, the arrays recPictureCb and recPictureCr.

When treeType is equal to SINGLE_TREE or DUAL_TREE_LUMA, the filtering process for edges in the luma coding block of the current coding unit consists of the following ordered steps:

1. The variable xN is set equal to Max(0, (nCbW/8)−1) and yN is set equal to (nCbH/4)−1.

2. For xDk equal to k<<3 with k=0 . . . nN and yDm equal to m<<2 with m=0 . . . yN, the following applies:
When bS[xDk][yDm] is greater than 0, the following ordered steps apply:
a. The decision process for block edges as specified in clause 8.6.2.6.3 is invoked with treeType, the picture sample array recPicture set equal to the luma picture sample array recPictureL, the location of the luma coding block (xCb, yCb), the luma location of the block (xDk, yDm), a variable edgeType set equal to EDGE_VER, the boundary filtering strength bS[xDk][yDm], and the bit depth bD set equal to BitDepthY as inputs, and the decisions dE, dEp and dEq, and the variable tC as outputs.
b. The filtering process for block edges as specified in clause 8.6.2.6.4 is invoked with the picture sample array recPicture set equal to the luma picture sample array recPictureL, the location of the luma coding block (xCb, yCb), the luma location of the block (xDk, yDm), a variable edgeType set equal to EDGE_VER, the decisions dE, dEp and dEq, and the variable tC as inputs, and the modified luma picture sample array recPictureL as output.

When ChromaArrayType is not equal to 0 and treeType is equal to SINGLE_TREE the filtering process for edges in the chroma coding blocks of current coding unit consists of the following ordered steps:

1. The variable xN is set equal to Max(0, (nCbW/8)−1) and yN is set equal to Max(0, (nCbH/8)−1).

2. The variable edgeSpacing is set equal to 8/SubWidthC.

3. The variable edgeSections is set equal to yN*(2/SubHeightC).

4. For xDk equal to k*edgeSpacing with k=0 . . . xN and yDm equal to m<<2 with m=0 . . . edgeSections, the following applies:
When bS[xDk*SubWidthC][yDm*SubHeightC] is equal to 2 and (((xCb/SubWidthC+xDk)

3)<<3) is equal to xCb/SubWidthC+xDk, the following ordered steps apply:
a. The filtering process for chroma block edges as specified in clause 8.6.2.6.5 is invoked with the chroma picture sample array recPictureCb, the location of the chroma coding block (xCb/SubWidthC, yCb/SubHeightC), the chroma location of the block (xDk, yDm), a variable edgeType set equal to EDGE_VER and a variable cQpPicOffset set equal to pps_cb_qp_offset as inputs, and the modified chroma picture sample array recPictureCb as output.
b. The filtering process for chroma block edges as specified in clause 8.6.2.6.5 is invoked with the chroma picture sample array recPictureCr, the location of the chroma coding block (xCb/SubWidthC, yCb/SubHeightC), the chroma location of the block (xDk, yDm), a variable edgeType set equal to EDGE_VER and a variable cQpPicOffset set equal to pps_cr_qp_offset as inputs, and the modified chroma picture sample array recPictureCr as output.

When treeType is equal to DUAL_TREE_CHROMA, the filtering process for edges in the two chroma coding blocks of the current coding unit consists of the following ordered steps:

1. The variable xN is set equal to Max(0, (nCbW/8)−1) and yN is set equal to (nCbH/4)−1.

2. For xDk equal to k<<3 with k=0 . . . xN and yDm equal to m<<2 with m=0 . . . yN, the following applies:
When bS[xDk][yDm] is greater than 0, the following ordered steps apply:
a. The decision process for block edges as specified in clause 8.6.2.6.3 is invoked with treeType, the picture sample array recPicture set equal to the chroma picture sample array recPictureCb, the location of the chroma coding block (xCb, yCb), the location of the chroma block (xDk, yDm), a variable edgeType set equal to EDGE_VER, the boundary filtering strength bS[xDk][yDm], and the bit depth bD set equal to BitDepthC as inputs, and the decisions dE, dEp and dEq, and the variable tC as outputs.
b. The filtering process for block edges as specified in clause 8.6.2.6.4 is invoked with the picture sample array recPicture set equal to the chroma picture sample array recPictureCb, the location of the chroma coding block (xCb, yCb), the chroma location of the block (xDk, yDm), a variable edgeType set equal to EDGE_VER, the decisions dE, dEp and dEq, and the variable tC as inputs, and the modified chroma picture sample array recPictureCb as output.
c. The filtering process for block edges as specified in clause 8.6.2.6.4 is invoked with the picture sample array recPicture set equal to the chroma picture sample array recPictureCr, the location of the chroma coding block (xCb, yCb), the chroma location of the block (xDk, yDm), a variable edgeType set equal to EDGE_VER, the decisions dE, dEp and dEq, and the variable tC as inputs, and the modified chroma picture sample array recPictureCr as output.

### 8.6.2.6.2 Horizontal Edge Filtering Process

Inputs to this process are:
a variable treeType specifying whether a single tree (SINGLE_TREE) or a dual tree is used to partition the CTUs and, when a dual tree is used, whether the luma (DUAL_TREE_LUMA) or chroma components (DUAL_TREE_CHROMA) are currently processed,
when treeType is equal to SINGLE_TREE or DUAL_TREE_LUMA, the reconstructed picture prior to deblocking, i.e., the array recPictureL,
when ChromaArrayType is not equal to 0 and treeType is equal to SINGLE_TREE or DUAL_TREE_CHROMA, the arrays recPictureCb and recPictureCr,
a location (xCb, yCb) specifying the top-left sample of the current coding block relative to the top-left sample of the current picture,
a variable nCbW specifying the width of the current coding block,
a variable nCbH specifying the height of the current coding block.

Outputs of this process are the modified reconstructed picture after deblocking, i.e:
when treeType is equal to SINGLE_TREE or DUAL_TREE_LUMA, the array recPictureL,
when ChromaArrayType is not equal to 0 and treeType is equal to SINGLE_TREE or DUAL_TREE_CHROMA, the arrays recPictureCb and recPictureCr.

When treeType is equal to SINGLE_TREE or DUAL_TREE_LUMA, the filtering process for edges in the luma coding block of the current coding unit consists of the following ordered steps:

1. The variable yN is set equal to Max(0, (nCbH/8)−1) and xN is set equal to (nCbW/4)−1.

2. For yDm equal to m<<3 with m=0 . . . yN and xDk equal to k<<2 with k=0 . . . xN, the following applies:
When bS[xDk][yDm] is greater than 0, the following ordered steps apply:
a. The decision process for block edges as specified in clause 8.6.2.6.3 is invoked with treeType, the picture sample array recPicture set equal to the luma picture sample array recPictureL, the location of the luma coding block (xCb, yCb), the luma location of the block (xDk, yDm), a variable edgeType set equal to EDGE_HOR, the boundary filtering strength bS[xDk][yDm], and the bit depth bD set equal to BitDepthY as inputs, and the decisions dE, dEp and dEq, and the variable tC as outputs.
b. The filtering process for block edges as specified in clause 8.6.2.6.4 is invoked with the picture sample array recPicture set equal to the luma picture sample array recPictureL, the location of the luma coding block (xCb, yCb), the luma location of the block (xDk, yDm), a variable edgeType set equal to EDGE_HOR, the decisions dEp, dEp and dEq, and the variable tC as inputs, and the modified luma picture sample array recPictureL as output.

When ChromaArrayType is not equal to 0 and treeType is equal to SINGLE_TREE the filtering process for edges in the chroma coding blocks of current coding unit consists of the following ordered steps:

1. The variable xN is set equal to Max(0, (nCbW/8)−1) and yN is set equal to Max(0, (nCbH/8)−1).

2. The variable edgeSpacing is set equal to 8/SubHeightC.

3. The variable edgeSections is set equal to xN*(2/SubWidthC).

4. For yDm equal to m*edgeSpacing with m=0 . . . yN and xDk equal to k<<2 with k=0 . . . edgeSections, the following applies:
When bS[xDk*SubWidthC][yDm*SubHeightC] is equal to 2 and (((yCb/SubHeightC+yDm)>>3)<<3) is equal to yCb/SubHeightC+yDm, the following ordered steps apply:
a. The filtering process for chroma block edges as specified in clause 8.6.2.6.5 is invoked with the chroma picture sample array recPictureCb, the location of the chroma coding block (xCb/SubWidthC, yCb/SubHeightC), the chroma location of the block (xDk, yDm), a variable edgeType set equal to EDGE_HOR and a variable cQpPicOffset set equal to pps_cb_qp_offset as inputs, and the modified chroma picture sample array recPictureCb as output.
b. The filtering process for chroma block edges as specified in clause 8.6.2.6.5 is invoked with the chroma picture sample array recPictureCr, the location of the chroma coding block (xCb/SubWidthC, yCb/SubHeightC), the chroma location of the block (xDk, yDm), a variable edgeType set equal to EDGE_HOR and a variable cQpPicOffset set equal to pps_cr_qp_offset as inputs, and the modified chroma picture sample array recPictureCr as output.

When treeType is equal to DUAL_TREE_CHROMA, the filtering process for edges in the two chroma coding blocks of the current coding unit consists of the following ordered steps:

1. The variable yN is set equal to Max(0, (nCbH/8)−1) and xN is set equal to (nCbW/4)−1.

2. For yDm equal to m<<3 with m=0 . . . yN and xDk equal to k<<2 with k=0 . . . xN, the following applies:
When bS [xDk][yDm] is greater than 0, the following ordered steps apply:
a. The decision process for block edges as specified in clause 8.6.2.6.3 is invoked with treeType, the picture sample array recPicture set equal to the chroma picture sample array recPictureCb, the location of the chroma coding block (xCb, yCb), the location of the chroma block (xDk, yDm), a variable edgeType set equal to EDGE_HOR, the boundary filtering strength bS[xDk][yDm], and the bit depth bD set equal to BitDepthC as inputs, and the decisions dE, dEp and dEq, and the variable tC as outputs.
b. The filtering process for block edges as specified in clause 8.6.2.6.4 is invoked with the picture sample array recPicture set equal to the chroma picture sample array recPictureCb, the location of the chroma coding block (xCb, yCb), the chroma location of the block (xDk, yDm), a variable edgeType set equal to EDGE_HOR, the decisions dE, dEp and dEq, and the variable tC as inputs, and the modified chroma picture sample array recPictureCb as output.
c. The filtering process for block edges as specified in clause 8.6.2.6.4 is invoked with the picture sample array recPicture set equal to the chroma picture sample array recPictureCr, the location of the chroma coding block (xCb, yCb), the chroma location of the block (xDk, yDm), a variable edgeType set equal to EDGE_HOR, the decisions dE, dEp and dEq, and the variable tC as inputs, and the modified chroma picture sample array recPictureCr as output.

### 8.6.2.6.3 Decision Process for Block Edges

Inputs to this process are:
a variable treeType specifying whether a single tree (SINGLE_TREE) or a dual tree is used to partition the CTUs and, when a dual tree is used, whether the luma (DUAL_TREE_LUMA) or chroma components (DUAL_TREE_CHROMA) are currently processed,
a picture sample array recPicture,
a location (xCb, yCb) specifying the top-left sample of the current coding block relative to the top-left sample of the current picture,
a location (xBl, yBl) specifying the top-left sample of the current block relative to the top-left sample of the current coding block,
a variable edgeType specifying whether a vertical (EDGE_VER) or a horizontal (EDGE_HOR) edge is filtered,
a variable bS specifying the boundary filtering strength,
a variable bD specifying the bit depth of the current component.

Outputs of this process are:
the variables dE, dEp and dEq containing decisions,
the variable tC.

If edgeType is equal to EDGE_VER, the sample values pi,k and qi,k with i=0 . . . 3 and k=0 and 3 are derived as follows:

$$qi , k = recPictureL [ xCb + xBl + i ] [ yCb + yBl + k ] \qquad ( 8867 )$$

$$pi , k = recPictureL [ xCb + xBl - i - 1 ] [ yCb + yBl + k ] . \qquad ( 8868 )$$

Otherwise (edgeType is equal to EDGE_HOR), the sample values pi,k and qi,k with i=0 . . . 3 and k=0 and 3 are derived as follows:

$$qi , k = recPicture [ xCb + xBl + k ] [ yCb + yBl + i ] \qquad ( 8869 )$$

$$pi , k = recPicture [ xCb + xBl + k ] [ yCb + yBl - i - 1 ] . \qquad ( 8870 )$$

The variable qpOffset is derived as follows:
If sps_ladf_enabled_flag is equal to 1 and treeType is equal to SINGLE_TREE or DUAL_TREE_LUMA, the following applies:
The variable lumaLevel of the reconstructed luma level is derived as follow:

$$lumaLevel = ( ( p 0 , 0 + p 0 , 3 + q 0 , 0 + q 0 , 3 ) ≫ 2 ) , \qquad ( 8871 )$$

The variable qpOffset is set equal to sps_ladf_lowest_interval_qp_offset and modified as follows:

```
for( i = 0; i < sps_num_ladf_intervals_minus2 + 1; i++ ) {
  if( lumaLevel > SpsLadfIntervalLowerBound[ i + 1 ] )
    qpOffset = sps_ladf_qp_offset[ i ](8 872)
  else
    break
}
```

Otherwise (treeType is equal to DUAL_TREE_CHROMA), qpOffset is set equal to 0.

The variables QpQ and QpP are derived as follows:
If treeType is equal to SINGLE_TREE or DUAL_TREE_LUMA, QpQ and QpP are set equal to the QpY values of the coding units which include the coding blocks containing the sample q0,0 and p0,0, respectively.
Otherwise (treeType is equal to DUAL_TREE_CHROMA), QpQ and QpP are set equal to the QpC values of the coding units which include the coding blocks containing the sample q0,0 and p0,0, respectively.

The variable qP is derived as follows:

$$qP = ( ( QpQ + QpP + 1 ) ≫ 1 ) + qpOffset . \qquad ( 8873 )$$

The value of the variable D′ is determined as specified in Table 8 18 based on the quantization parameter Q derived as follows:

$$Q = Clip 3 ( 0 , 63 , qP + ( tile\_group \_beta \_offset \_div2 ≪ 1 ) ) \qquad ( 8874 )$$

where tilegroup_beta_offset_div2 is the value of the syntax element tilegroup_beta_offset_div2 for the tile group that contains sample q0,0.

The variable D is derived as follows:

$$β = {β}^{′} * ( 1 ≪ ( bD - 8 ) ) . \qquad ( 8875 )$$

The value of the variable tC′ is determined as specified in Table 8 18 based on the quantization parameter Q derived as follows:

$$Q = Clip 3 ( 0 , 65 , qP + 2 * ( bS - 1 ) + ( tile\_group \_tc \_offset \_div2 ≪ 1 ) ) \qquad ( 8876 )$$

where tilegroup_tc_offset_div2 is the value of the syntax element tilegroup_tc_offset_div2 for the tile group that contains sample q0,0.

The variable tC is derived as follows:

$$tC = {tC}^{′} * ( 1 << ( bD - 8 ) ) . \qquad ( 8 \; 877 )$$

Depending on the value of edgeType, the following applies:
If edgeType is equal to EDGE_VER, the following ordered steps apply:

1. The variables dpq0, dpq3, dp, dq and d are derived as follows:

$$dp 0 = A b s ( p 2 , 0 - 2 * p 1 , 0 + p 0 , 0 ) \qquad ( 8 \; 878 )$$

$$dp 3 = Abs ( p 2 , 3 - 2 * p 1 , 3 + p 0 , 3 ) \qquad ( 8 \; 879 )$$

$$dq 0 = Abs ( q 2 , 0 - 2 * q 1 , 0 + q 0 , 0 ) \qquad ( 8 \; 880 )$$

$$dq 3 = Abs ( q 2 , 3 - 2 * q 1 , 3 + q 0 , 3 ) \qquad ( 8 \; 881 )$$

$$dpq 0 = dp 0 + dq 0 \qquad ( 8 \; 882 )$$

$$dpq 3 = dp 3 + dq 3 \qquad ( 8 \; 883 )$$

$$dp = dp 0 + dp 3 \qquad ( 8 \; 884 )$$

$$dq = dq 0 + dq 3 \qquad ( 8 \; 885 )$$

$$d = dpq 0 + dpq 3. \qquad ( 8 \; 886 )$$

2. The variables dE, dEp and dEq are set equal to 0.

3. When d is less than β, the following ordered steps apply:
a. The variable dpq is set equal to 2*dpq0.
b. For the sample location (xCb+xB1, yCb+yB1), the decision process for a sample as specified in clause 8.6.2.6.6 is invoked with sample values p0,0, p3,0, q0,0, and q3,0, the variables dpq, D and tC as inputs, and the output is assigned to the decision dSam0.
c. The variable dpq is set equal to 2*dpq3.
d. For the sample location (xCb+xB1, yCb+yB1+3), the decision process for a sample as specified in clause 8.6.2.6.6 is invoked with sample values p0,3, p3,3, q0,3, and q3,3, the variables dpq, β and tC as inputs, and the output is assigned to the decision dSam3.
e. The variable dE is set equal to 1.
f. When dSam0 is equal to 1 and dSam3 is equal to 1, the variable dE is set equal to 2.
g. When dp is less than (β+(β>>1))>>3, the variable dEp is set equal to 1.
h. When dq is less than (β+(β>>1))>>3, the variable dEq is set equal to 1.
Otherwise (edgeType is equal to EDGE_HOR), the following ordered steps apply:

1. The variables dpq0, dpq3, dp, dq and d are derived as follows:

$$dp 0 = Abs ( p 2 , 0 - 2 * p 1 , 0 + p 0 , 0 ) \qquad ( 8 \; 887 )$$

$$dp 3 = Abs ( p 2 , 3 - 2 * p 1 , 3 + p 0 , 3 ) \qquad ( 8 \; 888 )$$

$$dq 0 = Abs ( q 2 , 0 - 2 * q 1 , 0 + q 0 , 0 ) \qquad ( 8 \; 889 )$$

$$dq 3 = Abs ( q 2 , 3 - 2 * q 1 , 3 + q 0 , 3 ) \qquad ( 8 \; 890 )$$

$$dpq 0 = dp 0 + dq 0 \qquad ( 8 \; 891 )$$

$$dpq 3 = dp 3 + dq 3 \qquad ( 8 \; 892 )$$

$$dp = dp 0 + dp 3 \qquad ( 8 \; 893 )$$

$$dq = dq 0 + dq 3 \qquad ( 8 \; 894 )$$

$$d = dpq 0 + dpq 3. \qquad ( 8 \; 895 )$$

2. The variables dE, dEp and dEq are set equal to 0.

3. When d is less than D, the following ordered steps apply:
a. The variable dpq is set equal to 2*dpq0.
b. For the sample location (xCb+xB1, yCb+yB1), the decision process for a sample as specified in clause 8.6.2.6.6 is invoked with sample values p0,0, p3,0, q0,0 and q3,0, the variables dpq, D and tC as inputs, and the output is assigned to the decision dSam0.
c. The variable dpq is set equal to 2*dpq3.
d. For the sample location (xCb+xB1+3, yCb+yB1), the decision process for a sample as specified in clause 8.6.2.6.6 is invoked with sample values p0,3, p3,3, q0,3 and q3,3, the variables dpq, D and tC as inputs, and the output is assigned to the decision dSam3.
e. The variable dE is set equal to 1.
f. When dSam0 is equal to 1 and dSam3 is equal to 1, the variable dE is set equal to 2.
g. When dp is less than (β+(β>>1))>>3, the variable dEp is set equal to 1.
h. When dq is less than (β+(β>>1))>>3, the variable dEq is set equal to 1.

TABLE 8 18
Derivation of threshold variables β′ and tC′ from input Q

| Q | 0 | 1 | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|---|---|
| β′ | 0 | 0 | 0 | 0 | 0 | 0 | 0 | 0 | 0 | 0 | 0 | 0 | 0 | 0 | 0 | 0 | 6 |
| tC′ | 0 | 0 | 0 | 0 | 0 | 0 | 0 | 0 | 0 | 0 | 0 | 0 | 0 | 0 | 0 | 0 | 0 |
| Q | 17 | 18 | 19 | 20 | 21 | 22 | 23 | 24 | 25 | 26 | 27 | 28 | 29 | 30 | 31 | 32 | 33 |
| β′ | 7 | 8 | 9 | 10 | 11 | 12 | 13 | 14 | 15 | 16 | 17 | 18 | 20 | 22 | 24 | 26 | 28 |
| tC′ | 0 | 1 | 1 | 1 | 1 | 1 | 1 | 1 | 1 | 1 | 2 | 2 | 2 | 2 | 3 | 3 | 3 |
| Q | 34 | 35 | 36 | 37 | 38 | 39 | 40 | 41 | 42 | 43 | 44 | 45 | 46 | 47 | 48 | 49 | 50 |
| β′ | 30 | 32 | 34 | 36 | 38 | 40 | 42 | 44 | 46 | 48 | 50 | 52 | 54 | 56 | 58 | 60 | 62 |
| tC′ | 3 | 4 | 4 | 4 | 5 | 5 | 6 | 6 | 7 | 8 | 9 | 10 | 11 | 13 | 14 | 16 | 18 |

| Q | 51 | 52 | 53 | 54 | 55 | 56 | 57 | 58 | 59 | 60 | 61 | 62 | 63 | 64 | 65 |
|---|---|---|---|---|---|---|---|---|---|---|---|---|---|---|---|
| β′ | 64 | 66 | 68 | 70 | 72 | 74 | 76 | 78 | 80 | 82 | 84 | 86 | 88 | — | — |
| tC′ | 20 | 22 | 25 | 28 | 31 | 35 | 39 | 44 | 50 | 56 | 63 | 70 | 79 | 88 | 99 |

### 8.6.2.6.4 Filtering Process for Block Edges

Inputs to this process are:
a picture sample array recPicture,
a location (xCb, yCb) specifying the top-left sample of the current coding block relative to the top-left sample of the current picture,
a location (xB1, yB1) specifying the top-left sample of the current block relative to the top-left sample of the current coding block,
a variable edgeType specifying whether a vertical (EDGE_VER) or a horizontal (EDGE_HOR) edge is filtered,
the variables dE, dEp and dEq containing decisions,
the variable tC.

Output of this process is the modified picture sample array recPicture.

Depending on the value of edgeType, the following applies:
If edgeType is equal to EDGE_VER, the following ordered steps apply:

1. The sample values pi,k and qi,k with i=0.3 and k=0.3 are derived as follows:

$$q i , k = recPicture L [ xCb + xB 1 + i ] [ yCb + yB 1 + k ] \qquad ( 8 \; 896 )$$

$$pi , k = recPictureL [ xCb + xB 1 - i - 1 ] [ yCb + yB 1 + k ] . \qquad ( 8 \; 897 )$$

2. When dE is not equal to 0, for each sample location (xCb+xB1, yCb+yB1+k), k=0.3, the following ordered steps apply:
a. The filtering process for a sample as specified in clause 8.6.2.6.7 is invoked with the sample values pi,k, qi,k with i=0.3, the locations (xPi, yPi) set equal to (xCb+xBl−i−1, yCb+yBl+k) and (xQi, yQi) set equal to (xCb+xBl+i, yCb+yBl+k) with i=0 . . . 2, the decision dE, the variables dEp and dEq and the variable tC as inputs, and the number of filtered samples nDp and nDq from each side of the block boundary and the filtered sample values pi′ and gi′ as outputs.
b. When nDp is greater than 0, the filtered sample values pi′ with i=0 . . . nDp−1 replace the corresponding samples inside the sample array recPicture as follows:

$$r e c P i c t u re [ xCb + xB 1 - i - 1 ] [ yCb + yB 1 + k ] = {pi}^{′} . \qquad ( 8 \; 898 )$$

c. When nDq is greater than 0, the filtered sample values qi′ with j=0 . . . nDq−1 replace the corresponding samples inside the sample array recPicture as follows:

$$r e c P i c t u re [ xCb + xB 1 + j ] [ yCb + yB 1 + k ] = {qj}^{′} . \qquad ( 8 \; 899 )$$

Otherwise (edgeType is equal to EDGE_HOR), the following ordered steps apply:

1. The sample values pi,k and qi,k with i=0.3 and k=0.3 are derived as follows:

$$q i , k = recPictureL [ xCb + xB 1 + k ] [ yCb + yB 1 + i ] \qquad ( 8 \; 900 )$$

$$pi , k = recPictureL [ xCb + xB 1 + k ] [ yCb + yB 1 - i - 1 ] . \qquad ( 8 \; 901 )$$

2. When dE is not equal to 0, for each sample location (xCb+xBl+k, yCb+yBl), k=0.3, the following ordered steps apply:
a. The filtering process for a sample as specified in clause 8.6.2.6.7 is invoked with the sample values pi,k, qi,k with i=0.3, the locations (xPi, yPi) set equal to (xCb+xBl+k, yCb+yBl−i−1) and (xQi, yQi) set equal to (xCb+xBl+k, yCb+yBl+i) with i=0 . . . 2, the decision dE, the variables dEp and dEq, and the variable tC as inputs, and the number of filtered samples nDp and nDq from each side of the block boundary and the filtered sample values pi′ and gi′ as outputs.
b. When nDp is greater than 0, the filtered sample values pi′ with i=0 . . . nDp−1 replace the corresponding samples inside the sample array recPicture as follows:

$$r e c P i c t u re [ xCb + xB 1 + k ] [ yCb + yB 1 - i - 1 ] = {pi}^{′} . \qquad ( 8 \; 902 )$$

c. When nDq is greater than 0, the filtered sample values qj′ with j=0 . . . nDq−1 replace the corresponding samples inside the sample array recPicture as follows:

$$r e c P i c t u re [ xCb + xB 1 + k ] [ yCb + yB 1 + j ] = {qj}^{′} . \qquad ( 8 \; 903 )$$

### 8.6.2.6.5 Filtering Process for Chroma Block Edges

This process is only invoked when ChromaArrayType is not equal to 0.

Inputs to this process are:
a chroma picture sample array s′,
a chroma location (xCb, yCb) specifying the top-left sample of the current chroma coding block relative to the top-left chroma sample of the current picture,
a chroma location (xBl, yBl) specifying the top-left sample of the current chroma block relative to the top-left sample of the current chroma coding block,
a variable edgeType specifying whether a vertical (EDGE_VER) or a horizontal (EDGE_HOR) edge is filtered,
a variable cQpPicOffset specifying the picture-level chroma quantization parameter offset.

Output of this process is the modified chroma picture sample array s′.

If edgeType is equal to EDGE_VER, the values pi and qi with i=0 . . . 1 and k=0 . . . 3 are derived as follows:

$$q i , k = {s}^{′} [ xCb + xB 1 + i ] [ yCb + yB 1 + k ] \qquad ( 8 \; 904 )$$

$$pi , k = {s}^{′} [ xCb + xB 1 - i - 1 ] [ yCb + yB 1 + k ] . \qquad ( 8 \; 905 )$$

Otherwise (edgeType is equal to EDGE_HOR), the sample values pi and qi with i=0 . . . 1 and k=0 . . . 3 are derived as follows:

$$q i , k = {s}^{′} [ xCb + xB 1 + k ] [ y C b + yB 1 + i ] \qquad ( 8 \; 906 )$$

$$pi , k = {s}^{′} [ xCb + xB 1 + k ] [ y C b + yB 1 - i - 1 ] . \qquad ( 8 \; 907 )$$

The variables QpQ and QpP are set equal to the QpY values of the coding units which include the coding blocks containing the sample q0,0 and p0,0, respectively.

If ChromaArrayType is equal to 1, the variable QpC is determined as specified in Table 8 15 based on the index qPi derived as follows:

$$q P i = ( ( QpQ + QpP + 1 ) >> 1 ) + cQpPicOffset . \qquad ( 8 \; 908 )$$

Otherwise (ChromaArrayType is greater than 1), the variable QpC is set equal to Min(qPi, 63).

NOTE—The variable cQpPicOffset provides an adjustment for the value of pps_cb_qp_offset or pps_cr_qp_offset, according to whether the filtered chroma component is the Cb or Cr component. However, to avoid the need to vary the amount of the adjustment within the picture, the filtering process does not include an adjustment for the value of tile_group_cb_qp_offset or tile_group_cr_qp_offset.

The value of the variable tC′ is determined as specified in Table 8 18 based on the chroma quantization parameter Q derived as follows:

$$Q = Clip 3 ( 0 , 65 , QpC + 2 + ( tile\_group \_tc \_offset \_div2 << 1 ) ) \qquad ( 8 \; 909 )$$

where tilegroup_tc_offset_div2 is the value of the syntax element tile_group_tc_offset_div2 for the tile group that contains sample q0,0.

The variable tC is derived as follows:

$$t C = {tC}^{′} * ( 1 << ( BitDepthC - 8 ) ) . \qquad ( 8 \; 910 )$$

Depending on the value of edgeType, the following applies:
If edgeType is equal to EDGE_VER, for each sample location (xCb+xBl, yCb+yBl+k), k=0.3, the following ordered steps apply:

1. The filtering process for a chroma sample as specified in clause 8.6.2.6.8 is invoked with the sample values pi,k, qi,k, with i=0 . . . 1, the locations (xCb+xBl−1, yCb+yBl+k) and (xCb+xBl, yCb+yBl+k) and the variable tC as inputs, and the filtered sample values p0′ and q0′ as outputs.

2. The filtered sample values p0′ and q0′ replace the corresponding samples inside the sample array s′ as follows:

$${s}^{′} [ xCb + xB 1 ] [ yCb + yB 1 + k ] = q {0}^{′} \qquad ( 8 \; 911 )$$

$${s}^{′} [ xCb + xB 1 - 1 ] [ yCb + yB 1 + k ] = p {0}^{′} . \qquad ( 8 \; 912 )$$

Otherwise (edgeType is equal to EDGE_HOR), for each sample location (xCb+xBl+k, yCb+yBl), k=0.3, the following ordered steps apply:

1. The filtering process for a chroma sample as specified in clause 8.6.2.6.8 is invoked with the sample values pi,k, qi,k, with i=0 . . . 1, the locations (xCb+xBl+k, yCb+yBl−1) and (xCb+xBl+k, yCb+yBl), and the variable tC as inputs, and the filtered sample values p0′ and q0′ as outputs.

2. The filtered sample values p0′ and q0′ replace the corresponding samples inside the sample array s′ as follows:

$${s}^{′} [ xCb + xBl + k ] [ yCb + yBl ] = q {0}^{′} \qquad ( 8 \; 913 )$$

$${s}^{′} [ xCb + xBl + k ] [ yCb + yBl - 1 ] = p {0}^{′} . \qquad ( 8 \; 914 )$$

### 8.6.2.6.6 Decision Process for a Sample

Inputs to this process are:
the sample values p0, p3, q0 and q3,
the variables dpq, D and tC.

Output of this process is the variable dSam containing a decision.

The variable dSam is specified as follows:
If dpq is less than (β>>2),Abs(p3−p0)+Abs(q0−q3) is less than (β>>3) and Abs(p0−q0) is less than (5*tC+1)>>1, dSam is set equal to 1.
Otherwise, dSam is set equal to 0.

### 8.6.2.6.7 Filtering Process for a Sample

Inputs to this process are:
the sample values pi and qi with i=0 . . . 3,
the locations of pi and qi, (xPi, yPi) and (xQi, yQi) with i=0 . . . 2,
a variable dE,
the variables dEp and dEq containing decisions to filter samples p1 and q1, respectively,
a variable tC.

Outputs of this process are:
the number of filtered samples nDp and nDq,
the filtered sample values pi′ and qj′ with i=0 . . . nDp−1, j=0 . . . nDq−1.

Depending on the value of dE, the following applies:
If the variable dE is equal to 2, nDp and nDq are both set equal to 3 and the following strong filtering applies:

$$p {0}^{′} = Clip 3 ( p 0 - 2 * tC , p 0 + 2 * tC , ( p 2 + 2 * p 1 + 2 * p 0 + 2 * q 0 + q 1 + 4 ) >> 3 ) \qquad ( 8 \; 915 )$$

$$p {1}^{′} = Clip 3 ( p 1 - 2 * tC , p 1 + 2 * tC , ( p 2 + p 1 + p 0 + q 0 + 2 ) >> 2 ) \qquad ( 8 \; 916 )$$

$$p {2}^{′} = Clip 3 ( p 2 - 2 * tC , p 2 + 2 * tC , ( 2 * p 3 + 3 * p 2 + p 1 + p 0 + q 0 + 4 ) >> 3 ) \qquad ( 8 \; 917 )$$

$$q {0}^{′} = Clip 3 ( q 0 - 2 * tC , q 0 + 2 * tC , ( p 1 + 2 * p 0 + 2 * q 0 + 2 * q 1 + q 2 + 4 ) >> 3 ) \qquad ( 8 \; 918 )$$

$$q {1}^{′} = Clip 3 ( q 1 - 2 * tC , q 1 + 2 * tC , ( p 0 + q 0 + q 1 + q 2 + 2 ) >> 2 ) \qquad ( 8 \; 919 )$$

$$q {2}^{′} = Clip 3 ( q 2 - 2 * tC , q 2 + 2 * tC , ( p 0 + q 0 + q 1 + 3 * q 2 + 2 * q 3 + 4 ) >> 3 ) . \qquad ( 8 \; 920 )$$

Otherwise, nDp and nDq are set both equal to 0 and the following weak filtering applies:
The following applies:

$$Δ = ( 9 * ( q 0 - p 0 ) - 3 * ( q 1 - p 1 ) + 8 ) >> 4. \qquad ( 8 \; 921 )$$

When Abs(Δ) is less than tC*10, the following ordered steps apply:
The filtered sample values p0′ and q0′ are specified as follows:

$$Δ = Clip 3 ( - t C , tC , Δ ) \qquad ( 8 \; 922 )$$

$$p {0}^{′} = Clip 1 Y ( p 0 + Δ ) \qquad ( 8 \; 923 )$$

$$q {0}^{′} = Clip 1 Y ( q 0 - Δ ) . \qquad ( 8 \; 924 )$$

When dEp is equal to 1, the filtered sample value p1′ is specified as follows:

$$Δ p = C lip 3 ( - ( tC >> 1 ) , tC >> 1 , ( ( ( p 2 + p 0 + 1 ) >> 1 ) - p 1 + Δ ) >> 1 ) \qquad ( 8 \; 925 )$$

$$p {1}^{′} = Clip 1 Y ( p 1 + Δ p ) . \qquad ( 8 \; 926 )$$

When dEq is equal to 1, the filtered sample value q1′ is specified as follows:

$$Δ q = Clip 3 ( - ( tC >> 1 ) , tC >> 1 , ( ( ( q 2 + q 0 + 1 ) >> 1 ) - q 1 - Δ ) >> 1 ) \qquad ( 8 \; 927 )$$

$$q {1}^{′} = Clip 1 Y ( q 1 + Δ q ) . \qquad ( 8 \; 928 )$$

nDp is set equal to dEp+1 and nDq is set equal to dEq+1.

When nDp is greater than 0 and one or more of the following conditions are true, nDp is set equal to 0:
pcm_loop_filter_disabled_flag is equal to 1 and pcm_flag[xP0][yP0] is equal to 1.
cu_transquant_bypass_flag of the coding unit that includes the coding block containing the sample p0 is equal to 1.

When nDq is greater than 0 and one or more of the following conditions are true, nDq is set equal to 0:
pcm_loop_filter_disabled_flag is equal to 1 and pcm_flag[xQ0][yQ0] is equal to 1.
cu_transquant_bypass_flag of the coding unit that includes the coding block containing the sample q0 is equal to 1.

### 8.6.2.6.8 Filtering Process for a Chroma Sample

This process is only invoked when ChromaArrayType is not equal to 0.

Inputs to this process are:
the chroma sample values pi and qi with i=0 . . . 1,
the chroma locations of p0 and q0, (xP0, yP0) and (xQ0, yQ0),
a variable tC.

Outputs of this process are the filtered sample values p0′ and q0′.

The filtered sample values p0′ and q0′ are derived as follows:

$$Δ = Clip 3 ( - t C , tC , ( ( ( ( q 0 - p 0 ) << 2 ) + p 1 - q 1 + 4 ) >> 3 ) ) \qquad ( 8 \; 929 )$$

$$p {0}^{′} = Clip 1 C ( p 0 + Δ ) \qquad ( 8 \; 930 )$$

$$q {0}^{′} = Clip 1 C ( q 0 - Δ ) . \qquad ( 8 \; 931 )$$

When one or more of the following conditions are true, the filtered sample value, p0′ is substituted by the corresponding input sample value p0:
pcm_loop_filter_disabled_flag is equal to 1 and pcm_flag[xP0*SubWidthC][yP0*SubHeightC] is equal to 1.
cu_transquant_bypass_flag of the coding unit that includes the coding block containing the sample p0 is equal to 1.

When one or more of the following conditions are true, the filtered sample value, q0′ is substituted by the corresponding input sample value q0:
pcm_loop_filter_disabled_flag is equal to 1 and pcm_flag[xQ0*SubWidthC][yQ0*SubHeightC] is equal to 1.
cu_transquant_bypass_flag of the coding unit that includes the coding block containing the sample q0 is equal to 1.

### 8.6.3 Sample Adaptive Offset Process

### 8.6.3.1 General

Inputs to this process are the reconstructed picture sample array prior to sample adaptive offset recPictureL and, when ChromaArrayType is not equal to 0, the arrays recPictureCb and recPictureCr.

Outputs of this process are the modified reconstructed picture sample array after sample adaptive offset saoPictureL and, when ChromaArrayType is not equal to 0, the arrays saoPictureCb and saoPictureCr.

This process is performed on a CTB basis after the completion of the deblocking filter process for the decoded picture.

The sample values in the modified reconstructed picture sample array saoPictureL and, when ChromaArrayType is not equal to 0, the arrays saoPictureCb and saoPictureCr are initially set equal to the sample values in the reconstructed picture sample array recPictureL and, when ChromaArrayType is not equal to 0, the arrays recPictureCb and recPictureCr, respectively.

For every CTU with CTB location (rx, ry), where rx=0 . . . PicWidthInCtbsY−1 and ry=0 . . . PicHeightInCtbsY
1, the following applies:
When tile_group_sao_luma_flag of the current tile group is equal to 1, the CTB modification process as specified in clause 8.6.3.2 is invoked with recPicture set equal to recPictureL, cIdx set equal to 0, (rx, ry), and both nCtbSw and nCtbSh set equal to CtbSizeY as inputs, and the modified luma picture sample array saoPictureL as output.
When ChromaArrayType is not equal to 0 and tile_group_sao_chroma_flag of the current tile group is equal to 1, the CTB modification process as specified in clause 8.6.3.2 is invoked with recPicture set equal to recPictureCb, cIdx set equal to 1, (rx, ry), nCtbSw set equal to (1<<CtbLog2SizeY)/SubWidthC and nCtbSh set equal to (1<<CtbLog2SizeY)/SubHeightC as inputs, and the modified chroma picture sample array saoPictureCb as output.
When ChromaArrayType is not equal to 0 and tile_group_sao_chroma_flag of the current tile group is equal to 1, the CTB modification process as specified in clause 8.6.3.2 is invoked with recPicture set equal to recPictureCr, cIdx set equal to 2, (rx, ry), nCtbSw set equal to (1<<CtbLog2SizeY)/SubWidthC and nCtbSh set equal to (1<<CtbLog2SizeY)/SubHeightC as inputs, and the modified chroma picture sample array saoPictureCr as output.

### 8.6.3.2 CTB Modification Process

Inputs to this process are:
the picture sample array recPicture for the colour component cIdx,
a variable cIdx specifying the colour component index,
a pair of variables (rx, ry) specifying the CTB location,
the CTB width nCtbSw and height nCtbSh.

Output of this process is a modified picture sample array saoPicture for the colour component cIdx.

The variable bitDepth is derived as follows:
If cIdx is equal to 0, bitDepth is set equal to BitDepthY.
Otherwise, bitDepth is set equal to BitDepthC.

The location (xCtb, yCtb), specifying the top-left sample of the current CTB for the colour component cIdx relative to the top-left sample of the current picture component cIdx, is derived as follows:

$$( xCtb , yCtb ) = ( rx * nCtbSw , ry * vCtbSh ) . \qquad ( 8 \; 932 )$$

The sample locations inside the current CTB are derived as follows:

$$( xSi , ySj ) = ( xCtb + i , yCtb + j ) \qquad ( 8 \; 933 )$$

$$( xYi , yYj ) = ( cIdx == 0 ) ? ( xSi , ySj ) : ( xSi * SubWidthC , ySj * SubHeightC ) . \qquad ( 8 \; 934 )$$

For all sample locations (xSi, ySj) and (xYi, yYj) with i=0 . . . nCtbSw−1 and j=0 . . . nCtbSh−1, depending on the values of pcm_loop_filter_disabled_flag, pcm_flag[xYi][yYj] and cu_transquant_bypass_flag of the coding unit which includes the coding block covering recPicture[xSi][ySj], the following applies:
If one or more of the following conditions are true, saoPicture[xSi][ySj] is not modified:
pcm_loop_filter_disabled_flag and pcm_flag[xYi][yYj] are both equal to 1.
cu_transquant_bypass_flag is equal to 1.
SaoTypeIdx[cIdx][rx][ry] is equal to 0.

[Ed. (BB): Modify highlighted sections pending on future decision transform/quantization bypass].
Otherwise, if SaoTypeIdx[cIdx][rx][ry] is equal to 2, the following ordered steps apply:

1. The values of hPos[k] and vPos[k] for k=0 . . . 1 are specified in Table 8 19 based on SaoEoClass[cIdx][rx][ry].

2. The variable edgeIdx is derived as follows:
The modified sample locations (xSik′, ySjk′) and (xYik′, yYjk′) are derived as follows:

$$( {xSik}^{′} , {ySjk}^{′} ) = ( xSi + hPos [ k ] , ySj + vPos [ k ] ) \qquad ( 8 \; 935 )$$

$$( {xYik}^{′} , {yYjk}^{′} ) = ( cIdx == 0 ) ? ( {xSik}^{′} , {ySjk}^{′} ) : ( {xSik}^{′} * subWidthC , {ySjk}^{′} * SubHeightC ) . \qquad ( 8 \; 936 )$$

If one or more of the following conditions for all sample locations (xSik′, ySjk′) and (xYik′, yYjk′) with k=0 . . . 1 are true, edgeIdx is set equal to 0:
The sample at location (xSik′, ySjk′) is outside the picture boundaries.
The sample at location (xSik′, ySjk′) belongs to a different tile group and one of the following two conditions is true:
MinTbAddrZs[xYik′>>MinTbLog2SizeY][yYjk′>>MinTbLog2SizeY] is less than MinTbAddrZs[xYi>>MinTbLog2SizeY][yYj>>MinTbLog2SizeY] and tile_group_loop_filter_across_tile_groups_enabled_flag in the tile group which the sample recPicture[xSi][ySj] belongs to is equal to 0.
MinTbAddrZs[xYi>>MinTbLog2SizeY][yYj>>MinTbLog2SizeY] is less than MinTbAddrZs[xYik′>>MinTbLog2SizeY][yYjk′>>MinTbLog2SizeY] and tile_group_loop_filter_across_tile_groups_enabled_flag in the tile group which the sample recPicture[xSik′][ySjk′] belongs to is equal to 0.
loop_filter_across_tiles_enabled_flag is equal to 0 and the sample at location (xSik′, ySjk′) belongs to a different tile.

[Ed. (BB): Modify highlighted sections when tiles without tile groups are incorporated].
Otherwise, edgeIdx is derived as follows:
The following applies:

$$edgeIdx = 2 + Sign ( recPicture [ xSi ] [ ySj ] - recPicture [ xSi + hPos [ 0 ] ] [ ySj + vPos [ 0 ] ] ) + Sign ( recPicture [ xSi ] [ ySj ] - recPicture [ xSi + hPos [ 1 ] ] [ ySj + vPos [ 1 ] ] ) . \qquad ( 8 \; 937 )$$

When edgeIdx is equal to 0, 1, or 2, edgeIdx is modified as follows:

$$edgeIdx = ( edgeIdx == 2 ) ? 0 : ( edgeIdx + 1 ) . \qquad ( 8 \; 938 )$$

3. The modified picture sample array saoPicture[xSi][ySj] is derived as follows:

$$saoPicture [ xSi ] [ ySj ] = Clip 3 ( 0 , ( 1 << bitDepth ) - 1 , recPicture [ xSi ] [ ySj ] + SaoOffsetVal [ cIdx ] [ rx ] [ ry ] [ edgeIdx ] ) . \qquad ( 8 \; 939 )$$

Otherwise (SaoTypeIdx[cIdx][rx][ry] is equal to 1), the following ordered steps apply:

1. The variable bandShift is set equal to bitDepth−5.

2. The variable saoLeftClass is set equal to sao_band_position[cIdx][rx][ry].

3. The list bandTable is defined with 32 elements and all elements are initially set equal to 0. Then, four of its elements (indicating the starting position of bands for explicit offsets) are modified as follows:

$$for ( k = 0 ; k < 4 ; k ++ ) \qquad ( 8 \; 940 )$$

$$bandTable [ ( k + saoLeftClass ) \& 31 ] = k + 1 .$$

4. The variable bandIdx is set equal to bandTable[recPicture[xSi][ySj] bandShift].

5. The modified picture sample array saoPicture[xSi][ySj] is derived as follows:

$$saoPicture [ xSi ] [ ySj ] = Clip 3 ( 0 , ( 1 << bitDepth ) - 1 , recPicture [ xSi ] [ ySj ] + SaoOffsetVal [ cIdx ] [ rx ] [ ry ] [ bandIdx ] ) . \qquad ( 8 \; 941 )$$

TABLE 8 19
Specification of hPos and vPos according
to the sample adaptive offset class

SaoEoClass[ cIdx ][ rx ][ ry ] 0 1 2 3
hPos[ 0 ] −1 0 −1 1
hPos[ 1 ] 1 0 1 −1
vPos[ 0 ] 0 −1 −1 −1
vPos[ 1 ] 0 1 1 1

### 2.7. OBMC in ECM

When OBMC is applied, top and left boundary pixels of a CU are refined using neighboring block's motion information with a weighted prediction.

Conditions of not applying OBMC are as follows:
When OBMC is disabled at SPS level.
When current block has intra mode or IBC mode.
When current block applies LIC.
When current luma block area is smaller or equal to 32.

A subblock-boundary OBMC is performed by applying the same blending to the top, left, bottom, and right subblock boundary pixels using neighboring subblocks' motion information. It is enabled for the subblock based coding tools:
Affine AMVP modes;
Affine merge modes and subblock-based temporal motion vector prediction (SbTMVP);
Subblock-based bilateral matching.

When OBMC mode is used in CIIP mode with LMCS, inter blending is performed prior to LMCS mapping of inter samples. LMCS is applied to blended inter samples which are combined with LMCS applied intra samples in CIIP mode,

$${Inter}_{predY}^{′} = \frac{( 128 - {w}_{1} ) \times {Inter}_{predY} + {w}_{1} \times {OBMC}_{predY}}{128}$$

$$PredY = \frac{( 4 - {w}_{0} ) \times FwdMap ( {Inter}_{predY}^{′} ) + {w}_{0} \times {Intra}_{predY}}{4} ,$$

where Inter_{predY} represents the samples predicted by the motion of current block in the original domain, Intra_{predY} represents the samples predicted in the mapped domain, OBMC_{predY} represents the samples predicted by the motion of neighboring blocks in the original domain, and w₀ and w₁ are the weights.

### 2.8. Interweaved Prediction

To overcome the problems in sub-block based prediction, an interweaved prediction in video coding is proposed.

With interweaved prediction, a block is divided into sub-blocks with more than one dividing patterns. A dividing pattern is defined as the way to divide a block into sub-blocks, including the size of sub-blocks and the position of sub-blocks. For each dividing pattern, a corresponding prediction block may be generated by deriving motion information of each sub-block based on the dividing pattern. Therefore, even for one prediction direction, multiple prediction blocks may be generated by multiple dividing patterns. Alternatively, for each prediction direction, only a dividing pattern may be applied.

Suppose there are X dividing patterns, and X prediction blocks of the current block, denoted as P0, P1, . . . , PX−1 are generated by sub-block based prediction with the X dividing patterns. The final prediction of the current block, denoted as P, can be generated as

$$P ( x , y ) = \frac{{\sum }_{i = 0}^{X - 1} {w}_{i} ( x , y ) \times {P}_{i} ( x , y )}{{\sum }_{i = 0}^{X - 1} {w}_{i} ( x , y )} \qquad ( 15 )$$

where (x, y) is the coordinate of a pixel in the block and wᵢ(x, y) is the weighting value of Pi. Without losing generalization, it is supposed that

$${\sum }_{i = 0}^{X - 1} {w}_{i} ( x , y ) = ( 1 ≪ N )$$

wherein N is a non-negative value. FIG. 19 shows an example of interweaved prediction with two dividing patterns.

The detailed embodiments below should be considered as examples to explain general concepts. These embodiments should not be interpreted in a narrow way. Furthermore, these embodiments can be combined in any manner.

### Usage of Interweaved Prediction for Different Coding Tools

1. Interweaved prediction can be applied in one, some or all coding tools with sub-block based prediction. In one example, affine prediction applies interweaved prediction while other coding tools with sub-block based prediction such as ATMVP, STMVP, FRUC and BIO do not apply interweaved prediction. In another example, affine, ATMVP and STMVP apply interweaved prediction.

### Definitions of Dividing Patterns

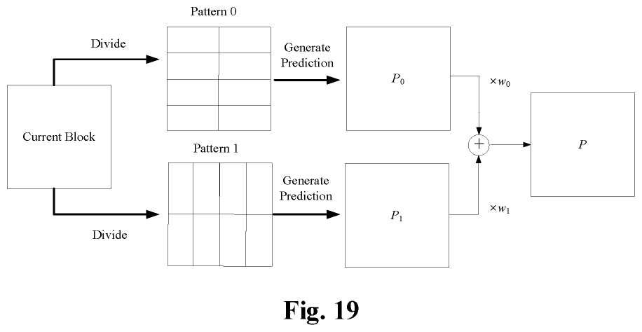

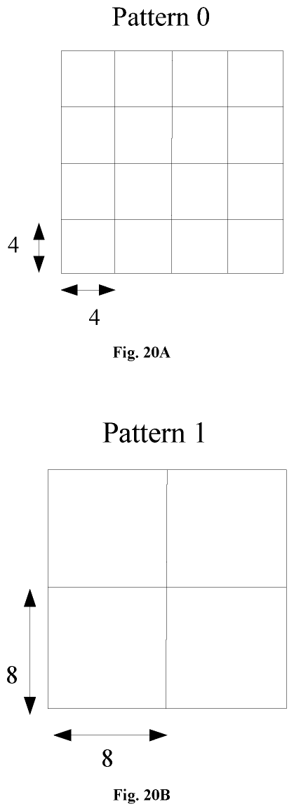

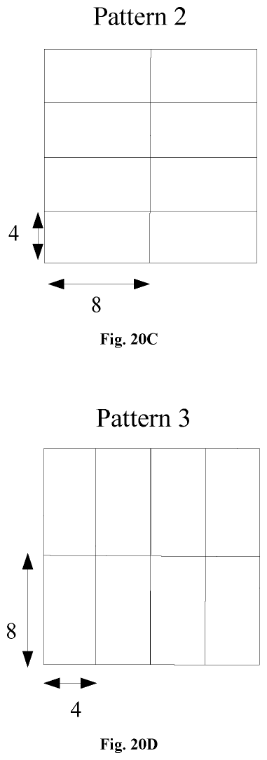

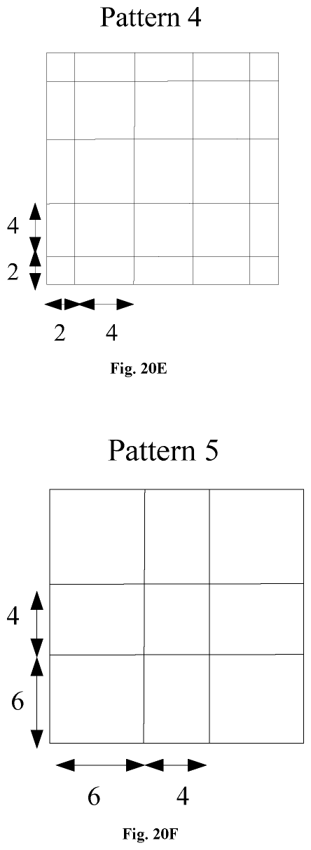

2. Dividing patterns can have different shapes, or sizes, or positions of sub-blocks. In one example, a dividing pattern may result in irregular sub-block sizes. FIG. 20A-FIG. 20G illustrate several exemplary dividing patterns for a 16×16 block. In FIG. 20A, the block is divided into 4×4 sub-blocks as in JEM. In FIG. 20B, the block is divided into 8×8 sub-blocks. In FIG. 20C and FIG. 20D, the block is divided into 8×4 sub-blocks and 4×8 sub-blocks, respectively. In FIG. 20E and FIG. 20F, the block is also divided into 4×4 sub-blocks but with different positions. The pixels at block boundaries which cannot be divided into an integral 4×4 sub-block can be divided in smaller sub-blocks with sizes like 2×4, 4×2 or 2×2 as shown in FIG. 20E, or they can be merged into adjacent 4×4 sub-blocks to form larger sub-blocks with sizes like 6×4, 4×6 or 6×6 as shown in FIG. 20F; In FIG. 20G the block is also divided into 8×8 sub-blocks but with different positions. The pixels at block boundaries which cannot be divided into an integral 8×8 sub-block can be divided in smaller sub-blocks with sizes like 8×4, 4×8 or 4×4.
3. The shapes and sizes of sub-blocks in sub-block-based prediction can depend on the shape and/or size of the coding block and/or coded block information (e.g., it is affine or ATMVP mode).
   a. In one example, the sub-blocks are with the size 4×N (or 8×N and so on) when the current block is with the size M×N.
   b. In one example, the sub-blocks are with the size M×4 (or M×8 and so on) when the current block is with the size M×N.
   c. In one example, the sub-blocks are with the size A×B with A>B such as 8×4, when the current block is with the size M×N and M>N; otherwise, the sub-blocks are with the size B×A such as 4×8.
   d. In one example, suppose the current block is with the size M×N, then sub-blocks are with the size A×B when M×N<=T (or Min(M, N)<=T, or Max(M, N)<=T and so on) and sub-blocks are with the size C×D when M×N>T (or Min(M, N)>T, or Max(M, N)>T, and so on), where A<=C and B<=D. For example, if M×N<=256 sub-blocks are with the size 4×4; otherwise, sub-blocks are with the size 8×8.

### Enabling/Disabling Interweaved Prediction and Coding Process of Interweaved Prediction

4. Whether to apply interweaved prediction depends on the inter-prediction direction.
   a. In one example, the interweaved prediction may be applied for bi-prediction but not for uni-prediction.
   b. In one example, when multiple-hypothesis is applied, the interweaved prediction may be applied for one prediction direction when there are more than one reference blocks.
5. How to apply interweaved prediction depends on the inter-prediction direction.
   a. In one example, a bi-predicted block with sub-block based prediction is divided into sub-blocks with two different dividing patterns for two different reference lists. In one example, the block is divided into 4×8 sub-blocks as shown in FIG. 20D when predicted from reference list 0 (L0), but divided into 8×4 sub-blocks as shown in FIG. 20C when predicted from reference list 1 (L1). And the final prediction P is calculated as

$$P ( x , y ) = \frac{{w}^{0} ( x , y ) \times {P}^{0} ( x , y ) + {w}^{1} ( x , y ) \times {P}^{1} ( x , y )}{{w}^{0} ( x , y ) + {w}^{1} ( x , y )} \qquad ( 16 )$$

where P0 and P1 are predictions from L0 and L1, respectively. w0 and w1 are weighting values for L0 and L1, respectively. Without losing generalization, it is supposed that w⁰(x, y)+w¹(x, y)=1<<N (wherein N is non-negative integer value).
b. In one example, a uni-predicted block with sub-block based prediction is divided into sub-blocks with two or more different dividing patterns. For example, the prediction for list L (L=0 or 1) PL is calculated as

$${P}^{L} ( x , y ) = \frac{{\sum }_{i = 0}^{XL - 1} {w}_{i}^{L} ( x , y ) \times {P}_{i}^{L} ( x , y )}{{\sum }_{i = 0}^{XL - 1} {w}_{i}^{L} ( x , y )} \qquad ( 17 )$$

where XL is the number of dividing patterns for list L;

$${P}_{i}^{L} ( x , y )$$

is the prediction generated with the ith dividing pattern and

$${w}_{i}^{L} ( x , y )$$

is the weighting value of

$${P}_{i}^{L} ( x , y ) .$$

For example, XL is 2. With the 0th dividing pattern, the block is divided into 4×8 sub-blocks as shown in FIG. 20D. With the 1th dividing pattern, the block is divided into 8×4 sub-blocks as shown in FIG. 20C.
c. In one example, a bi-predicted block with sub-block based prediction is considered as a combination of two uni-predicted block from L0 and L1 respectively. The prediction from each list can be derived as described in the above example. The final prediction P can be calculated as

$$P ( x , y ) = \frac{\begin{matrix}a * \frac{{\sum }_{i = 0}^{X 1 - 1} {w}_{i}^{0} ( x , y ) \times {P}_{i}^{0} ( x , y )}{{\sum }_{i = 0}^{X 1 - 1} {w}_{i}^{0} ( x , y )} + \\ b * \frac{{\sum }_{i = 0}^{X 1 - 1} {w}_{i}^{1} ( x , y ) \times {P}_{i}^{1} ( x , y )}{{\sum }_{i = 0}^{X 1 - 1} {w}_{i}^{1} ( x , y )}\end{matrix}}{a + b} \qquad ( 18 )$$

wherein parameters a and b are two additional weights applied to the two internal prediction blocks. In one example, a and b are both equal to 1.
d. In one example, for a multiple hypothesis coded block, for each prediction direction (or reference picture list), there could be more than one prediction blocks generated by different dividing patterns. Multiple prediction blocks may be utilized to generate the final version with additional weights applied. In one example, the additional weights may be set to 1/M wherein M is the total number of generated prediction blocks.
6. Whether and how to apply interweaved prediction can be transmitted from the encoder to the decoder at sequence level, picture level, view level, slice level, Coding Tree Unit (CTU) (a. k. a. Largest Coding Unit (LCU) level, CU level, PU level or TU level or tile level or tile group level or region level which may contain multiple CUs/PUs/Tus/LCUs. The information can be signaled in Sequence Parameter Set (SPS), view parameter set (VPS), Picture Parameter Set (PPS), Slice Header (SH), picture header, sequence header, or tile level or tile group level, CTU (a. k. a. LCU), CU, PU, TU or the first block of a region.
   a. In one example, interweaved prediction applies to existing sub-block methods like ATMVP, STMVP, FRUC, BIO or affine implicitly. In this example, no additional signaling cost is needed at all.
   b. In another example, new sub-block merge candidates generated by interweaved prediction are inserted into merge list, e.g., interweaved prediction+ATMVP, interweaved prediction+STMVP, interweaved prediction+FRUC etc.
   c. In one example, a flag may be signaled to indicate whether interweaved prediction is used or not. In one example, a flag signaled to indicate whether interweaved prediction is used or not, if the current block is affine inter-coded.
   d. In one example, a flag may be signaled to indicate whether interweaved prediction is used or not, if the current block is affine merge-coded and applies uni-prediction.
   e. In one example, a flag may be signaled to indicate whether interweaved prediction is used or not, if the current block is affine merge-coded.
   f. In one example, interweaved prediction may be always used if the current block is affine merge-coded and applies uni-prediction.
   g. In one example, interweaved prediction may be always used if the current block is affine merge-coded.
   h. In one example, the flag to indicate whether interweaved prediction is used or not may be inherited without being signaled.
      i. In one example, the inheritance may be used if the current block is affine merge-coded.
      ii. In one example, the flag may be inherited from the flag of the neighbouring block where the affine model is inherited from.
      iii. In one example, the flag is inherited from a predefined neighboring block such as the left or above neighbouring block.
      iv. In one example, the flag may be inherited from the first encountered affine-coded neighbouring block.
      v. In one example, the flag may be inferred to be zero if no neighbouring block is affine-coded.
      vi. In one example, the flag may be only inherited when the current block applies uni-prediction.
      vii. In one example, the flag may be only inherited when the current block and the neighbouring block to be inherited from are in the same CTU.
      viii. In one example, the flag may be only inherited when the current block and the neighbouring block to be inherited from are in the same CTU row.
      ix. In one example, the flag may not be inherited from the flag of the neighbouring block when the affine model is derived from a temporal neighboring block.
      x. In one example, the flag may not be inherited from the flag of a neighboring block which is not located in the same LCU or LCU row or video data processing unit (such as 64×64, or 128×128).
      xi. In one example, how to signal and/or derive the flag may depend on the block dimension of the current block and/or coded information.
   i. In one example, interweaved prediction is not applied if the reference picture is the current picture.
      i. In one example, the flag to indicate whether interweaved prediction is used or not is not signaled if the reference picture is the current picture.

### Weighting Values

7. The weighting values w are fixed. For example, wᵢ(x, y)=1 in eq (15) and eq (16).
8. The weighting values may depend on position as well as the dividing pattern, i.e., wᵢ(x,y) may be different for different (x, y). Alternatively, the weighting values may further depend on the sub-block prediction based coding tools (e.g., affine, or ATMVP) and/or other coded information (e.g., skip or non-skip modes, and/or MV information, et al.).
9. Weighting values can be transmitted from the encoder to the decoder at sequence level, picture level, slice level, Coding Tree Unit (CTU) (a. k. a. Largest Coding Unit (LCU) level, CU level, or PU level or region level which may contain multiple CUs/PUs/Tus/LCUs. They can be signaled in Sequence Parameter Set (SPS), Picture Parameter Set (PPS), Slice Header (SH), CTU (a. k. a. LCU), CU or PU or the first block of a region.
   a. In one alternative solution, furthermore, for some blocks, it may inherit the weighting values from a spatial and/or temporal neighboring block.

### Partial Interweaved Prediction

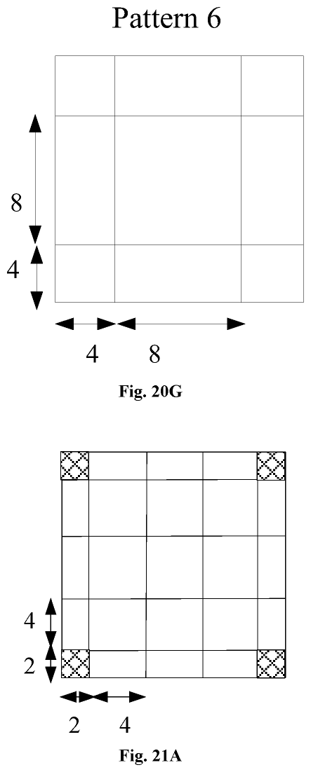

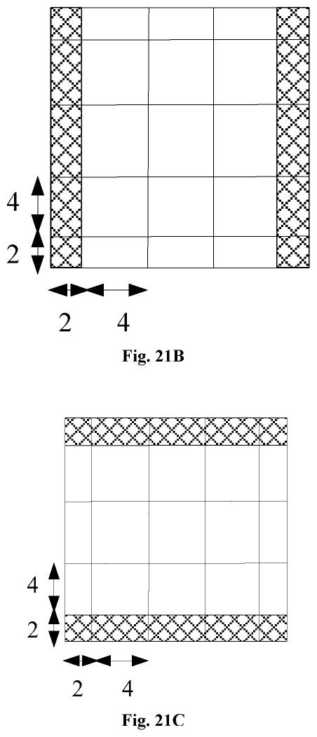

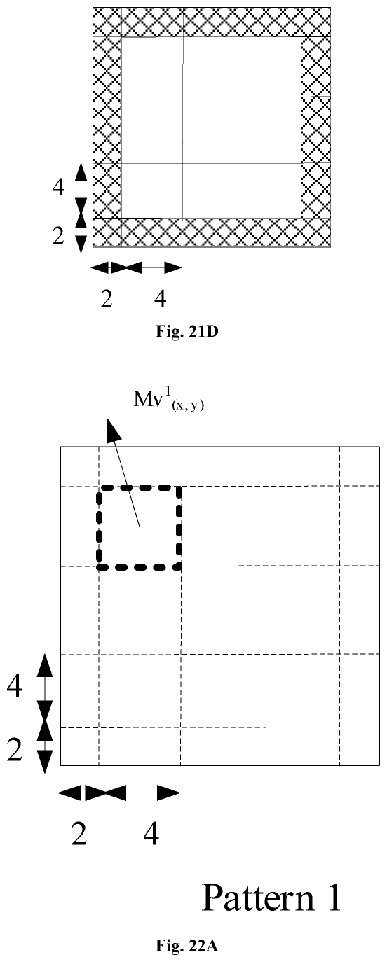

10. In one embodiment, interweaved prediction is applied to a part of the current block. Prediction samples at some positions are calculated as the weighted sum of two or more sub-block based predictions. Prediction samples at other positions are not. For example, these prediction samples are copied from the sub-block based prediction with a certain dividing pattern. FIG. 21A-FIG. 21D illustrate examples of partial interweaved prediction. Interweaved prediction is not applied on shaded areas.
   a. In one example, the current block is predicted by sub-block based prediction P1 and P2 with dividing pattern DO and dividing pattern D1, respectively. The final prediction is calculated as P=w0×P0+w1×P1. At some positions, w0≠0 and w1≠0. But at some other positions, w0=1 and w1=0, that is, interweaved prediction is not applied at those positions.
   b. In one example, interweaved prediction is not applied on four corner sub-blocks as shown in FIG. 21A.
   c. In one example, interweaved prediction is not applied on the left-most column of sub-blocks and right-most column of sub-blocks as shown in FIG. 21B.
   d. In one example, interweaved prediction is not applied on the top-most row of sub-blocks and bottom-most row of sub-blocks as shown in FIG. 21C.
   e. In one example, interweaved prediction is not applied on the top-most row of row of sub-blocks, bottom-most row of sub-blocks the left-most column of sub-blocks and right-most column of sub-blocks as shown in FIG. 21D.
   f. In one example, whether to and how to apply partial interweaved prediction may depend on the size/shape of the current block.
      i. For example, interweaved prediction is applied to the whole block if the size of the current block satisfies certain conditions; otherwise, interweaved prediction is applied to a part (or some parts) of the block. The conditions include but not limited to: (suppose the width and height of the current block is W and H respectively and T, T1, T2 are integer values):

$$1. W >= T 1 and H >= T 2 ;$$

$$2. W <= T 1 and H <= T 2 ;$$

$$3. W >= T 1 or H >= T 2 ;$$

$$4. W <= T 1 or H <= T 2 ;$$

$$5. W + H >= T ;$$

$$6. W + H <= T ;$$

$$7. W \times H >= T ;$$

$$8. W \times H <= T .$$

ii. For example, interweaved prediction is not applied on the left-most column of sub-blocks and right-most column of sub-blocks as shown in FIG. 21B if W>=H; Otherwise, interweaved prediction is not applied on the top-most row of sub-blocks and bottom-most row of sub-blocks as shown in FIG. 21C.
iii. For example, interweaved prediction is not applied on the left-most column of sub-blocks and right-most column of sub-blocks as shown in FIG. 21B if W>H; Otherwise, interweaved prediction is not applied on the top-most row of sub-blocks and bottom-most row of sub-blocks as shown in FIG. 21C.
g. It is proposed that whether and how to apply interweaved prediction may be different for different regions in a block.
   i. For example, suppose the current block is predicted by sub-block based prediction P1 and P2 with dividing pattern DO and dividing pattern D1, respectively. The final prediction is calculated as P(x, y)=w0×P0(x, y)+w1×P1(x, y). If the position (x, y) belongs to a sub-block with dimensions S0×H0 with the dividing pattern DO; and belongs to a sub-block S1×H1 with the dividing pattern D1. If one or several following conditions are satisfied, set w0=1 and w1=0. (i.e., interweaved prediction is not applied at this position).

$$1. S 1 < T 1 ;$$

$$2. H 1 < T 2 ;$$

$$3. S 1 < T 1 and H 1 < T 2 ;$$

$$4. S 1 < T 1 or H 1 < T 2 ;$$

T1 and T2 are integers. For example, T1=T2=4.

### Encoder Issue

11. In one embodiment, interweaved prediction is not applied in the motion estimation (ME) process.
   a. For example, interweaved prediction is not applied in the ME process for the 6-parameter affine prediction.
   b. For example, interweaved prediction is not applied in the ME process if the size of the current block satisfies certain conditions such as (suppose the width and height of the current block is W and H respectively and T, T1, T2 are integer values):

$$i . W >= T 1 and H >= T 2 ;$$

$$ii . W <= T 1 and H <= T 2 ;$$

$$iii . W >= T 1 or H >= T 2 ;$$

$$iv . W <= T 1 or H <= T 2 ;$$

$$v . W + H >= T ;$$

$$vi . W + H <= T ;$$

$$vii . W \times H >= T ;$$

$$viii . W \times H <= T .$$

c. For example, interweaved prediction is not applied in the ME process if the current block is split from a parent block, and the parent block does not choose affine mode at encoder.
   i. Alternatively, affine mode is not checked at encoder if the current block is split from a parent block, and the parent block does not choose affine mode at encoder.

### MV Derivation

In the following discussion, SatShift(x, n) is defined as

$$SatShift ( x , n ) = \{ \begin{matrix}( x + offsset0 ) >> n if x \geq 0 \\ - ( ( - x + offset 1 ) >> n ) if x < 0.\end{matrix}$$

Shift(x, n) is defined as Shift(x, n)=(x+offset0)>>n.

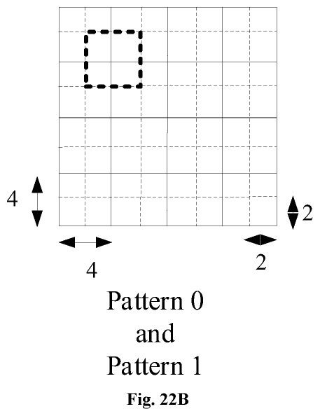

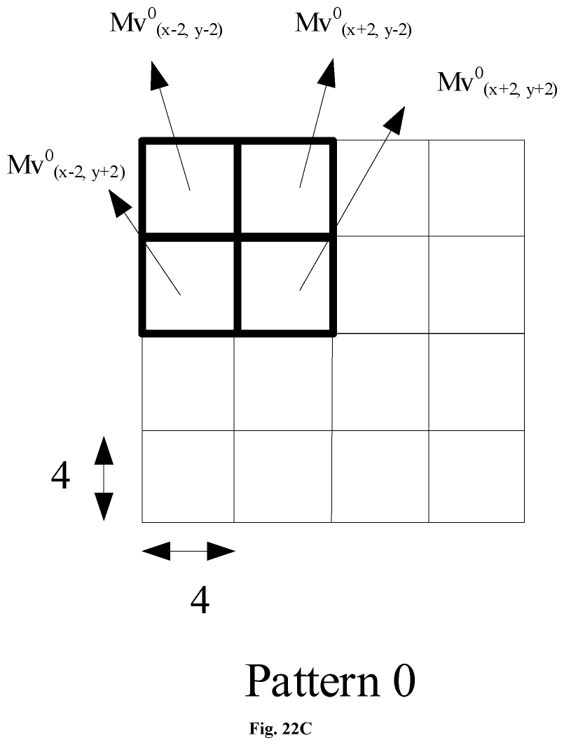

In one example, offset0 and/or offset1 are set to (1<<n)>>1 or (1<<(n−1)). In another example, offset0 and/or offset1 are set to 0.
12. The MV of each sub-block within one dividing pattern may be derived from the affine model (such as with Eq.(1)) directly, or it may be derived from MVs of sub-blocks within another dividing pattern.
   a. In one example, the MV of a sub-block B with dividing pattern 0, may be derived from MVs of all or some of the sub-blocks within dividing pattern 1, that overlap with sub-block B.
   b. FIG. 22A-FIG. 22C illustrate examples. In FIG. 22A, MV1(x,y) of a specific sub-block within dividing pattern 1 is to be derived. FIG. 22B shows dividing pattern 0 (solid) and dividing pattern 1 (dashed) in the block, indicating that there are four sub-blocks with in dividing pattern 0 overlapping with the specific sub-block within dividing pattern 1. FIG. 22C shows the four MVs: MV0(x−2,y−2), MV0(x+2,y−2), MV0(x−2,y+2) and MV0(x+2,y+2) of the four sub-blocks with in dividing pattern 0 overlapping with the specific sub-block within dividing pattern 1. Then MV1(x,y) will be derived from MV0(x−2,y−2), MV0(x+2,y−2), MV0(x−2,y+2) and MV0(x+2,y+2).
   c. Suppose MV′ of one sub-block within dividing pattern 1 is derived from MV0, MV1, MV2, . . . MVk of k−1 sub-blocks within dividing pattern 0. MV′ may be derived as:
      i. MV′=MVn, n is any of 0 . . . k.
      ii. MV′=f(MV0, MV1, MV2, . . . , MVk). f is a linear function.
      iii. MV′=f(MV0, MV1, MV2, . . . , MVk). f is a non-linear function.
      iv. MV′=Average(MV0, MV1, MV2, . . . , MVk). Average is an averaging operation.
      v. MV′=Median(MV0, MV1, MV2, . . . , MVk). Median is an operation to get the median value.
      vi. MV′=Max(MV0, MV1, MV2, . . . , MVk). Max is an operation to get the maximum value.
      vii. MV′=Min(MV0, MV1, MV2, . . . , MVk). Min is an operation to get the minimum value.
      viii. MV′=MaxAbs(MV0, MV1, MV2, . . . , MVk). MaxAbs is an operation to get the value with the maximum absolute value.
      ix. MV′=MinAbs(MV0, MV1, MV2, . . . , MVk). MinAbs is an operation to get the value with the minimum absolute value.
      x. Take FIG. 22A-FIG. 22C as an example, MV1(x,y) may be derived as:

$$1. MV 1 ( x , y ) = SatShift ( MV 0 ( x - 2 , y - 2 ) + MV 0 ( x + 2 , y - 2 ) + MV 0 ( x - 2 , y + 2 ) + MV 0 ( x + 2 , y + 2 ) , 2 ) ;$$

$$2. MV 1 ( x , y ) = Shift ( MV 0 ( x - 2 , y - 2 ) + MV 0 ( x + 2 , y - 2 ) + MV 0 ( x - 2 , y + 2 ) MV 0 ( x + 2 , y + 2 ) , 2 ) ;$$

$$3. MV 1 ( x , y ) = SatShift ( MV 0 ( x - 2 , y - 2 ) + MV 0 ( x + 2 , y - 2 ) , 1 ) ;$$

$$4. MV 1 ( x , y ) = Shift ( MV 0 ( x - 2 , y - 2 ) + MV 0 ( x + 2 , y - 2 ) , 1 ) ;$$

$$5. MV 1 ( x , y ) = SatShift ( MV 0 ( x - 2 , y + 2 ) + MV 0 ( x + 2 , y + 2 ) , 1 ) ;$$

$$6. MV 1 ( x , y ) = Shift ( MV 0 ( x - 2 , y + 2 ) + MV 0 ( x + 2 , y + 2 ) , 1 ) ;$$

$$7. MV 1 ( x , y ) = SatShift ( MV 0 ( x - 2 , y - 2 ) + MV 0 ( x + 2 , y + 2 ) , 1 ) ;$$

$$8. MV 1 ( x , y ) = Shift ( MV 0 ( x - 2 , y - 2 ) + MV 0 ( x + 2 , y + 2 ) , 1 ) ;$$

$$9. MV 1 ( x , y ) = SatShift ( MV 0 ( x - 2 , y - 2 ) + MV 0 ( x - 2 , y + 2 ) , 1 ) ;$$

$$10. MV 1 ( x , y ) = Shift ( MV 0 ( x - 2 , y - 2 ) + MV 0 ( x - 2 , y + 2 ) , 1 ) ;$$

$$11. MV 1 ( x , y ) = SatShift ( MV 0 ( x + 2 , y - 2 ) + MV 0 ( x + 2 , y + 2 ) , 1 ) ;$$

$$12. MV 1 ( x , y ) = Shift ( MV 0 ( x + 2 , y - 2 ) + MV 0 ( x + 2 , y + 2 ) , 1 ) ;$$

$$13. MV 1 ( x , y ) = SatShift ( MV 0 ( x + 2 , y - 2 ) + MV 0 ( x - 2 , y + 2 ) , 1 ) ;$$

$$14. MV 1 ( x , y ) = Shift ( MV 0 ( x + 2 , y - 2 ) + MV 0 ( x - 2 , y + 2 ) , 1 ) ;$$

$$15. MV 1 ( x , y ) = MV 0 ( x - 2 , y - 2 ) ;$$

$$16. MV 1 ( x , y ) = MV 0 ( x + 2 , y - 2 ) ;$$

$$17. MV 1 ( x , y ) = MV 0 ( x - 2 , y + 2 ) ;$$

$$18. MV 1 ( x , y ) = MV 0 ( x + 2 , y + 2 ) .$$

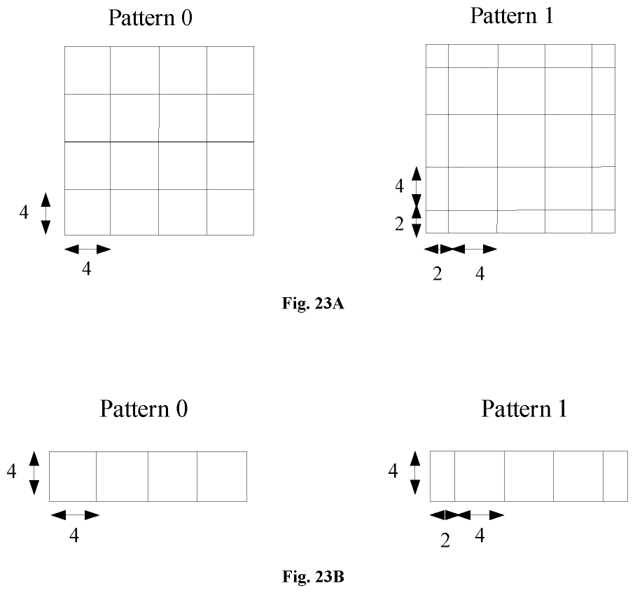

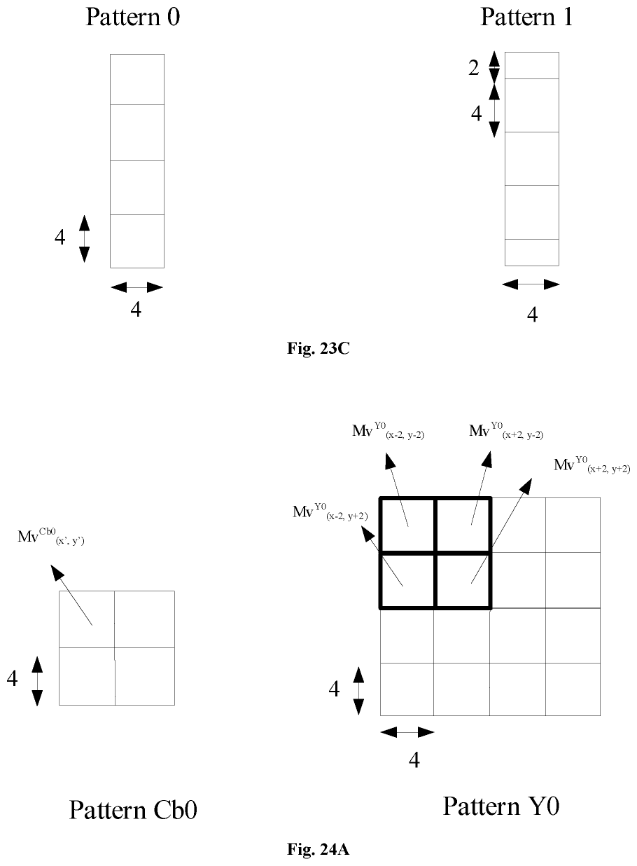

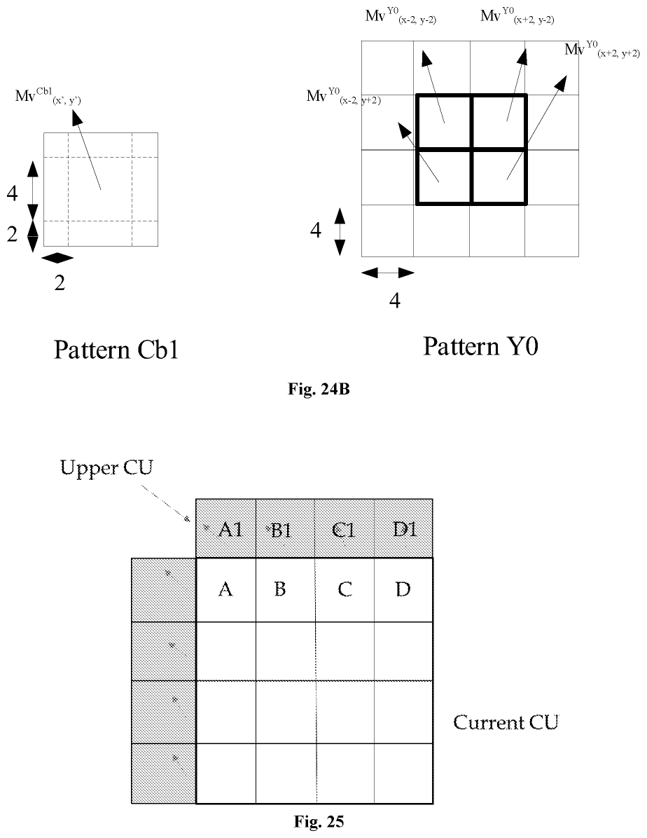

13. How to select the dividing pattern may depend on the width and height of the current block. FIG. 23A-FIG. 23C illustrate examples of choosing dividing patterns depending on block dimensions.
   a. For example, if width>T1 and height>T2 (e.g. T1=T2=4), two dividing patterns are selected. FIG. 23A show an example of two dividing patterns.
   b. For example, if height<=T2 (e.g. T2=4), another two dividing patterns are selected. FIG. 23B show an example of two dividing patterns.
   c. For example, if width<=T1 (e.g. T1=4), yet another two dividing patterns are selected. FIG. 23C show an example of two dividing patterns.
14. The MV of each sub-block within one dividing pattern of one color component C1 may be derived from MVs of sub-blocks within another dividing pattern of another color component C0.
   a. For example, C1 refers to color component coded/decoded after another color component, such as Cb or Cr or U or V or R or B.
   b. For example, C0 refers to color component coded/decoded before another color component, such as Y or G.
   c. In one example, how to derive MV of a sub-block within one dividing pattern of one color component from MVs of MVs of sub-blocks within another dividing pattern of another color component may depend on the color format, such as 4:2:0, or 4:2:2, or 4:4:4.
   d. In one example, the MV of a sub-block B in color component C1 with dividing pattern C1Pt (t=0 or 1), may be derived from MVs of all or some of the sub-blocks in color component C0 within dividing pattern C0Pr (r=0 or 1), that overlap with sub-block B, after down-scaling or up-scaling the coordinates according to the color format.
      i. In one example, C0Pr is always equal to C0P0.
   e. FIG. 24A and FIG. 24B illustrate an example. FIG. 24A and FIG. 24B illustrate examples of deriving MVs of sub-blocks in one component within a dividing pattern from MVs of sub-block in another component within another dividing pattern. The color format is 4:2:0. MVs of sub-blocks in Cb component are derived from MVs of sub-blocks in Y component.
      i. In FIG. 24A left, MVCb0(x′,y′) of a specific Cb sub-block B within dividing pattern 0 is to be derived. FIG. 24A right shows four Y sub-blocks with in dividing pattern 0, which are overlapped with Cb sub-block B when down-scaled by 2:1. Suppose x=2*x′ and y=²*y′, four MVs: MV0(x−2,y−2), MV0(x+2,y−2), MV0(x−2,y+2) and MV0(x+2,y+2) of the four Y sub-blocks with in dividing pattern 0 are used to derive the MVCb0(x′,y′).
      ii. In FIG. 24B left, MVCb0(x′,y′) of a specific Cb sub-block B within dividing pattern 1 is to be derived. FIG. 24B right shows four Y sub-blocks with in dividing pattern 0, which are overlapped with Cb sub-block B when down-scaled by 2:1. Suppose x=2*x′ and y=²*y′, four MVs: MV0(x−2,y−2), MV0(x+2,y−2), MV0(x−2,y+2) and MV0(x+2,y+2) of the four Y sub-blocks with in dividing pattern 0 are used to derive the MVCb0(x′,y′).
   f. Suppose MV′ of one sub-block of color component C1 is derived from MV0, MV1, MV2, . . . MVk of k−1 sub-blocks of color component C0. MV′ may be derived as:
      i. MV′=MVn, n is any of 0 . . . k.
      ii. MV′=f(MV0, MV1, MV2, . . . , MVk). f is a linear function.
      iii. MV′=f(MV0, MV1, MV2, . . . , MVk). f is a non-linear function.
      iv. MV′=Average(MV0, MV1, MV2, . . . , MVk). Average is an averaging operation.
      v. MV′=Median(MV0, MV1, MV2, . . . , MVk). Median is an operation to get the median value.
      vi. MV′=Max(MV0, MV1, MV2, . . . , MVk). Max is an operation to get the maximum value.
      vii. MV′=Min(MV0, MV1, MV2, . . . , MVk). Min is an operation to get the minimum value.
      viii. MV′=MaxAbs(MV0, MV1, MV2, . . . , MVk). MaxAbs is an operation to get the value with the maximum absolute value.
      ix. MV′=MinAbs(MV0, MV1, MV2, . . . , MVk). MinAbs is an operation to get the value with the minimum absolute value.
      x. Take FIG. 24A and FIG. 24B as an example, MVCbt(x′,y′) t=0 or 1, may be derived as:

$$1. MVCbt ( {x}^{′} , {y}^{′} ) = SatShift ( MV 0 ( x - 2 , y - 2 ) + MV 0 ( x + 2 , y - 2 ) + MV 0 ( x - 2 , y + 2 ) + MV 0 ( x + 2 , y + 2 ) , 2 ) ;$$

$$2. MVCbt ( {x}^{′} , {y}^{′} ) = Shift ( MV 0 ( x - 2 , y - 2 ) + MV 0 ( x + 2 , y - 2 ) + MV 0 ( x - 2 , y + 2 ) + MV 0 ( x + 2 , y + 2 ) , 2 ) ;$$

$$3. MVCbt ( {x}^{′} , {y}^{′} ) = SatShift ( MV 0 ( x - 2 , y - 2 ) + MV 0 ( x + 2 , y - 2 ) , 1 ) ;$$

$$4. MVCbt ( {x}^{′} , {y}^{′} ) = Shift ( MV 0 ( x - 2 , y - 2 ) + MV 0 ( x + 2 , y - 2 ) , 1 ) ;$$

$$5. MVCbt ( {x}^{′} , {y}^{′} ) = SatShift ( MV 0 ( x - 2 , y + 2 ) + MV 0 ( x + 2 , y + 2 ) , 1 ) ;$$

$$6. MVCbt ( {x}^{′} , {y}^{′} ) = Shift ( MV 0 ( x - 2 , y + 2 ) + MV 0 ( x + 2 , y + 2 ) , 1 ) ;$$

$$7. MVCbt ( {x}^{′} , {y}^{′} ) = SatShift ( MV 0 ( x - 2 , y - 2 ) + MV 0 ( x + 2 , y + 2 ) , 1 ) ;$$

$$8. MVCbt ( {x}^{′} , {y}^{′} ) = Shift ( MV 0 ( x - 2 , y - 2 ) + MV 0 ( x + 2 , y + 2 ) , 1 ) ;$$

$$9. MVCbt ( {x}^{′} , {y}^{′} ) = SatShift ( MV 0 ( x - 2 , y - 2 ) + MV 0 ( x - 2 , y + 2 ) , 1 ) ;$$

$$10. MVCbt ( {x}^{′} , {y}^{′} ) = Shift ( MV 0 ( x - 2 , y - 2 ) + MV 0 ( x - 2 , y + 2 ) , 1 ) ;$$

$$11. MVCbt ( {x}^{′} , {y}^{′} ) = SatShift ( MV 0 ( x + 2 , y - 2 ) + MV 0 ( x + 2 , y + 2 ) , 1 ) ;$$

$$12. MVCbt ( {x}^{′} , {y}^{′} ) = Shift ( MV 0 ( x + 2 , y - 2 ) + MV 0 ( x + 2 , y + 2 ) , 1 ) ;$$

$$13. MVCbt ( {x}^{′} , {y}^{′} ) = SatShift ( MV 0 ( x + 2 , y - 2 ) + MV 0 ( x - 2 , y + 2 ) , 1 ) ;$$

$$14. MV 1 ( x , y ) = Shift ( MV 0 ( x + 2 , y - 2 ) + MV 0 ( x - 2 , y + 2 ) , 1 ) ;$$

$$15. MVCbt ( {x}^{′} , {y}^{′} ) = MV 0 ( x - 2 , y - 2 ) ;$$

$$16. MVCbt ( {x}^{′} , {y}^{′} ) = MV 0 ( x + 2 , y - 2 ) ;$$

$$17. MVCbt ( {x}^{′} , {y}^{′} ) = MV 0 ( x - 2 , y + 2 ) ;$$

$$18. MVCbt ( {x}^{′} , {y}^{′} ) = MV 0 ( x + 2 , y + 2 ) .$$

### Interweaved Prediction for Bi-Prediction

15. When interweaved prediction is applied on bi-prediction, the following methods may be applied to save the internal bitdepth increased due to different weights:
   a. For list X (X=0 or 1), PX(x, y)=Shift(W0(x,y)*PX0(x,y)+W1(x,y)*PX1(x,y), SW), where PX(x, y) is the prediction for list X, PX0(x,y) and PX1(x,y) are the prediction for list X with dividing pattern 0 and dividing pattern 1, respectively. W0 and W1 are integers representing the interweaved prediction weighting values and SW represents the precision of the weighting values.
   b. The final prediction value is derived as P(x,y)=Shift(Wb0(x,y)*P0(x,y)+Wb1(x,y)*P1(x,y), SWB), where Wb0 and Wb1 are integers used in weighted bi-prediction and SWB is the precision. When there is no weighted bi-prediction, Wb0=Wb1=SWB=1. c. In some embodiments, PX0(x,y) and PX1(x,y) may be kept the precision of interpolation filtering. For example, they may be unsigned integers with 16 bits. The final prediction value is derived as P(x,y)=Shift(Wb0(x,y)*P0(x,y)+Wb1(x,y)*P1(x,y), SWB+PB), where PB is the additional precision from interpolation filtering, e.g., PB=6. In this case, W0(x,y)*PX0(x,y) or W1(x,y)*PX1(x,y) may exceed 16 bits. It is proposed that PX0(x,y) and PX1(x,y) are right-shift to a lower precision first, to avoid exceeding 16 bits.
      i. For example, For list X (X=0 or 1), PX(x, y)=Shift(W0(x,y)*PLX0(x,y)+W1(x,y)*PLX1(x,y), SW), where PLX0(x,y)=Shift(PX0(x,y), M), PLX1(x,y)=Shift(PX1(x,y), M). And the final prediction is derived as P(x,y)=Shift(Wb0(x,y)*P0(x,y)+Wb1(x,y)*P1(x,y), SWB+PB-M). For example, M is set to be 2 or 3.
   d. The above mentioned methods may be also applicable to other bi-prediction methods with different weighting factors for two reference prediction blocks, such as Generalized Bi-Prediction (GBi, wherein weights could be e.g., ⅜, ⅝), weighted prediction (wherein weights could be a very large value).
   e. The above mentioned methods may be also applicable to other multiple hypothesis uni-prediction or bi-prediction methods with different weighting factors for different reference prediction blocks.

### Block Size Dependents

16. Whether and/or how to apply interweaved prediction may depend on block width W and height H.
   a. In one example, whether and/or how to apply interweaved prediction may depend on the size of VPDU (Video Processing Data Unit which typically represent the maximumly allowed block size for processing in hardware design).
   b. In one example, when interweaved prediction is disabled for a certain block dimension (or a block with certain coded information), the original prediction method may be utilized.
      i. Alternatively, affine mode may be directly disabled for such kind of blocks.
   c. In one example, interweaved prediction cannot be used when W>T1 and H>T2. For example, T1=T2=64;
   d. In one example, interweaved prediction cannot be used when W>T1 or H>T2. For example, T1=T2=64;
   e. In one example, interweaved prediction cannot be used when W*H>T. For example, T=64*64;
   f. In one example, interweaved prediction cannot be used when W<T1 and H<T2. For example, T1=T2=16;
   g. In one example, interweaved prediction cannot be used when W<T1 or H>T2. For example, T1=T2=16;
   h. In one example, interweaved prediction cannot be used when W*H<T. For example, T=16*16.
   i. In one example, for a sub-block which is not located at block boundary (e.g., coding unit), interweaved affine may be disabled for this sub-block. Alternatively, furthermore, the prediction results with original affine prediction method may be directly used as the final prediction for this sub-block.
   j. In one example, interweaved prediction is used in a different way when W>T1 and H>T2. For example, T1=T2=64;
   k. In one example, interweaved prediction is used in a different way when W>T1 or H>T2. For example, T1=T2=64;
   l. In one example, interweaved prediction is used in a different way when W*H>T. For example, T=64*64;
   m. In one example, interweaved prediction is used in a different way when W<T1 and H<T2. For example, T1=T2=16;
   n. In one example, interweaved prediction is used in a different way when W<T1 or H>T2. For example, T1=T2=16;
   o. In one example, interweaved prediction is used in a different way when W*H<T. For example, T=16*16.
   p. In one example, when H>X (e.g. H is equal to 128, X=64), the interweaved prediction is not applied on samples belonging to a sub-blocks crossing the upper W*(H/2) partition and the lower W*(H/2) partition of the current block.
   q. In one example, when W>X (e.g. W is equal to 128, X=64), the interweaved prediction is not applied on samples belonging to a sub-blocks crossing the left (W/2)*H partition and the right (W/2)*H partition of the current block.
   r. In one example, when W>X and H>Y (e.g. W=H=128, X=Y=64),
      i. the interweaved prediction is not applied on samples belonging to a sub-blocks crossing the left (W/2)*H partition and the right (W/2)*H partition of the current block.
      ii. the interweaved prediction is not applied on samples belonging to a sub-blocks crossing the upper W*(H/2) partition and the lower W*(H/2) partition of the current block.
   s. In one example, interweaved prediction is only enabled for blocks with specific sets of width and/or height.
   t. In one example, interweaved prediction is only disabled for blocks with specific sets of width and/or height.
   u. In one example, interweaved prediction is only used for specific types of picture/slice/tile group/tile/or other kinds of video data units.
      i. For example, interweaved prediction is only used for P picture or B picture.
      ii. For example, a flag is signaled to indicate whether interweaved prediction can be used or not in the header of picture/slice/tile group/tile.
         1. For example, this flag is signaled only if affine prediction is allowed.
17. It is proposed that a message is signaled to indicate whether to apply the dependency between whether/how to apply interweaved prediction and the width and height. The message may be signaled in SPS/VPS/PPS/Slice header/picture header/tile/tile group header/CTUs/CTU rows/multiple CTUs/or other kinds of video processing units.
18. In one example, when interweaved prediction is used, bi-prediction is disallowed.
   a. For example, when interweaved prediction is used, the index to indicate whether bi-prediction is used is not signaled.
   b. Alternatively, indications of whether bi-prediction is disallowed may be signaled in SPS/VPS/PPS/Slice header/picture header/tile/tile group header/CTUs/CTU rows/multiple CTUs.
19. It is proposed to further refine sub-blocks' motion information based on motion information derived from two or multiple patterns.
   a. In one example, the refined motion information may be utilized for predicting following blocks to be coded.
   b. In one example, the refined motion information may be utilized in the filtering process, such as Deblock, SAO, ALF.
   c. Whether to store the refined information may be based on the position of sub-block relative to the whole block/CTU/CTU row/tile/slice/tile groups/picture.
   d. Whether to store the refined information may be based on the coded mode of current block and/or neighboring blocks.
   e. Whether to store the refined information may be based on the dimension of current block.
   f. Whether to store the refined information may be based on picture/slice types/reference picture lists etc. al.
20. It is proposed that whether to and/or how to apply deblocking process or other kinds of filtering process (such as SAO, Adaptive loop filter) may depend on whether interweaved prediction is applied or not.
   a. In one example, deblocking is not conducted on an edge between two sub-blocks in one division pattern for a block if the edge is inside a sub-block in another division pattern for a block.
   b. In one example, deblocking is made weaker on an edge between two sub-blocks in one division pattern for a block if the edge is inside a sub-block in another division pattern for a block.
      i. In one example, bS[xDi][yDj] described in the VVC deblocking process is decreased for such a edge.
      ii. In one example, D described in the VVC deblocking process is decreased for such a edge.
      iii. In one example, A described in the VVC deblocking process is decreased for such a edge.
      iv. In one example, tC described in the VVC deblocking process is decreased for such a edge.
   c. In one example, deblocking is made stronger on an edge between two sub-blocks in one division pattern for a block if the edge is inside a sub-block in another division pattern for a block.
      i. In one example, bS[xDi][yDj] described in the VVC deblocking process is increased for such a edge.
      ii. In one example, D described in the VVC deblocking process is increased for such a edge.
      iii. In one example, A described in the VVC deblocking process is increased for such a edge.
      iv. In one example, tC described in the VVC deblocking process is increased for such a edge.
21. It is proposed that whether to and/or how to apply local illumination compensation or weighted prediction to a block/sub-block may depend on whether interweaved prediction is applied or not.
   a. In one example, when one block is coded with interweaved prediction mode, it is disallowed to apply local illumination compensation or weighted prediction.
   b. Alternatively, furthermore, there is no need to signal indications of enabling local illumination compensation if interweaved prediction is applied to a block/sub-block.
22. It is proposed that when weighted prediction is applied to one block or sub-block, bi-directional optical flow (BIO) may be skipped.
   a. In one example, BIO may be applied to blocks with weighted prediction.
   b. In one example, BIO may be applied to blocks with weighted prediction, however, certain conditions shall be satisfied.
      i. In one example, it is required that at least one parameter shall be within one range, or equal to certain values.
      ii. In one example, certain reference pictures restrictions may be applied.

### 2.9. Template Matching-Based Affine Control Points Refinement (TM-Affine)

In this disclosure, it is proposed to refine Affine CPMV with template matching. For a given Affine candidate in Affine candidate list, the CPMV may be further refined with template matching, and the refined Affine candidate is then used to derive sub-block or pixel level Affine motion information for the current block.

The detailed embodiments below should be considered as examples to explain general concepts. These embodiments should not be interpreted in a narrow way. Furthermore, these embodiments can be combined in any manner.

The terms ‘video unit’ or ‘coding unit’ or ‘block’ may represent a coding tree block (CTB), a coding tree unit (CTU), a coding block (CB), a CU, a PU, a TU, a PB, a TB.

The terms ‘Affine block’ may represent a block coded with Affine merge, Affine AMVP or any other Affine variant mode (i.e., Affine MMVD etc), which may be described by motion information of two control point (4-parameter) or three control point motion vectors (6-parameter). The terms ‘CPMV’ may represent the motion information of a Affine block at top-left, top-right and/or bottom-left corners.

The term ‘template’ may represent a reconstructed region that can be used to refine the CPMV, which may represent either ‘separate template’ or ‘unified template’. Here a ‘separate template’ may represent a reconstructed region that can be used to refine individual CPMV, i.e., specific one(s) of top-left, top-right and/or bottom-left corners, while a ‘unified template’ may represent a reconstructed region that can be used to refine all or arbitrary CPMV(s) for a block. The term ‘template matching cost’ or ‘TM cost’ may represent either matching cost of a separate template or a unified template.

In this disclosure, regarding “a block coded with mode N”, here “mode N” may be a prediction mode (e.g., MODE_INTRA, MODE_INTER, MODE_PLT, MODE_IBC, and etc.), or a coding technique (e.g., DIMD, TIMD, PDPC, CCLM, CCCM, GLM, intraTMP, AMVP, SMVD, Merge, BDOF, PROF, DMVR, AMVR, TM, Affine, CIIP, GPM, spatial GPM, SGPM, GPM inter-inter, GPM intra-intra, GPM inter-intra, MHP, GEO, TPM, MMVD, BCW, HMVP, SbTMVP, LIC, OBMC, ALF, deblocking, SAO, bilateral filter, LMCS, and the corresponding variants, and etc.).

It is noted that the terminologies mentioned below are not limited to the specific ones defined in existing standards. Any variance of the coding tool is also applicable.

1. In one example, affine motion compensation may be refined by using previously decoded samples,
a) In one example, at least one CPMV may be refined.
b) In one example, at least one MV of one subblock of affine motion compensation may be refined.
c) In one example, at least one affine parameter (such as a, b, c, d, e, f) may be refined.
d) In one example, previously decoded samples may be a template of the current block.
e) In one example, previously decoded samples may be a template of the reference block.
f) In one example, template represents a reconstructed region that can be used to refine the CPMV.
g) In one example, for an Affine-coded block, different separate templates may be used for different control points.
   i. In one example, for a control point, the corresponding separate template may comprise the samples from the adjacent and/or non-adjacent positions in the already-reconstructed region.
      1) In one example, the separate templates for all the control points are collected from adjacent reconstructed region.
      2) In one example, the separate template samples for some control points are collected from the adjacent reconstructed region of the current block, while for the rest control points, the temple samples are collected from non-adjacent reconstructed region.
         a) In one example, specifically, the template samples for left-top corner are collected from non-adjacent region, while for right-top and/or left-bottom corners, the temple samples are collected from adjacent region.
      3) In one example, both adjacent and non-adjacent samples are used for certain control points.
   ii. In one example, for different control points, the shape of the separate templates may be different.
      1) In one example, for certain control points, L-shape (e.g., comprising both above and left neighbouring samples) separate template is used.
      2) In one example, for certain control points, I-shape or ‘-’ shape template (e.g., comprising either left or above (but not both) neighbouring samples) may be used.
   iii. In one example, which shape of template is used for a CPMV refinement may be based on the position/location of the control point.
      1) In one example, CPMV at the top-left corner of the current video unit may use a L-shape template (e.g., comprising both above and left neighbouring samples).
      2) In one example, CPMV at the top-right corner of the current video unit may use a ‘-’ shape template (e.g., comprising above neighbouring samples only).
      3) In one example, CPMV at the top-left corner of the current video unit may use a I-shape template (e.g., comprising left neighbouring samples only).
      4) In one example, for a certain CPMV, the shapes of templates in the current picture and reference picture are same.
         a) For example, as depicted in FIG. 16, the template of a CPMV may refer to a group of neighbouring samples in the current picture (e.g., templates in the current picture) and a second group of neighbouring samples in a reference picture (e.g., templates in the reference picture).
   iv. In one example, for different control points, the number of the samples used in the template may be different.
      1) Alternatively, the number of the sample used for different control points are the same for an Affine block.
      2) For different control points, the lines (or rows or columns) of the samples used in the template may be different.
h) In one example, an unified template is used during the CPMV refinement.
   i. In one example, the TM cost associated with the unified template is used to determine the MV shift value.
   ii. In one example, the TM cost associated with the unified template is used to determine the CPMV combination.
   iii. In one example, an unified template may comprise all or partial adjacent samples of the whole block, i.e. as shown in FIG. 16.
i) A template may only comprise samples from one component such as luma, or from multiple components such as luma and chroma.
j) In one example, for arbitrary template, a reference template region with the same shape may be located with a MV, as shown in FIG. 16.
k) In one example, a template may not necessarily contain all the pixels in a certain region, it may contain part of the pixels in the specified region.

2. When constructing an Affine candidate list, CPMV refinement may be firstly performed to a potential affine candidate, then the refined candidate is inserted into the Affine candidate list.
a) In one example, alternatively, CPMV refinement is conducted after the Affine candidate list is constructed.
   i. In one example, only the Affine candidate(s) with specific index(es) need to perform CPMV refinement.
   ii. In one example, all or partial Affine candidates need to perform CPMV refinement.
   iii. In one example, similarity check is firstly conducted to determine whether a candidate needs to perform CPMV refinement or not.
      1) In one example, the candidates in the list are traversed in a certain order. The i-th candidate C_i may only not need to perform refinement when it is similar enough compared with arbitrary candidate in {C_1 . . . , C_i−1}.
         a) In one example, the traverse order may be derived based on TM cost.
         b) In one example, specifically, a pair of candidates may be considered similar enough if the all the CPMV difference are smaller than a threshold, and/or the same prediction direction, and or reference frame is used.
         c) In one example, the candidates in {C_1 . . . , C_i−1} may already be refined by TM.

3. In one example, a first Affine candidate list is constructed firstly, followed by a second Affine candidate list construction process.
a) For example, the input of the second Affine candidate list generation may be based on the output of the first Affine candidate list generation.
b) For example, the first Affine candidate list may be constructed without CPMV refinement.
c) For example, the second Affine candidate list may be generated by applying CPMV refinement on the CPMV candidates in the first Affine candidate list.
   i. For example, at least one CPMV candidate in the first Affine candidate list may be refined.
   ii. Alternatively, more than one CPMV candidates in the Affine candidate list may be refined.
   iii. For example, the CPMV refinement may be based on TM.
d) For example, the first Affine candidate list may be constructed with a candidate reordering process.
   i. For example, the reordering process may be based on TM.
e) For example, the second Affine candidate list may be constructed without any candidate reordering process.
f) For example, different pruning rules may be used in the first pruning and the second pruning.
   i. For example, the first Affine candidate list generation may be applied associated with a first pruning method.
   ii. For example, the second Affine candidate list generation may be applied associated with a second pruning method.
   iii. For example, the threshold for motion similarity checks in the first and second pruning methods may be different.
   iv. For example, a block dimension (e.g., block width and/or height) based threshold may be used in the second pruning method.
   v. For example, alternatively, a fixed threshold may be used in the second pruning method.

4. For a given Affine candidate, some or all of the CPMVs may be refined based on TM, then the refined CPMVs are used to derive the Affine motion information for the current block and/or sub-block(s).
a) In one example, both integer and fractional precision may be used to refine the control points.
   i. In one example, only integer precision is used to refine the control point, and fractional precision searching is skipped.
      1) In one example, whether fractional precision search is needed depends on the results of integer precision search.
   ii. In one example, it is proposed to use a specific interpolation filter to generate reference templates for motion vectors pointing to fractional positions.
      1) In one example, a simplified interpolation filter may be applied.
      2) In one example, the simplified interpolation filter can be 2-tap bilinear, alternatively, it can also be 4-tap, 6-tap or 8-tap filter that belongs to DCT, DST, Lanczos or any other interpolation types.
      3) In one example, a more complex interpolation filter (e.g., with longer filter taps) may be applied.
   iii. In one example, whether to use above methods (e.g., integer precision, different interpolation filters) or not and/or how to use above methods can be signalled in the bitstream (such as in SPS, PPS, picture header, slice header, CTU, CU, etc.) or determined on-the-fly according to decoded information.
      1) In one example, which method to be applied may be dependent on the coding tool.
      2) In one example, which method to be applied may be dependent on block dimension.
b) In one example, different control points are respectively refined, which means the MV shift values (i.e., the difference between an initial CPMV and the corresponding refined CPMV) may be different for different control points.
   i. In one example, all or some of the control points may first be respectively refined by TM, then one combination of control points is determined by looping over all or some of the combinations (i.e. M (such as M=4) combinations for 4−parameter model, −N (such as N=8) combinations for 6-parameter model) of CPMVs before and after refinement, and one set of CPMVs that minimize the TM cost of the current block is derived.
      1) In one example, in above case, all or some of the control points may first be refined by the respective separate templates.
      2) In one example, for each combination of CPMVs, the sub-block level motion information is calculated for the boundary sub-blocks, then the unified TM cost is calculated in accordance with the method described in section 2.4 and FIG. 17. The optimal combination which yields the least TM cost is selected as the refined Affine candidate.
         a) In one example, only partial boundary sub-blocks need to calculate the TM cost.
      3) In one example, alternatively, there is no need to loop over all the combinations, and the combination of which the control points are all refined by TM is directly served as the refined Affine candidate.
      4) In one example, when the refined Affine candidate is derived, a 2^{nd} pass control point refinement may be performed to further refine each control point.
         a) In one example, each CPMV is further iteratively refined to minimize the TM cost of the current block. In each iteration, one CPMV is refined while the others are fixed.
c) In one example, alternatively, multiple control points are simultaneously refined, where a same MV shift value is shared for all or multiple control points.
   i. In one example, all or partial MV shift values in a given MV shift set are traversed one by one. The MV shift value being traversed is assigned to all or multiple CPMVs, then the motion information of the boundary sub-blocks associated with the refined CPMVs are calculated, and the TM cost is formulated accordingly. In this process, the one that yields the least TM cost is determined as the best motion shift value, which may be finally used to refine the CPMVs.
      1) In one example, specifically, multiple integer MV shift values are respectively traversed, the one yielding the least TM cost are determined as the initial search point for fractional shift value.
d) In one example, the refined Affine candidate may replace the original one.
   i. In one example, the refined Affine candidate will always replace the original one.
   ii. In one example, alternatively, the refined Affine candidate will conditionally replace the original one.
      1) In one example, specifically, the TM costs associated with the original CPMVs (termed as C_beforeTM) and the refined CPMVs (C_afterTM) are respectively calculated, and the refined Affine candidate will replace the original one only when the ratio of C_afterTM and C_beforeTM is smaller (or larger) than a constant or an adaptively determined value TH.
         a) In one example, in above case, different coding modes, e.g., Affine merge/Affine AMVP/Affine MMVD, may have different TH value settings.
   iii. Alternatively, the refined Affine candidate may be used as a new candidate.
      1) In one example, the refined Affine candidate may be placed in a position adjacent to (i.e., right before or after) the original one in the Affine candidate list.
      2) In one example, alternatively, the refined Affine candidates may be placed in arbitrary positions in the Affine candidate list.
      3) In one example, a refined affine candidate may be compared with at least one candidate already in the candidate list. If they are the same or similar, then it is not added into the list.

5. The CPMV refinement may be used with regression based Affine candidate derivation method.
a) In one example, after all or some of the CPMVs are refined with TM (yielding Affine_model_TM), the motion information of the boundary sub-blocks associated with Affine_model_TM are derived, which is then fed to a regression model to output a new Affine model (termed as Affine_model_R). Then the TM cost of boundary sub-blocks with Affine_model_TM and Affine_model_R are respectively calculated and compared. And the one with less TM cost is determined as the ultimate refined Affine candidate.
   i. In one example, all or some of the CPMVs may firstly perform integer precision TM refinement (yielding Affine_model_TM_I), then perform fractional precision TM refinement (yielding Affine_model_TM_F). And the motion information of the boundary sub-blocks associated with Affine_model_TM_I is derived, which is then fed to a regression model to output a new Affine model (Affine_model_R). Finally, the TM cost of boundary sub-blocks with Affine_model_TM_F and Affine_model_R are calculated and compared, and the one with less TM cost is determined as the ultimate refined Affine candidate.
   ii. In one example, only partial sub-blocks may need to calculate TM cost to generate Affine_model_TM, Affine_model_TM_I and/or Affine_model_TM_F.

6. In one example, TM-based refinement may be applied to affine merge or affine AMVP (affine inter).
a) In one example, the MVP(s) of affine AMVP may be refined based on TM.
   i. Alternatively, the MVP(s) of affine AMVP may be refined based on DMVR.
b) In one example, for affine AMVP (inter) mode, whether TM-based refinement is performed or not may be dependent on the precision of MV or MVD.
   i. In one example, specifically, TM-based refinement is performed only when specific MV/MVD precision is used for a block.
c) In one example, different MV shift sets or searching procedures may be used for affine merge and affine AMVP (affine inter).
   i. In one example, specifically, different number of MV shift value may be used for affine merge and affine AMVP (affine inter).
   ii. In one example, for affine AMVP (affine inter), there is no need to compute TM cost for certain MV shift if the initial CPMVs and that with the MV shift yields the same CPMVs after rounding to certain precision.

7. In one example, TM-based refinement may be applied to an affine-coded block together with DMVR-based refinement.
a) In one example, TM-based refinement may be applied before DMVR.
b) In one example, TM-based refinement may be applied after DMVR.
c) Alternatively, TM-based refinement may be applied to an affine-coded block exclusively with DMVR-based refinement.

8. In one example, derivation of TM cost may depend on whether the block is bi-predicted or uni-predicted.
a) If the block is bi-predicted, TM cost may be derived based on bi-prediction on TM.
   i. In one example, let TMref0 and TMref1 be the reference TM associated with the List0 and List1 respectively, then the ultimate reference TM (TMbi) may be derived as:

$$TMbi = a * TM ref 0 + ( 1 - a ) * TMref 1.$$

1) In one example, a equals to 0.5.
2) In one example, a is determined based on BCW index.
3) In one example, TMref0 is generated based on the CPMVs in List 0, and/or TMref1 is generated based on the CPMVs in List 1.
b) Alternatively, if the block is bi-predicted, TM cost may be calculated for List0 and List1 separately.

9. In one example, the refinement of CPMVs may be done in an iterative way.
a) For example, in one step of refinement, one CPMV is refined while others are fixed.
b) In one example, the already refined CPMV(s) may be used when a subsequent CPMV is to be refined.
   i. In one example, alternatively, the CPMV before refinement is used when the subsequent CPMVs are to be refined.
c) In one example, the refinement of CPMVs may be done in an iterative way for bi-predicted blocks.
   i. In one example, the CPMVs associated with List K(K=0 or 1) may be firstly refined, then the CPMVs associated with List (1−K) are refined.
      1) Whether to and/or how to refine the CPMVs in a later List (1−K) may be determined based on the refined CPMVs of a former List K.
      ii. In one example, the CPMVs associated with List 0 and List 1 may be separately refined.
         1) In one example, specifically, when the CPMVs in List K(K=0 or 1) are being refined, for each searching step, uni-directional reference TM in List K is generated based on the corresponding CPMVs, and TM cost is hereby calculated to determine the best MV shift value.
      iii. In one example, alternatively, the CPMVs associated with List 0 and List 1 may be jointly refined.
         1) In one example, specifically, when the CPMVs in List K(K=0 or 1) are being refined, for each searching step, bi-directional reference TM is generated based on the CPMV information of both List (as described in Bullet 8). The one yielding the least TM cost is determine as the best MV shift value.

10. Multiple rounds of refinement may be conducted to CPMVs.
a) In one example, all or partial CPMVs may be refined in each round of refinement.
b) In one example, all or partial CPMVs may already be refined in a former round refinement, then a later round is conducted to further refine the CPMVs.

11. Whether to and/or how to refine the CPMVs based on TM may be determined based on the prediction direction of the current block.
a) In one example, the CPMVs may need to be refined by TM only when the current block is uni-predicted.
b) In one example, the CPMVs may need to be refined by TM only when the current block is bi-predicted.
c) In one example, the CPMVs may always need to be refined by TM no matter whether the current block is bi-predicted or not.

12. More than one CPMV refinement processes may be cascaded for an affine coded block.
a) For example, an affine DMVR process may be applied based on refined CPMVs.
   i. For example, a first step of CPMV refinement for affine mode (e.g., affine merge, and/or affine amvp) may be an explicit (MMVD based) and/or implicit (e.g., TM based) CPMV refinement process.
      1) For example, for the explicit refinement, block level syntax elements such as MMVD index, and/or MMVD step, and/or MMVD distance, may be signalled in the bitstream.
      2) For example, for the implicit refinement, the CPMVs may be refined at the decoder side (e.g., TM based) without block level signalling.
   ii. For example, a second step of CPMV refinement for affine mode (e.g., affine merge, and/or affine amvp) may be a DMVR based refinement process (e.g., regression based affine DMVR, and/or affine DMVR which adding translation offsets to CPMVs), and the affine merge DMVR process may be conducted based on the refined CPMVs obtained at the first step.
      1) Furthermore, for example, two different affine DMVR processed may be applied, e.g., one is regression based and the other is not regression based.
   iii. For example, the bilateral cost may be computed and used to determine the DMVR based offsets.
b) Alternatively, the CPMVs may be firstly refined based on DMVR, then afterwards, the DMVR refined CPMVs may be further refined by an explicit (MMVD based) and/or implicit (e.g., TM based) CPMV refinement process.

13. For example, pixel/sample based affine prediction may be applied based on the refined CPMVs.
a) For example, the refined CPMVs may be derived based on explicit method (e.g., MMVD based), and/or TM based refinement, and/or DMVR based refinement.
b) For example, the refined CPMVs may be applied for uni-directional affine prediction, and/or bi-directional affine prediction.
c) For example, the refined CPMV based pixel/sample affine prediction may be applied for affine merge, and/or affine AMVP mode.

14. The disclosed methods may be applied to MHP (Multiple hypothesis prediction) coded block if Affine prediction is used as a hypothesis.

15. The Affine candidate list may simultaneously contain two alternative versions (e.g., refined and non-refined version) of an Affine candidate.
a) In one example, the original candidate and a TM-refined (or bilateral matching-refined) version of the same candidate may simultaneously appear in the Affine list.
   i. In one example, whether two alternative versions appear in the Affine list for a same candidate or not may depend on the prediction direction (e.g., bi- or uni-predicted) of the candidate.
   ii. In one example, after a preliminary Affine list is constructed, the candidates in the list may be checked in some certain order (e.g., TM cost). If the current candidate satisfies certain condition (e.g., uni-predicted), then the alternative version of the candidate is used to append the list.
      1) In one example, if the current candidate is already refined, then the alternative version (i.e., non-refined version) of the candidate may be used to append the list, and vice versa.
      2) In one example, the alternative version may be used to replace certain or arbitrary candidate.
         a) In one example, the alternative version may be used to replace the candidate with or after a specific index A.
         i. In one example, A may be a constant value.
         ii. In one example, the index of the first candidate with all-zero CPMVs is determined as A.
         iii. In one example, A may be dependent on the candidate number of certain type(s) of Affine candidate.
   iii. In one example, the ultimate Affine candidate index is determined based on the initial Affine index I and a variable B.
      1) In one example, the initial Affine index I may be parsed in the bitstream.
      2) In one example, B may be arbitrary value ranging from 0 to the maximum allowed Affine candidate number.
      3) In one example, the index of the first candidate with all-zero CPMVs in the Affine list may be determined as B.
      4) In one example, if I is smaller than B, then I is used to specify the Affine candidate.
         a) Alternatively, if I is larger than or equal to B, then an adjusted index is derived, which is used to specify Affine candidate.
         i. In one example, the adjusted index may be (I−B).
         ii. In one example, the adjusted index may be dependent on I, B, and/or the prediction direction of the candidates.
         iii. In one example, the alternative version of the candidate specified by the adjusted index may be used as the ultimate Affine candidate.
         1. In one example, If the candidate specified by the adjusted index is already refined, then the non-refined version will be used to generate Affine prediction, and vice versa.

16. Whether to and/or how to apply the disclosed methods above may be determined based on syntax element(s).
a) For example, at least one syntax element is signalled in the bitstream.
b) For example, whether to and/or how to apply the disclosed methods may be signalled at sequence level/group of pictures level/picture level/slice level/tile group level, such as in sequence header/picture header/SPS/VPS/DPS/DCI/PPS/APS/slice header/tile group header.
c) For example, whether to and/or how to apply the disclosed methods may be signalled at PB/TB/CB/PU/TU/CU/VPDU/CTU/CTU row/slice/tile/sub-picture/other kinds of region contain more than one sample or pixel.
d) For example, whether to and/or how to apply the disclosed methods above may be dependent on coded information, such as block size, colour format, single/dual tree partitioning, colour component, slice/picture type.
e) For example, whether a syntax element (i.e., indicating if TM refinement is applied to CPMVs) is signalled or not may be determined based on another syntax element.

### 2.10. Extensions of Motion Vector Prediction List Construction Based on Template Matching Cost Ordering

In this disclosure, an optimized MVP list derivation method based on template matching cost ordering is proposed. Instead of constructing the MVP list based on a predefined traversing order, it is investigated an optimized MVP selecting approach by taking advantage of the matching cost in the reconstructed template region, such that more appropriate candidates are included in the list.

In this disclosure, it is also proposed to improve inter coding process by introducing more TMVPs, which are generated based on the motion information from multiple collocated frames. Besides, we also improve inter coding tools by introducing the template matching. It should be noted that the proposed strategy can be utilized in arbitrary coding tools that require temporal motion information's, including but not limited to normal merge and AMVP list construction, merge with motion vector difference (MMVD), Affine motion compensation, Subblock-based temporal motion vector prediction (SbTMVP), Adaptive DMVR and so on. It should be noted that the proposed strategy for TMVP derivation can be utilized in arbitrary coding tools that require MVP list construction process, including but not limited to normal merge and AMVP list construction, merge with motion vector difference (MMVD), Affine motion compensation, Subblock-based temporal motion vector prediction (SbTMVP), Adaptive DMVR and so on.

It should be noted that the proposed strategy for MVP list construction can be utilized in normal merge and AMVP list construction process and can also be easily extended to other modules that require MVP derivation, e.g., merge with motion vector difference (MMVD), Affine motion compensation, Subblock-based temporal motion vector prediction (SbTMVP) and so on.

In the following discussion, category represents the belongingness of a MVP candidate, e.g., non-adjacent MVP candidates belong to one category, HMVP candidates belonging to another category. A group denotes a MVP candidate set which contains one or multiple MVP candidates. In one example, a single group denotes an MVP candidate set in which all the candidates belong to one category, e.g. adjacent MVP, non-adjacent MVP, HMVP, etc. In another example, a joint group denotes an MVP candidate set which contains candidates from multiple categories. list can either be MVP candidate MVP candidate list, TMVP candidate list, motion shift candidate list or sub-CU level MVP candidate list, where MVP candidate list represents a group of MVP candidates that can be selected as MVP in video coding process. TMVP candidate list represent a group of TMVP where each candidate within the group has the potential to be selected as the candidate in MVP candidate list. Motion shift candidate list represents a group of MV candidates that point to the collocated frame in video coding process. Sub-CU level MVP candidate list represent a group of motion candidates that provide sub-CU level motion fields, including SbTMVP candidates, AFFINE candidates and so on.

The detailed embodiments below should be considered as examples to explain general concepts. These embodiments should not be interpreted in a narrow way. Furthermore, these embodiments can be combined in any manner. Combination between this patent application and others are also applicable.

1. Multiple thresholds to determine whether a candidate could be added to a candidate list may be utilized in the candidate pruning process.
a) A threshold may be used to determine whether a potential candidate can be put into a candidate list.
   i. For example, if the absolute difference of at least one component of the MV of the potential candidate and that of a candidate existing in the candidate list is smaller than a threshold, the potential candidate is not put into the list.
   ii. For example, if the absolute difference of all components of the MV of the potential candidate and that of a candidate existing in the candidate list is smaller than a threshold, the potential candidate is not put into the list.
b) In one example, the candidate is a MVP candidate, the candidate pruning process is the MVP candidate pruning process, and the candidate list is a motion candidates list.
   i. In one example, the motion candidate list is a merge candidate list.
   ii. In one example, the motion candidate list is a AMVP candidate list.
   iii. In one example, the motion candidate list is an extend merge or AMVP list, such as sub-block merge candidate list, affine merge candidate list, MMVD list, GPM list, template matching merge list, biliteral matching merge list etc.
c) In one example, the pruning thresholds may be different for two groups, where the group can be either a single group (containing only one category of candidates) or a joint group (containing at least two categories of candidates).
d) Alternatively, only one threshold is used for all potential MVP candidates regardless of category and/or groups.
e) In one example, N (e.g., N=2) thresholds are used in the pruning process.
   i. Assume A is the MVP set which contains all available MVP candidates regardless of category, in one example, a first threshold is used for a first subset of candidates in set A, and a second threshold is used for a second subset of candidates (e.g. the rest candidates excluding those in the first subset) in set A.
   ii. In one example, a first threshold is used for a single group denoted by A, and a second threshold is used for another group (single or joint)/multiple other groups/rest of candidates which are not with the same category as those in A.
      1) In one example, a first threshold is used for the single group of adjacent candidates, and a second threshold is used for the rest candidates, including but not limited to non-adjacent MVP, HMVP, pairwise MVP and zero MVP.
   iii. The first threshold may be larger than or smaller than the second threshold.
f) Alternatively, furthermore, the threshold for a MVP category or group may be dependent on the decoded information, e.g., block dimension/coding methods (e.g., CIIP/MMVD) and/or the variance of motion information within the category or group.

2. Multi-pass reordering can be performed to construct a MVP list.
a) In one example, the multi-pass may involve different reordering criteria.
b) In one example, multi-pass reordering can be performed to multiple single/joint groups, wherein at least two single/joint groups may have overlap MVP candidates or not.
c) In one example, K-pass (e.g., K=2) reordering is used to construct a MVP list.
   i. In one example, in the first pass, a single/joint group A is firstly reordered based on a first cost (e.g. template matching cost) sorting, and the candidate with the largest cost (CL) in A is identified and then transferred to another single/joint group B (e.g. B may comprise the rest of candidates which are not with the same category as those in A). Subsequently, group B conduct the 2 to K pass reorder based on the first cost (or other cost metrics) sorting. Finally, the candidates in group A (except CL) and B (CL included) are included in the MVP list in accordance with the sorted order.
   ii. In one example, the group A in above case is a single group of adjacent candidates, and group B is a joint group of non-adjacent candidates and HMVP.
   iii. Alternatively, group A and B may be any other single or joint candidate group.
   iv. In one example, in the first pass, one or multiple single/joint groups are firstly reordered based on a first cost (e.g. template matching cost) sorting. Then a preliminary MVP list is constructed by inserting some of the candidates in each group into the list with the sorted order. Subsequently, the preliminary MVP list performs the second pass reorder to select partial candidates into the ultimate MVP list.
      1) In one example, different single/joint groups may have overlap candidates or not.
      2) In one example, all of the candidates in the preliminary MVP list are selected from the sorted single/joint groups.
      3) Alternatively, partial candidates in the preliminary MVP list are selected from the sorted groups, and the rest candidates are included into the list with other rules.
      4) In one example, in the second pass, all the candidates in the preliminary list, regardless of the corresponding categories, are sorted based on a cost (e.g. template matching cost), and only limited number of candidates are included into the ultimate MVP list based on the sorted order.
         a) Alternatively, furthermore, all the candidates in the preliminary MVP list are included in the ultimate MVP list in accordance with the sorted order.
      5) The cost (e.g. template matching cost) calculated in a former pass can be re-used in a later pass.
         a) In one example, when the cost for a certain candidate is calculated in a former pass, it will be saved in a variable or any other data structure in case the same cost is needed in a later pass.
         b) In one example, in a later pass, if the cost for a certain candidate is needed, it will first check whether this cost has been calculated before or not. If this cost has been calculated and/or saved before, and/or is accessible in the current pass, it will be fetched in the current pass instead of calculating again.

3. At least one virtual candidate (e.g., pairwise MVP and zero MVP) may be involved in the at least one group.
a) In one example, all the virtual candidates are treated with one joint group.
   i. Alternatively, each category of virtual candidates is treated as a single group.
   ii. In one example, the pairwise MVP and/or zero MVP are included in a single/joint group.
   iii. Alternatively, furthermore, the group which contains the virtual candidates is reordered and then put into a candidate list.
b) Alternatively, the virtual candidates (e.g., pairwise MVP and/or zero MVP) are not included in any single/joint group.
   i. Alternatively, furthermore, no reordering process is applied to virtual candidates.
      1) Alternatively, furthermore, they may be further appended to candidate list.
   ii. In one example, one or more single/joint groups are constructed, where partial or all of the groups are reordered. In this case, at least one position in MVP list is preserved for the virtual candidates (e.g., pairwise MVP and/or zero MVP), which are appended to MVP list as the last or any other entry.
   iii. In one example, furthermore, a single group of adjacent candidates is firstly included in the MVP list, then a joint group of non-adjacent and HMVP are reordered and subsequently appended to MVP list. In this case, at least one position is preserved for the virtual candidates (e.g., pairwise MVP and/or zero MVP), which are appended to MVP list as the last or any other entry.
   iv. In one example, furthermore, a joint group of adjacent candidates, non-adjacent and HMVP are reordered and subsequently appended to MVP list, and the virtual candidates (e.g., pairwise MVP and/or zero MVP) are appended to MVP list as the last or any other entry.
c) Alternatively, the virtual candidates (e.g., pairwise MVP) of one category is included in a single/joint group and the virtual candidates of another category is not included.
d) In one example, no virtual candidates (e.g., pairwise MVP and/or zero MVP) appear in the ultimate MVP list when reordering operation is performed for MVP list construction.

4. The number of candidates of a single/joint group may not be allowed to exceed a maximum candidate number.
a) In one example, a single/joint group is constructed with limited amount of candidates constrained by maximum number Nᵢ, where iϵ[0, 1, . . . , K] is the index of the corresponding group. NA may be the same or they may be different for different i.
b) In one example, partial candidates in a single/joint group are limited by maximum number N.
   i. In one example, one or multiple categories of candidates in a group are constructed with limited amount Nᵢ, while other categories in the same group can be included with arbitrary number.
      1) In one example, the categories include but not limited to adjacent candidates, non-adjacent candidates, HMVP, pairwise candidates, etc.
c) Alternatively, a first single/joint group may be constructed with at most Nᵢ MVP candidates, while a second single/joint groups may not have such constraint.
d) In one example, Nᵢ is a fix value shared by both encoder and decoder.
   i. Alternatively, Nᵢ is determined by encoder and signalled in the bitstream. And decoder decodes Nᵢ value and then construct the corresponding iₜₕ single/joint group with at most N, candidates.
      ii. Alternatively, Nᵢ is derived in both encoder and decoder with the same operations, such that there is no need to signal the Nᵢ value.
         1) In one example, encoder and decoder may derive the Nᵢ value based on the variance of all available motion information for iₜₕ group.
         2) Alternatively, encoder and decoder may derive the Nᵢ value based on the number of all available candidates for iₜₕ group.
         3) In one example, encoder and decoder may derive the Nᵢ value based on the number of the available adjacent candidates.
         a) In one example, Nᵢ is set to N−NADJ, where N is a constant, N_{ADJ} is the number of the available adjacent candidates.
         4) Alternatively, furthermore, encoder and decoder may derive the Nᵢ value based on any information that encoder/decoder can both access to when constructing the MVP list.
e) In one example, all or partial of the single/joint groups may share a same maximum candidate number N.

5. The construction of a single/joint group may depend on the maximum number constraint Nᵢ.
a) In one example, all available MVP candidates for iₜₕ group are included in the group in accordance with a certain order. Once the candidate number in the current group reaches Nᵢ, the construction for group i is terminated.
b) In one example, in above case, the order for group construction may be derived based on the distance between to-be-coded CU and MVP candidates, where a closer MVP candidate is assigned with a higher priority.
c) Alternatively, the order may be derived based on a cost (such as a template matching) cost, where a MVP with a less cost has a higher priority.
d) In one example, the construction of single/joint group is performed with at least one pruning operation in at least one group, or between groups.
e) In one example, the constructed single/joint group is further reordered based on at least one cost method (e.g., template matching cost), then some or all of the candidates in this group may be included in the MVP list.
   i. Alternatively, the candidates in the constructed single/joint group will not be further reordered, and some or all of the candidates in this group are included into the MVP list in the same order as they are included in the group.

6. On how to prune MVP candidates.
a) In one example, K-pass (e.g., K=2) pruning is performed to build a MVP list.
   1) In one example, a first pruning may be performed inside at least one single/joint group, and a second pass pruning may be performed between at least two candidates that belong to different groups.
      a) In one example, in the first pass pruning, the pruning thresholds for two single/joint groups may be the same, or may be different.
      b) In one example, furthermore, in the first pass pruning, some of single/joint groups may share a same threshold value, while other single/joint groups may use different threshold values.
   2) In one example, furthermore, the threshold for a certain pass or group is determined by the decoding information, including but not limited to the block size, coding tools been used (e.g., TM, DMVR, adaptive DMVR, CIIP, AFFINE, AMVP-merge).
      a) Alternatively, a threshold may be determined by at least one syntax element signaled to the decoder.

7. It is proposed to introduce K (e.g., K=2) collocated frames in video coding process.
a) In one example, motion vectors stored in at least one of the K collocated frame may be used to encode/decode the current frame.
b) In one example, these collocated frames can be arbitrary reconstructed frames in decoding picture buffer (DPB).
c) In one example, these collocated frames can be arbitrary reconstructed frames in arbitrary reference list.
   i. In one example, if the current to-be-coded frame has one or more than one reference lists, then the collocated frames may be selected from one or more than one list.
      1) In one example, if the reference frames with index N (e.g., N=0) in each list are not the same one (e.g. with different POC value), then these reference frames are selected as collocated frames.
         a) In another example, the reference frames with top-N index in each list are selected as collocated frames after performing redundance checking.
         b) Alternatively, any reference frame in arbitrary lists can be selected as collocated frames.
      2) In one example, if the current to-be-coded frame has one or more than one reference lists, the selected collocated frames may come from only one reference list.
         a) In one example, if the contents in each reference list are the same (e.g. low delay case), the selected collocated frames may come from only one reference list.

8. On how to select collocated frames. Let S denote the set that contains all the available reconstructed frames in DPB or reference list, and SK is an arbitrary candidate in S. Then:
a) Whether SK can be selected as collocated frame may be dependent on the POC distance between the to-be-coded frame and SK.
   i. In one example, all the candidates in S are sorted based on the POC distance between the to-be-coded frame and each candidate, then the top-N (N>0) candidates with the smallest distance are selected as collocated frames.
   ii. In one example, SK can be selected as a collocated frame only if the distance between it and the to-be-coded frame is smaller or larger than a threshold T(T>0).
   b) Whether SK can be selected as collocated frame may be dependent on the quantization parameter (QP) value.
      i. In one example, all the candidates in S are sorted based on the QP value, then the top-N (N>0) candidates with the smallest or largest QP are selected as collocated frames.
      ii. In one example, all the candidates in S are sorted based on the absolute QP distance between the to-be-coded frame and each candidate, then the top-N (N>0) candidates with the smallest distance are selected as collocated frames.
      iii. In one example, SK can be selected as a collocated frame only if the absolute QP difference between it and the to-be-coded frame is smaller or larger than a threshold T(T>0).
   c) Whether SK can be selected as collocated frame may be dependent on the frame type.
      i. In one example, SK cannot be selected as collocated frame if it is an I or P frame.
         1) Alternatively, SK can be selected as collocated frame even if it is an I or P frame.
   d) Whether SK can be selected as a collocated frame may be dependent on the the temporal layer or Tid of the to-be-coded frame.
      i. In one example, SK cannot be selected as a collocated frame if the Tid or temporal layer of the to-be-coded frame is smaller than (or larger than, or equal to) a threshold T(T>0).
      ii. In one example, the maximum allowed number of collocated frames can be used may be dependent on the Tid or temporal layer of the to-be-coded frame.
         1) In one example, at most N (N>0) collocated frames may be used if the Tid or temporal layer of the to-be-coded frame is smaller than (or equal to) a threshold T(T>0).
         2) In one example, at most M (M>0) collocated frames may be used if the Tid or temporal layer of the to-be-coded frame is larger than (or equal to) a threshold T(T>0).
         3) In one example, M and N in above example may be a same value or be different values.
e) In one example, multiple metrics are combined to determine which one is used as collocated frame.
   i. In one example, if N (N>1) frames in reference list or DPB have equal POC distance relative to the to-be-coded frame, then those with larger (or smaller) QP (or absolute QP distance relative to the to-be-coded frame) have higher priority to be selected as collocated frame.
   ii. In one example, if N (N>1) frames in reference list or DPB have equal QP, then those with larger (or smaller) POC (or absolute QP distance distance relative to the to-be-coded frame) have higher priority to be selected as collocated frame.
   iii. In one example, alternatively, if N (N>1) frames in reference list or DPB have equal absolute QP distance relative to the to-be-coded frame, then those with smaller (or larger) QP (or POC distance relative to the to-be-coded frame) have higher priority to be selected as collocated frame.

9. The selected collocated frame(s) may be signalled in the bitstream, including but not limited to slice header or SPS or PPS or picture parameter header.

a) Alternatively, both encoder and decoder derive the collocated frames based on a predefined rule, such that no additional information is needed to be transmitted.
b) In one example, partial collocated frames need to be signalled by the syntax elements, while other collocated frames are derived based on a predefined rule, such that no additional information is needed to be transmitted.
c) In one example, the information indicates which list the collocated frame come from (e.g. whether it comes from list 0) and the corresponding reference index are signalled in the syntax elements.
   i. In one example, specifically, if the number of reference frame in arbitrary reference list is zero, the information indicating the reference list may not need to be signalled.
   ii. In one example, specifically, if only one frame exists in the corresponding list, then the reference index may not need to be signalled.
d) In one example, the number of collocated frame(s) (denoted as N) may be coded in the bitstream.
e) In one example, indications of N collocated frames may be signalled after the number N is signalled.
f) In one example, a collocated frames may be indicated by a reference list and/or a reference index.
g) In one example, signalling of a first collocated frame may depend on a second collocated frame signalled before.
h) More than one collocated frames may be jointly coded.
i) A syntax element used to signal collocated frame(s) may be binarized with a fixed length coded, unary code, truncated unary code, Exponential Golomb code or any other coding methods.
j) In one example, the information related to collocated frame(s) may be signalled only if TMVP is enabled.

10. Multiple syntax elements may be signalled in the bitstream to identify multiple collocated frames, where each syntax element may specify different collocated frame.
a) In one example, when a new candidate is being checked, it needs to firstly check whether a same frame (e.g. with identical POC number) is already been selected before. If no such a frame has been selected before, it could be selected as a collocated frame if it satisfies certain conditions.
b) Alternatively, two or more syntax elements may identify a same collocated frame.
   i. In one example, if at least K (k>=0) collocated frames needs to be selected, and the number of available different frames is smaller than K, then redundant frames can be used as collocated frame.
   ii. In one example, a same collocated frame may be identified by different syntax elements, which may locate in different reference frame lists.
   iii. In one example, a same collocated frame may be identified by different syntax elements, which may also provide different temporal information if this collocated frame is used more than once.
      1) In one example, the MVs in different reference frame lists may be used when the same collocated frame is used more than twice.
         a) In one example, the MV either in list 0 or list 1 is used.
         b) In one example, the MV in both lists are used in a combined manner.

11. How many collocated frames are used may be dependent on the coding configuration.
a) In one example, the number of collocated frames used in different coding configurations may be different.
   i. In one example, the coding configurations may include random access (RA), low-delay B (LDB) or low-delay P (LDP) or any other configurations.
   ii. In one example, the maximum allowed number of collocated frames used in RA configuration may be larger than (or smaller than, or equal to) that of LDB or LDP configuration.
      1) In one example, at most K (e.g. K=2) collocated frames are used in RA configuration, and at most M(e.g. M=1) collocated frames are used in LDB/LDP configuration.
      2) In one example, M and K in above examples may be a same value or be different values.

12. How many collocated frames are used may be dependent on the status of reference frame list.
a) In one example, the number of collocated frames used in coding process may be dependent on whether the POC values of all the reference frames are smaller (or larger) than that of the to-be-coded frame or not.
   i. In one example, if all the reference frames have smaller (or larger) POC value than that of the to-be-coded frame, then at most M (e.g. M=1) collocated frames may be used.
   ii. In one example, if some of the reference frames have smaller POC value than that of the to-be-coded frame, and some other reference frames have larger POC value than that of the to-be-coded frame, then at most K (e.g. K=2) collocated frames may be used.
   iii. In above examples, M and K may be a same value or be different values.
b) In one example, whether a reference frame can be used as collocated frame may be dependent on the POC distance between it and the to-be-coded frame.
   i. In one example, a reference frame may not be used as collocated frame if the POC distance between it and the to-be-coded frame larger than (or smaller than, or equal to) a threshold T.
      1) In one example, in above example, T may be a constant or be an adaptively determined value.
   ii. In one example, for each reference frame in reference frame list, the POC distance between it and current frame is calculated, and if the smallest POC distance value is smaller than a threshold T, then no collocated frame is used for the current frame.
      1) In one example, in above example, T may be a constant or be an adaptively determined value.
      2) In one example, specifically, in this case, no TMVP (or sbTMVP/temporal AFFINE control point) exists in the corresponding candidate list.

13. In one example, the determination of collocated frame(s), such as the number of collocated frames and whether a reference frame is a collocated frame, may depend on the coding information of at least one reference frame.
a) In one example, a reference frame cannot be used as a collocated frame if it is an I-frame.
b) In one example, a reference frame cannot be used as a collocated frame if the number of intra-coded blocks in the reference frame is larger than a threshold.

14. How many collocated frames or/and which reference frame(s) are used (as collocated frame) may be dependent on certain characteristics of a coding block.
a) In one example, for arbitrary two coding blocks that belong to the same frame/slice/tile, the collocated frame(s) being used may be the same or not.
   i. In one example, for arbitrary two coding blocks that belong to the same frame/slice/tile, the maximum allowed number of collocated frame can be used may be the same or not.
   ii. In one example, for arbitrary two coding blocks that belong to the same frame/slice/tile, how many collocated frames or/and which reference frame(s) are used (as collocated frame) may be the same or not.
b) In one example, for certain coding blocks, how many collocated frames or/and which reference frame(s) are used (as collocated frame) may be dependent on the characteristics of a coding block.
   i. In one example, the characteristics may be:
      1) Block size.
      2) Qp.
      3) Prediction information (e.g. uni-predicted or bi-predicted).
c) In one example, for certain coding blocks, how many collocated frames or/and which reference frame(s) are used (as collocated frame) may be dependent on the usage of some coding tools.
   i. In one example, the coding tools may include but not limited to: 1) regular/TM/CIIP/MMVD/GPM/TPM/subblock merge mode.
      2) AMVP.
      3) AMVP-merge.
      4) AFFINE.
      5) BDOF.
      6) LIC.

15. It is proposed to introduce K (k>=1) TMVPs in video coding process, which may locate in one or multiple collocated frames.
a) In one example, at most C(C>=0) TMVPs are inserted into MVP/TMVP candidate list regardless whether they are from one or multiple collocated frames, where C is a constant or an adaptively determined number.
b) In one example, in the MVP/TMVP candidate list, the maximum allowed number of TMVP in a certain collocated frame is constrained by a constant or an adaptively determined number.
c) In one example, encoder traverses all the collocated frames in a predefined or adaptively determined order to get in total C(C>=0) TMVPs, and for each collocated frame, at most D(D>=0) TMVPs is obtained, where D may vary from one collocated frame to another. The traversing process terminates when the total number of TMVP reaches C, or all the collocated frames have been traversed.
d) In one example, the number of TMVPs to be used in a list may be signalled in the bitstream, such as in SPS/PPS/picture header/slice header/etc..

16. Different collocated frames may be assigned with different priority.
a) In one example, the priority of a collocated frame is determined based on the corresponding QP value, where those with larger QP are assigned with higher priority.
   i. Alternatively, the collocated frames with smaller QP are assigned with higher priority.
b) In one example, the priority of a collocated frame is determined based on the temporal distance relative to the current frame, where those with smaller distance are assigned with higher priority.
   i. Alternatively, a collocated frame with a larger distance is assigned with a higher priority.
c) In one example, the priority of a collocated frame is determined based on the index in the corresponding reference list.
   i. In one example, the reference frame with a smaller index has a higher priority.
d) In one example, this priority is associated with TMVP construction process and any other process in video coding.
   i. In one example, all the collocated frames are traversed in a descending order of priority. When an arbitrary collocated frame Fi is selected, K (K>=0) positions will be traversed to include TMVPs in the TMVP/MVP candidate list, where K may be the same for each collocated frame, or be different from one to another. Once the number of existing TMVP reaches the maximum allowed number M(M>=0), the iteration terminates and the collocated frames with lower priority are skipped. Otherwise, all the collocated frames will be traversed to construct TMVP/MVP candidate list.
   ii. In another example, K(K>=0) positions are respectively checked in accordance with some certain orders to get TMVP candidates. For i-th position being checked, the specific position in all the collocated frames are traversed in a descending order of priority, and the available TMVPs are included in the list. Once the number of existing TMVP candidates reaches the maximum allowed number M(M>=0), the iteration terminates and the rest positions and collocated frames with lower priority are skipped. Otherwise, all the positions and collocated frames will be traversed to constructed TMVP/MVP candidate list.
      1) Alternatively, in above case, for a certain TMVP position, at most N (N>=0) TMVPs are included in the list.
         a) In one example, for a certain TMVP position, if N (N>=0) TMVPs in high-priority collocated frame has already been included in the list, the same position in low-priority collocated frames will not be checked.
         b) Alternatively, for a certain TMVP position, arbitrary N(N>=0) TMVPs can be included in the list regardless of priority.
e) In one example, a collocated frame with a lower priority is used as backup, which is activated only when TMVP or any other information in a high-priority collocated frame does not exist.
   i. In one example, for a certain position in different collocated frames, if the required information (e.g. TMVP) in high-priority collocated frame is available, then this information is used in coding process, and the checking process for the following collocated frames is skipped. Otherwise, the same position in low-priority collocated frames are checked, and the corresponding information is used if it exists.
   ii. Alternatively, in above case, the information in lower-priority collocated frames are also used even though that of high-priority collocated frames exists.
f) Alternatively, different collocated frames are assigned with equal priority.
   i. In one example, a TMVP candidate set is built to include all or part of the potential TMVPs that may locate in any one of the collocated frames, which is then sorted in a certain order (e.g. template matching cost), and top-N(N>=0) candidates in the sorted list will be selected as the ultimate TMVPs.
g) In one example, different collocated frames may come from different reference frame lists.
   i. In one example, the high-priority collocated frame can only be selected from reference list 0 (or list 1).
      1) In one example, alternatively, the high-priority collocated frame can only be selected from reference list 1 (or list 0).
   ii. In one example, whether the low-priority collocated frame is selected from list0 or list1 may depend on the high-priority collocated frame.
      1) In one example, if the high-priority collocated frames comes from list0, then the low-priority collocated frame may come from either list0 or list1.
      2) In one example, if the high-priority collocated frames comes from list1, then the low-priority collocated frame can only come from either list1.
      3) In one example, alternatively, if the high-priority collocated frames comes from list1, then the low-priority collocated frame may come from either list0 or list1.

17. The proposed collocated frames can be used in any coding tool in video coding process, including but not limited to regular/CIIP/MMVD/GPM/TPM/subblock merge, AMVP, AFFINE, adaptive DMVR and so on.
a) In one example, M (M>=0) TMVPs are selected from N (N>=0) collocated frames, where each collocated frame selects equal number of TMVPs or not.
b) In one example, TMVP candidate lists are firstly built, then all or partial of the candidates in the TMVP lists are included in the ultimate MVP list.
   i. In one example, S (S>=0) TMVP candidate lists are firstly built, which is then respectively sorted in some certain metrics, e.g. template matching cost, and top-M (M>=0) candidates in each TMVP list are included into the ultimate merge candidate list, where K may be a same constant for all the collocated frame, or be different from one to another.
   ii. In one example, the TMVP candidate list is respectively built for each one of the collocated frames, each list include all or partial of available TMVP candidates in the corresponding collocated frame, which is then sorted in a certain metrics, e.g. template matching cost, and top-M (M>=0) candidates are included into the ultimate merge candidate list, where K may be a same constant for all the collocated frame, or be different from one to another.
   iii. In one example, alternatively, only one TMVP candidate list is built to include all or a constant number of available TMVP candidates in all the collocated frame, which is then sorted in a certain metrics, e.g. template matching cost, and top-M(M>=0) candidates are included into the ultimate merge candidate list.
   iv. In one example, the sorting metric mentioned above can also be the distance between a certain candidate and the current block.
c) In one example, alternatively, no TMVP candidate lists needs to be built, the TMVPs associated with some certain positions in one or multiple collocated frames are directly included int the MVP list.
d) In one example, alternatively, H (H>=0) TMVP candidates are firstly included in a joint candidate group which contains multiple types of MVP candidates, then top-M(M>=0) candidates are included into the ultimate merge candidate list in accordance with some certain metrics.
   i. The type of the MVP candidates in the joint group includes but not limited to adjacent candidates, non-adjacent candidates, HMVPs, zero candidates, constructed candidates and so on.
   ii. H (H>=0) TMVP candidates may be collected from partial or all of the collocated frames.
   iii. In one example, the sorting metric can be templated matching cost or bilateral matching cost.

18. In one example, at least two TMVPs which may come from different collocated frames may be jointly used to generate the final prediction.
a) In one example, the average or weighted average of the two or more TMVPs may be used as a MV or MVP of the current block.
b) In one example, the predictions generated by the two or more TMVPs may be averaged or weighted averaged to generate a prediction of the current block.

19. It is proposed to construct at least one motion shift list to derive the motion shift for SbTMVP/AFFINE control point/TMVP.
a) In one example, each candidate in the motion shift list is a MV that point to the corresponding collocated frame.
b) In one example, each candidate in the motion shift list is a MV to locate the SbTMVP/AFFINE control point/TMVP in the corresponding collocated frame.
c) In one example, a motion shift candidate may be included in the motion shift list before it is rounded to certain precision.
   i. In one example, specifically, a motion shift candidate may be included in the motion shift list before it is rounded to integer precision.
d) In one example, whether to construct the motion shift list or not may be dependent on the availability of the template as illustrated in FIG. 4.
   i. In one example, if the corresponding template of the current CU does not exist or available, then the motion shift list may not need to be build.
e) In one example, the motion shift candidate in the list can be obtained from a certain block such as a CU that has already been coded.
   i. In one example, the motion information of a coded CU is firstly obtained, if the corresponding MV points to a certain collocated frame, then this MV is inserted into the motion shift list after performing redundancy checking.
   ii. In one example, specifically, a motion shift candidate can be an adjacent candidate, which is obtained from a neighbouring CU.
      1) In one example, only some fixed positions can be used to obtain adjacent candidates.
      2) Alternatively, arbitrary adjacent positions can be used to obtain adjacent candidates.
   iii. In one example, specifically, a motion shift candidate can be a non-adjacent candidate, which is obtained from a non-neighbouring CU.
      1) In one example, only some fixed positions can be used to obtain non-adjacent candidates.
      2) Alternatively, arbitrary non-adjacent positions can be used to obtain non-adjacent candidates.
   iv. In one example, specifically, a motion shift candidate can be obtained from a MV list that keeps the MV of CUs in the history.
      1) In one example, the motion shift candidate is obtained from history based MVP (HMVP) list.
   v. In one example, specifically, a motion shift candidate may be a virtual candidate.
      1) In one example, a motion candidate may be a zero candidate or constructed candidate.
   vi. Alternatively, a motion shift candidate may be arbitrary MV that points to the collocated frame.
f) In one example, the MVP candidate list constructed for some certain coding modes, e.g. regular/CIIP/MMVD/GPM/TPM, can be re-used to obtain motion shift candidates.

20. The motion shift lists may be constructed along with pruning process.
a) In one example, pruning process is used to avoid repeating or redundant motion shift with the list, which can be realized by using appropriate threshold TH.
b) In one example, if two motion shift candidates point to the same collocated frame, they may both be included to motion shift list only if the absolute difference between the corresponding X and Y
components are either or both larger (or no smaller) than TH.
   c) The pruning threshold can be signalled in the bitstream.
i. In one example, the pruning threshold can be signalled either in PU, CU, CTU or slice level.
   d) The pruning threshold may depend on the characteristics of the current block.
   i. In one example, the threshold may be derived by analysing the diversity among the candidates.
   ii. In one example, the optimal threshold can be derived through RDO.
   iii. In one example, the threshold may be the lamda value used in RDO process, or be some other value derived based on the lamda value.

21. K (K>=1) motion shift lists may be constructed to derive at least one SbTMVP/AFFINE control point/TMVP candidate.
a) In one example, the number of the candidates in each list may not exceed a certain constant.
b) In one example, the motion shift list is built by traversing the motion candidates in a predefined order.
   i. In one example, the motion candidates may be:
      1) adjacent neighboring MVPs;
      2) adjacent neighboring MVPs at specific location(s);
      3) TMVP MVPs;
      4) HMVP MVPs;
      5) Non-adjacent MVPs;
      6) Constructed MVPs (such as pairwise MVPs);
      7) Inherited affine MV candidates;
      8) Constructed affine MV candidates;
      9) SbTMVP candidates.
c) In one example, the construction of motion shift list terminates if the number of candidates in the list reaches to the maximum allowed number K.
d) In one example, M(M>=0) motion shift list is constructed to derive SbTMVP/AFFINE control point/TMVP candidates.
e) In one example, D (D>=0) motion shifts are selected from each list, where D may be a same value for arbitrary motion candidate list, or be different from one to another.
f) In one example, the number of motion shift list to be constructed may be dependent on the number of collocated frames.
   i. In one example, only one motion shift list is constructed for all the collocated frames.
      1) In one example, specifically, the motion information of a potential motion shift candidate is firstly obtained, if the corresponding MV in arbitrary reference picture list points to either of M (M>=1) collocated frames, then this MV is inserted into the motion shift list after performing redundancy checking.
   ii. In one example, the number of the list may be equal to the number of collocated frames, where one motion shift list is constructed for each of the collocated frames.
      1) In one example, for each of collocated frame, the corresponding motion shift list is constructed by including the motion candidates that have MV in either reference list that points to the current collocated frame. In particular, the motion information of a potential motion shift candidate is firstly obtained, if the corresponding MV points to the current collocated frame, then this MV is inserted into the motion shift list built for the current collocated frame after performing redundancy checking.

22. The constructed motion shift lists may be sorted based on at least one certain metric.
a) In one example, the metrics may be template matching cost or bilateral matching cost.
b) In one example, the reference template locates in the collocated frame, and the current template locates in the to-be-coded frame, then the template matching cost is calculated for partial or all of the motion shift candidates.
c) In one example, the motion shift lists may be sorted based on the template matching of the motion shift candidates within the lists.
d) In one example, Q (Q>1) reordering process may be conducted to motion shift list.
   i. The Q reordering process may be conducted in a cascade way or in a parallel way.
   ii. In one example, for certain types of candidates, a candidate group is firstly constructed, then first K (0<K<Q) pass reordering is performed to select partial candidates in the motion shift list. The the last pass reordering is performed to reorder all the candidates in the motion shift list.
e) In one example, alternatively, the motion shift list may not need to be sorted.
   i. In one example, the motion shift list is built by traversing the motion candidates in a predefined order.
   ii. In one example, the construction of motion shift list terminates if the number of candidates in the list reaches to the maximum allowed number K.

23. H (H>=1) SbTMVP/AFFINE control point/TMVP candidates may be included in the sub-CU/CU level MVP candidate list.
a) In one example, partial or all of the candidates in the motion shift lists are used to derive SbTMVP/AFFINE control point/TMVP candidates.
b) In one example, at most Q (Q>0) motion shifts are used to derive SbTMVP/AFFINE control point/TMVP candidates in one motion shift list.
c) In one example, no motion shift is used to derive SbTMVP/AFFINE control point/TMVP candidates in certain motion shift list.

24. Top-M (M>0) candidates with the least metric cost in each motion shift list may be used to derive SbTMVP/AFFINE control point/TMVP candidates.
a) In one example, M may be a same value for each list, or be different from one to another.
b) In one example, the temporal motion information (e.g. MV, reference index, etc) of the location specified by the motion shift is used by the current block.
   i. In one example, the MV of the location specified by the motion shift may firstly perform scaling process, then the scaled MV is used by the current block.
   ii. In one example, alternatively, the MV of the location specified by the motion shift may be directly used by the current block without performing scaling process.
   iii. In one example, the MV scale process may be conducted based on the POC distance between the to-be-coded frame and the collocated frame, and the distance between the collocated frame and the corresponding reference frame.
   iv. In one example, specifically, the temporal motion information may be used to derive TMVP, SbTMVP or any other motion information.
c) In one example, the constructed SbTMVP/AFFINE control point/TMVP candidates based on the motion shift may be further reordered.
   i. In one example, Top-K (K>0) candidates in the sorted SbTMVP/AFFINE control point/TMVP set mat be included in the sub-CU/CU level MVP candidate list.
d) In one example, the cost of the motion shift candidates which belong to different motion shift lists may be compared to determine which one(s) could be used to derive SbTMVP/AFFINE control point/TMVP candidates.
   i. In one example, the cost of it motion shift candidate in list A may be compared with that of the j-th candidate in list B, and the one with smaller cost will be used to derive SbTMVP/AFFINE control point/TMVP candidate.

25. Before the motion shift is used to derived SbTMVP/AFFINE control point/TMVP candidates, it may be firstly refined through template matching process or not.
a) In one example, during the template matching refinement, only integer positions are searched to get a refined motion shift.
b) In one example, the searching step (i.e., the nearest distance between two searching positions) may be K (K>0) pels.

26. A new motion shift may be constructed by the existing ones in the list.
a) In one example, a motion shift may be constructed by the averaging the arbitrary K(K>1) shifts in the list.
b) In one example, the constructed motion shift is reordered together with the ones in the motion shift list.
   i. In one example, the constructed motion shift may be used to derive SbTMVP candidate if it satisfies certain conditions as other normal shift candidates.

27. On reordering of SbTMVP candidates. Once the SbTMVPs are derived based on the motion shifts selected from one or multiple motion shift list(s), they will be included in the sub-CU level MVP candidate list and then may be reordered according to certain metrics.
a) In one example, the metrics may be template matching cost or bilateral matching cost.
b) In one example, the metrics (e.g. template matching cost) for partial or all of the SbTMVPs and AFFINE candidates in the list are calculated, then partial or all of the candidates are reordered in a descending (or ascending) order of the metrics.
   i. In one example, for all or partial of candidates, the metrics may be further adjusted before reordering.
      1) In one example, let Cₒᵣᵢ denote the original metric value of a certain candidate, then the adjusted metric value C_{adj} is calculated as:

$${C}_{adj} = a * {C}_{ori} + b ,$$

where a and b may be fixed constants or adaptively determined values.
2) In one example, for a certain candidate, whether the matric value is adjusted may depend on the candidate category.
   a) In one example, only partial (or all) of AFFINE (or sbTMVP) candidates need to perform metric value adjustment.
3) In one example, for a certain candidate, whether the metric value is adjusted may depend on whether it is uni-predicted or bi-predicted.
ii. In one example, all the SbTMVP candidates are reordered based on certain metrics, then the all the sorted SbTMVP candidates may be placed in front (or behind) of all or partial of the AFFINE candidates.
iii. In one example, partial SbTMVP candidates are reordered together with all the AFFINE candidates, where other SbTMVP candidates will always placed in a fix position in the list.
   1) In one example, specifically, which SbTMVP candidates are reordered or not may depends on the collocated frames.
      a) In one example, which SbTMVP candidate(s) are reordered or not may depends on the priority of the collocated frame it(they) locate(s).
      i. In one example, the collocated frames that are closer to the to-be-coded frame are assigned with higher priority.
      ii. In one example, all or partial of the SbTMVP candidates that locate in the collocated frame with top-W(W>0) highest priority will not be reordered.
      1. In one example, these SbTMVP candidates may always be placed in the most front positions in the list.
      2. In one example, alternatively, these SbTMVP candidates may be placed in arbitrary fixed positions in the list.
      3. Alternatively, these SbTMVP candidates may be placed in arbitrary positions in the list.
   2) In one example, specifically, which SbTMVP candidates are reordered or not may depends on the rank of the corresponding motion shift in the motion shift list.
      a) In one example, the SbTMVP candidates of which the motion shifts have higher (or lower) rank may not be reordered but placed in the most front positions in the list.
   3) In one example, specifically, which SbTMVP candidates are reordered or not may depends on both of the corresponding rank of the motion shift in the motion shift list, and the collocated frame they locate.
      a) In one example, if the SbTMVP locates in the top-M(M>0) highest-priority frame, and the associated motion shift ranks top-N(N>0) in the corresponding motion shift list, this SbTMVP may be placed in the first (or any other) position in the sorted sub-CU level MVP candidate list.

28. In one example, a motion shift fetched from a motion shift list may be refined before it is used to locate a position in at least one collocated frame for TMVP or sbTMVP.
a) In one example, the motion shift may be refined by templated matching.
b) In one example, the motion shift may be refined by biliteral matching.
c) In one example, the motion shift may be refined by adding a delta MV.
d) In one example, the motion shift may be refined by clipping.
e) In one example, the motion shift may be refined by shifting.

29. In one example, multiple motion shifts (denoted as SM0, SM1, . . . SMn) which may be from a motion shift list may be jointly used to derive a final motion shift (denoted as SMf) to locate a position in at least one collocated frame for TMVP or sbTMVP. E.g. SMf=F(SM0, SM1, . . . , SMn).
a) In one example, SMf=(SM0+SM1+ . . . +SMn)/n.
b) In one example, SMf=max(SM0, SM1, . . . , SMn).
c) In one example, SMf=min(SM0, SM1, . . . , SMn).
d) In one example, SMf=middle(SM0, SM1, . . . , SMn).
e) In one example, SMf=(W1*SM0+W*SM1+ . . . +W3*SMn)/(W1+W2+ . . . +Wn).

30. After SbTMVP candidate is derived, the subblock motion may be further refined by template matching.

### 3. Problems

The existing subblock based prediction technologies have the following problems:
1) They face a dilemma. The motion information of each sub-block may be more accurate if the size of sub-blocks is smaller. However, smaller sub-blocks impose a higher bandwidth requirement in MC.
2) Motion information derived for smaller sub-block might be dangerous especially when there are some noises in a block. Fixing the sub-block size within one block may be sub-optimal.

### 4. Detailed Solutions

In this disclosure, it is proposed to further improve subblock based motion compensation. In particular, interweaved prediction is improved to be compatible with pixel based affine motion compensation. Besides, regression affine is also improved.

The detailed embodiments below should be considered as examples to explain general concepts. These embodiments should not be interpreted in a narrow way. Furthermore, these embodiments can be combined in any manner.

The terms ‘video unit’ or ‘coding unit’ or ‘block’ may represent a coding tree block (CTB), a coding tree unit (CTU), a coding block (CB), a CU, a PU, a TU, a PB, a TB.

In this disclosure, regarding “a block coded with mode N”, here “mode N” may be a prediction mode (e.g., MODE_INTRA, MODE_INTER, MODE_PLT, MODE_IBC, and etc.), or a coding technique (e.g., DIMD, TIMD, PDPC, CCLM, CCCM, GLM, intraTMP, AMVP, SMVD, Merge, BDOF, PROF, DMVR, AMVR, TM, Affine, CIIP, GPM, spatial GPM, SGPM, GPM inter-inter, GPM intra-intra, GPM inter-intra, MHP, GEO, TPM, MMVD, BCW, HMVP, SbTMVP, LIC, OBMC, ALF, deblocking, SAO, bilateral filter, LMCS, and the corresponding variants, and etc.).

It is noted that the terminologies mentioned below are not limited to the specific ones defined in existing standards. Any variance of the coding tool is also applicable.

### On Interweaved Affine

1. The usage of interweaved prediction on affine mode may be dependent on another coding method.
a) In one example, if pixel based affine motion compensation is applied to a coding block, then interweaved prediction may not be applied.
b) In one example, interweaved affine prediction and pixel based affine can not be simultaneously used for a coding block.
   i. In one example, alternatively, interweaved affine prediction and pixel based affine may be simultaneously used for a coding block.
      1. In one example, for a coding block, partial pixels may be predicted by interweaved affine, while (some) other pixels may be predicted by pixel based affine.
      2. In one example, the predictions of interweaved affine and pixel based affine may be blended to generate a new prediction.

2. In one example, the usage of interweaved prediction on affine mode may be dependent on sequence/frame resolution.

3. Interweaved affine prediction and BDOF may be simultaneously used for a coding block.
i. In one example, if an affine-coded block is bi-predicted and/or some certain conditions are satisfied, BDOF may be used to get the prediction.
   1. In one example, specifically, BDOF and interweaved affine prediction may be used in a cascade way.
      a) In one example, BDOF may be used before or after interweaved affine prediction.
         i. In one example, after a 1^{st} version affine motion (or prediction) is generated, BDOF may be applied to get a 2^{nd} version affine motion (or prediction), then interweaved affine may be used to get a 3^{rd} version affine motion (or prediction) based on the 2^{nd} version.
         1. In one example, the 3^{rd} version prediction is used as the final affine prediction.
         2. In one example, specifically, multiple versions of prediction may be blended with a weighted average to get a 4^{th} version prediction, which is used as the final affine prediction.
   2. In one example, specifically, BDOF and interweaved affine prediction may be used in a parallel way.
      a) In one example, specifically, after a 1st version affine motion (or prediction) is generated, a 2^{nd} and a 3^{rd} affine motions (or predictions) are generated respectively by BDOF and interweaved affine prediction in parallel.
         1. In one example, specifically, multiple versions of prediction may be blended with a weighted average to get a 4^{th} version prediction, which is used as the final affine prediction.
   3. In one example, alternatively, interweaved affine prediction is not used when BDOF is used for an affine-coded block.

4. The usage of interweaved affine prediction for a coding block may be dependent on whether it is bi-predicted or uni-predicted.
a) In one example, interweaved affine prediction may be used only for bi-predicted blocks.
b) In one example, alternatively interweaved affine prediction may be used only for uni-predicted blocks.
c) In one example, interweaved affine prediction may be used for both uni- and bi-predicted blocks.

5. The usage of interweaved affine prediction and/or TM-Affine may be dependent on the slice/frame type.
a) In one example, interweaved affine prediction and/or TM-Affine may not be applied to GPB (Generalized P/B frame) slice/frame.
   i. In one example, if all the reference pictures/frames/slices of the to-be-coded pictures/frames/slices are collected from forward direction in terms of POC, then the current slice/frame is a GPB slice/frame.
   ii. In one example, specifically, if all the reference pictures/frames/slices of the to-be-coded pictures/frames/slices are collected from forward direction in terms of POC, then interweaved affine prediction and/or TM-Affine may not be applied.
b) In one example, interweaved affine prediction and/or TM-Affine may be applied to partial GPB (Generalized P/B frames) slices/frames.
   i. In one example, for a GPB slice/frame, if the POC distance between it and its nearest reference frame is larger than 1 (i.e., the GPB frame in Random-Access configuration case), then interweaved affine prediction and/or TM-Affine may be applied to this GPB slice/frame.
      1. In one example, otherwise, interweaved affine prediction and/or TM-Affine may not be applied to this GPB slice/frame.
   ii. In one example, for a GPB slice/frame, if the POC distance between it and its nearest reference frame is larger (or smaller) than a certain value, then interweaved affine prediction and/or TM-Affine may be applied to this GPB slice/frame.

6. The usage of interweaved affine prediction and/or pixel based affine motion compensation may be dependent on block dimension.
a) In one example, if the block dimension satisfies certain conditions, interweaved affine prediction is used.
   i. In one example, specifically, if both (or either) height and width are larger or smaller than a threshold, or the ratio of height and width is larger or smaller than a threshold, interweaved affine prediction may be used.
   ii. In one example, specifically, if block area is larger or smaller than a threshold, interweaved affine prediction may be used.
b) In one example, alternatively, if the block dimension doesn't satisfy the same condition, pixel based affine is used instead.
c) In one example, the dimension condition may be imposed together with other conditions.
   i. In one example, OBMC flag may be used together with dimension condition.
      1. In one example, specifically, if OBMC is used for a block, and block dimension satisfies certain condition, then pixel affine is used to generation prediction.
   d) In one example, whether interweaved affine is applied or not may be dependent on the subblock size.
      i. In one example, if subblock size is smaller than a threshold, e.g., 4×4, then interweaved affine is not applied.

7. In one example, when interweaved affine is used, or pixel based affine is not used, the size of the largest subblock to perform affine prediction is set to a constant.

8. In one example, PROF (affine prediction refinement with optical flow) may be performed for interweaved affine.
a) In one example, both predictions generated by the two dividing patterns are refined by PROF.
   i. In one example, only the prediction generated by a particular dividing pattern is refined by PROF.
   ii. In one example, PROF is not applied if interweaved affine is used for a block.
b) In one example, for certain dividing pattern, only partial prediction samples are refined by PROF.
   i. In one example, if either width or height of a subblock is smaller than a threshold, e.g., 4, then PROF is not applied to this subblock.

9. It is proposed that whether to and/or how to apply subblock-boundary deblocking process or other kinds of subblock-boundary based filtering process (such as SAO, Adaptive loop filter, OBMC) may depend on whether affine mode/pixel based affine/interweaved prediction is applied or not.
a) In one example, if affine mode/pixel based affine/interweaved prediction is applied, some or all kinds of subblock-boundary based deblocking/filtering process is not applied.
   i. In one example, specifically, if affine mode/pixel based affine/interweaved prediction is applied, subblock-boundary oriented deblocking and/or OBMC is not applied.
      1. In one example, specifically, whether/how certain kind of subblock-boundary based deblocking/filtering process is applied or not may also be dependent on the slice type.
         a) In one example, specifically, whether/how certain kind of subblock-boundary based deblocking/filtering process is applied or not may also be dependent on whether a certain frame is a GPB or not.
         b) In one example, specifically, whether/how certain kind of subblock-boundary based deblocking/filtering process is applied or not may also be dependent on the POC distance between a certain frame and its nearest reference frame.

### On OBMC

10. It is proposed that whether to and/or how to apply CU level OBMC may be dependent on the coding mode.
a) In one example, if subblock level inter modes (such as affine, SbTMVP, multi-pass DMVR) is used for the current block, then each boundary subblock will conduct CU level OBMC filtering independently.
   i. In one example, specifically, the boundary subblocks are looped one by one. Suppose A is an arbitrary boundary subblock being traversed, and A1 is the corresponding neighboring subblock which is used for OBMC filtering. Then A will be filtered if A and A1 have different motion. After A finishes filtering, subsequent subblocks will conduct OBMC in a similar way.
b) In one example, alternatively, if non-subblock level inter mode is used for the current block, then multiple boundary subblocks may conduct OBMC filtering together.
   i. FIG. 25 illustrates examples of CU level OBMC. In one example, suppose A is an arbitrary boundary subblock being traversed, and A1 is the corresponding neighboring subblock. If A1 and subsequent N (N>=0) successive sublocks, e.g., 2 subblocks B1 and C1 in FIG. 25, have identical motion M_nei, and M_nei is different from A's motion in the meanwhile, then (N+1) subblocks (including A) will be filtered together. Otherwise, if M_nei is equal to A's motion, then (N+1) successive subblocks (including A) will skip CU level OBMC filtering.

### On Regression Affine

11. Whether a previously affine-coded block can be used to generate regression affine candidate may be dependent on the block size.
a) In one example, a previously affine-coded block may not be used to generate regression affine candidate if the block width/height/the ratio of width and height/area is smaller or larger than a pre-defined or an adaptively derived threshold.
b) In one example, a previously affine-coded block may not be used to generate regression affine candidate if the ratio of its block area and current block' area is smaller or larger than a pre-defined or an adaptively derived threshold.

12. To generate a regression affine candidate, it is proposed to use the motion fields of N (N>1) previously coded CUs as the input of regression process.
a) In one example, for arbitrary CU that is used to generate a regression affine candidate, at least one subblock is used to provide the motion field.
b) In one example, for arbitrary CU that is used to generate a regression affine candidate, all the subblocks of this CU are used to provide the motion field.
c) In one example, N CUs may be collected from adjacent, non-adjacent position, or a history CU/parameter table.
d) In one example, at least one previously coded CU may be collected from:
   i. Adjacent neighboring position(s);
   ii. Adjacent neighboring position(s) at specific location(s).
   iii. Collocated or adjacent temporal position(s).
   iv. A history table.
   v. Non-adjacent spatial/temporal position(s).
e) In one example, N CUs are all inter coded.
   i. In one example, N CUs are all coded with affine mode.
   ii. In one example, alternatively, at least K (K>=0) of N are affine coded.
   iii. In one example, the motion fields of at least one affine coded CU and at least one non-affine coded CU may be used to generate a regression affine candidate.
f) In one example, all the N CUs may need to share the same prediction direction (i.e., bi- or uni-predicted, and/or reference list used), and/or the same reference index/frame.
   i. In one example, alternatively, they may have different prediction direction or reference frame.
g) In one example, a regression affine candidate may be generated only when the subblock number of N CUs is larger than a constant threshold.
h) In one example, the motion fields of neighboring or non-adjacent positions may also used as additional input.
   i. In one example, M-row/column neighboring subblocks and/or F-row/column non-adjacent subblocks may be used as input, where M, F>=0.
      1. In one example, the locations of the non-adjacent positions being used may be dependent on the block dimension.
   i) In one example, the proposed regression candidates may be used when the number of existing regression candidates does not reach the maximum allowed number.
   j) In one example, the proposed regression candidates may be be reordered based on certain metric, e.g., ARMC or template matching.
   k) In one example, the number of the proposed regression candidates may not exceed a constant or an adaptively determined value.
   l) In one example, the proposed regression affine candidates may be used to generate Affine merge/Affine AMVP/Affine MMVD/adaptive DMVR for Affine/Affine TM/Affine DMVR and/or any other affine-related method that require affine candidate list construction.

13. The motion fields of at least K (K>1, e.g., K=2) coding block may be used to generate a regression affine candidate for affine AMVP mode.
a) In one example, a coding block may be used to generate regression affine candidate only if the reference index or the reference frame been used of this coding block is identical to the reference index of the current block.

14. An affine candidate list may contain the regression affine candidates that are generated by different number of previous coded coding blocks.
a) In one example, at least one regression affine candidate in the list is generated with M (M>0) previously coded blocks, and/or at least one regression affine candidate in the list is generated with N (N>0) previously coded blocks, where M and N are not identical.
b) In one example, a regression affine candidate which is generate with more previously coded blocks has higher priority to be included in an affine candidate list than a candidate that is generate with fewer previously coded blocks.

### On SbTMVP

15. The usage of SbTMVP may be dependent on the temporal layer or temporal layer index (Tid) of the frame/slice/tile that a coding block associated with.
a) In one example, SbTMVP is enabled for a block when the temporal layer or Tid is smaller or larger than a constant (or on-the-fly determined) value.
   i. In one example, specifically, no SbTMVP candidate is allowed to be inserted into the subblock based candidate list if the temporal layer or Tid is smaller or larger than a constant (or on-the-fly determined) value.
b) In one example, the maximum allowed number of SbTMVP candidate that can be included in the subblock based candidate list may be dependent on the temporal layer or Tid.
   i. In one example, specifically, at most K SbTMVP candidates may be included in the subblock based candidate list when Tid is smaller or larger than a threshold, otherwise at most M SbTMVP candidates may be included in the subblock based candidate list. Here K and M may be different values.
      1. In one example, specifically, the threshold may be a constant (or on-the-fly determined) value.
      2. In one example, specifically, multiple thresholds may be used to determine whether SbTMVP can be and/or how many SbTMVP candidates can be inserted into the subblock based candidate list.

16. Once one or multiple SbTMVPs are derived, they may be included in the subblock based candidate list and then be reordered according to certain metrics.
a) In one example, the metrics may be template matching cost or bilateral matching cost.
b) In one example, the metrics (e.g. template matching cost) for partial or all of the SbTMVPs and Affine candidates in the list are calculated, then partial or all of the candidates are reordered in a descending (or ascending) order of the metrics.
   i. In one example, all the SbTMVP candidates may be reordered based on certain metrics, then all the sorted SbTMVP candidates may be placed in front (or behind) of all or partial of the Affine candidates.
   ii. In one example, partial or all of the SbTMVP candidates may always occupy some fixed positions in the reordered list, while the order of other SbTMVP candidates may be determined based on certain metrics, i.e., template matching or bilateral matching cost.
      1. In one example, specifically, for partial or all the SbTMVP candidates, certain metrics or costs are calculated, which may then be sorted together with the same cost of all or partial of the Affine candidates, and the order of these SbTMVP and/or Affine candidates in the subblock based candidate list may be determined based on the sorting results of the cost.
         a) In one example, the order of the candidates in the list may be in accordance with the sorting order of the cost.
      2. In one example, specifically, whether certain SbTMVP candidates are reordered or not may be determined by temporal layer or Tid of the coding block/picture.
         a) In one example, if temporal layer or Tid is smaller (or larger) than a threshold, then all the SbTMVP candidates are reordered together with Affine candidates based on certain metric.
         i. In one example, the candidate order in the reordered list may be in accordance with the sorting order of the metric.
         b) In one example, alternatively, if temporal layer or Tid is larger (or smaller) than a threshold, then certain SbTMVP candidate(s) may directly occupy one or multiple fixed positions in the reordered list.
         i. In one example, specifically, if temporal layer or Tid is larger (or smaller) than a threshold, then certain SbTMVP candidate(s) may directly occupy the first or top position(s) in the reordered list without reordering.
         ii. In one example, specifically, for the rest SbTMVP candidates, certain metrics or costs are calculated, which may then be sorted together with the same cost of all or partial of the Affine candidates, and the order of these SbTMVP and/or Affine candidates in the subblock based candidate list may be determined based on the sorting results of the cost.
      3. In one example, specifically, whether certain SbTMVP candidates are reordered or not may depends on the collocated frames.
         a) In one example, which SbTMVP candidate(s) are reordered or not may depends on the priority of the collocated frame it(they) locate(s).
         i. In one example, the collocated frames that are closer to the to-be-coded frame are assigned with higher priority.
         ii. In one example, the collocated frames that has larger (or lower) Qp may be assigned with higher priority.
         iii. In one example, all or partial of the SbTMVP candidates that locate in the collocated frame with top-W (W>0) highest priority will not be reordered.
         1. In one example, these SbTMVP candidates may always be placed in the most front positions in the list.
         2. In one example, alternatively, these SbTMVP candidates may be placed in arbitrary fixed positions in the list.
         3. Alternatively, these SbTMVP candidates may be placed in arbitrary positions in the list.
      4. In one example, specifically, whether certain SbTMVP candidates are reordered or not may depends on the rank of the corresponding motion shift in the motion shift list.
         a) In one example, the SbTMVP candidates of which the motion shifts have higher (or lower) rank may not be reordered but placed in the most front positions in the list.
      5. In one example, specifically, whether certain SbTMVP candidates are reordered or not may depend on the combination of the following conditions: (1) the corresponding rank of the motion shift in the motion shift list; (2) the collocated frame of a SbTMVP locate; (3) the temporal layer or Tid of the coding block/picture.
         a) In one example, if a SbTMVP locates in the top-M(M>0) highest-priority frame, and/or the associated motion shift ranks top-N(N>0) in the corresponding motion shift list, and/or the temporal layer or Tid of the coding block/frame is larger (or smaller) than a threshold, then this SbTMVP may be placed in the first (or any other) position without reordering in the sorted sub-CU level MVP candidate list.

### General Aspects

17. In above examples, the video unit may refer to the video unit may refer to color component/sub-picture/slice/tile/coding tree unit (CTU)/CTU row/groups of CTU/coding unit (CU)/prediction unit (PU)/transform unit (TU)/coding tree block (CTB)/coding block (CB)/prediction block(PB)/transform block (TB)/a block/sub-block of a block/sub-region within a block/any other region that contains more than one sample or pixel.

18. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.

19. Whether and/or how to apply the above methods may depend on the following information:
a) A message signalled in the DPS/SPS/VPS/PPS/APS/picture header/slice header/tile group header/Largest coding unit (LCU)/Coding unit (CU)/LCU row/group of LCUs/TU/PU block/Video coding unit.
b) Position of CU/PU/TU/block/Video coding unit.
c) Block dimension of current block and/or its neighbouring blocks.
d) Block shape of current block and/or its neighbouring blocks.
e) coded mode of a block, e.g., IBC or non-IBC inter mode or non-IBC subblock mode.
f) Indication of the color format (such as 4:2:0, 4:4:4).
g) Coding tree structure.
h) Slice/tile group type and/or picture type.
i) Color component (e.g., may be only applied on chroma components or luma component).
j) Temporal layer ID.
k) Profiles/Levels/Tiers of a standard.

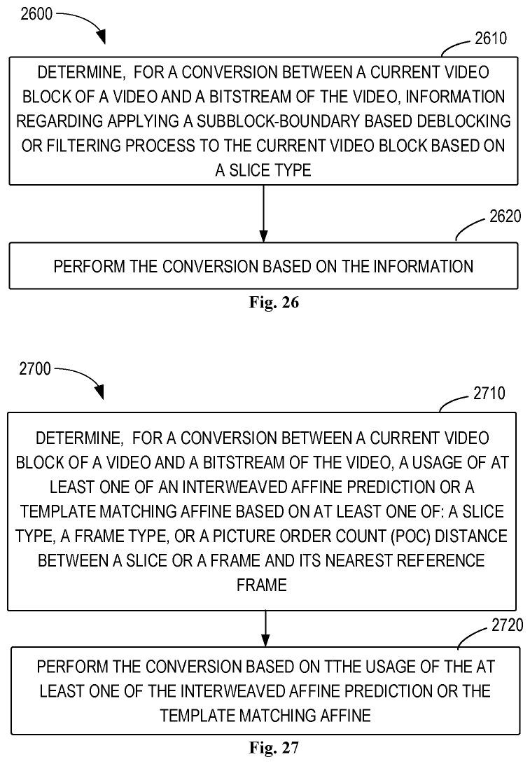

Further embodiments will be described below. FIG. 26 illustrates a flowchart of a method 2600 for video processing in accordance with embodiments of the present disclosure. The method 2600 is implemented during a conversion between a video unit or a video block of a video and a bitstream of the video.

At block 2610, for a conversion between a current video block of a video and a bitstream of the video, information regarding applying a subblock-boundary based deblocking or filtering process to the current video block is determined based on a slice type. As used herein, the term “current video block” refers to a video block or a video unit to be processed, which may also be referred to as a “target video block” or a “current video unit”.

At block 2620, the conversion is performed based on the information. The information indicates at least one of: whether a kind of subblock-boundary based deblocking or filtering process is applied, or how the kind of subblock-boundary based deblocking or filtering process is applied. In some embodiments, the conversion includes encoding the current video block into the bitstream. Alternatively, or in addition, in some embodiments, the conversion includes decoding the current video block from the bitstream.

The method 2600 enables determining whether to and/or how to apply a subblock-boundary based deblocking or filtering process based on a slice type. Thus, the coding effectiveness and/or coding efficiency can be improved.

In some embodiments, the information is based on whether a frame is a generalized P or B (GPB) frame.

In some embodiments, the information is further based on a picture order count (POC) distance between a frame and its nearest reference frame.

According to further embodiments of the present disclosure, a non-transitory computer-readable recording medium is provided. The non-transitory computer-readable recording medium stores a bitstream of a video which is generated by a method performed by an apparatus for video processing. In the method, information regarding applying a subblock-boundary based deblocking or filtering process to a current video block of the video is determined based on a slice type. The bitstream is generated based on the information. The information indicates at least one of: whether a kind of subblock-boundary based deblocking or filtering process is applied, or how the kind of subblock-boundary based deblocking or filtering process is applied.

According to still further embodiments of the present disclosure, a method for storing bitstream of a video is provided. In the method, information regarding applying a subblock-boundary based deblocking or filtering process to a current video block of the video is determined based on a slice type. The bitstream is generated based on the information. The bitstream is stored in a non-transitory computer-readable recording medium. The information indicates at least one of: whether a kind of subblock-boundary based deblocking or filtering process is applied, or how the kind of subblock-boundary based deblocking or filtering process is applied.

FIG. 27 illustrates a flowchart of a method 2700 for video processing in accordance with embodiments of the present disclosure. The method 2700 is implemented during a conversion between a video unit or a video block of a video and a bitstream of the video.

At block 2710, for a conversion between a current video block of a video and a bitstream of the video, a usage of at least one of an interweaved affine prediction or a template matching affine is determined based on at least one of: a slice type, a frame type, or a picture order count (POC) distance between a slice or a frame and its nearest reference frame.

At block 2720, the conversion is performed based on the usage of the at least one of the interweaved affine prediction or the template matching affine. In some embodiments, the conversion includes encoding the current video block into the bitstream. Alternatively, or in addition, in some embodiments, the conversion includes decoding the current video block from the bitstream.

The method 2700 enables determining the usage of interweaved affine prediction or template matching affine based on slice type, frame type and/or POC. In this way, the coding effectiveness and/or coding efficiency can be improved.

In some embodiments, reference pictures or reference frames or reference slices of to-be-coded pictures or frames or slices are collected from a forward direction in term of POC, the slice type of a current slice or the frame type of a current frame is a generalized P or B (GPB) slice or frame.

In some embodiments, for a generalized P or B (GPB) slice or frame, a POC distance between the GPB slice or frame and its nearest reference frame is larger than one or the GPB slice or frame is a GPB frame in random-access configuration case, and the at least one of the interweaved affine prediction or the template matching affine is not applied to the GPB slice or frame.

In some embodiments, for a generalized P or B (GPB) slice or frame, a POC distance between the GPB slice or frame and its nearest reference frame is larger than or smaller than a predefined value, and the at least one of the interweaved affine prediction or the template matching affine is applied to the GPB slice or frame.

According to further embodiments of the present disclosure, a non-transitory computer-readable recording medium is provided. The non-transitory computer-readable recording medium stores a bitstream of a video which is generated by a method performed by an apparatus for video processing. In the method, a usage of at least one of an interweaved affine prediction or a template matching affine is determined based on at least one of: a slice type, a frame type, or a POC distance between a slice or a frame and its nearest reference frame. The bitstream is generated based on the usage of the at least one of the interweaved affine prediction or the template matching affine.

According to still further embodiments of the present disclosure, a method for storing bitstream of a video is provided. In the method, a usage of at least one of an interweaved affine prediction or a template matching affine is determined based on at least one of: a slice type, a frame type, or a POC distance between a slice or a frame and its nearest reference frame. The bitstream is generated based on the usage of the at least one of the interweaved affine prediction or the template matching affine. The bitstream is stored in a non-transitory computer-readable recording medium.

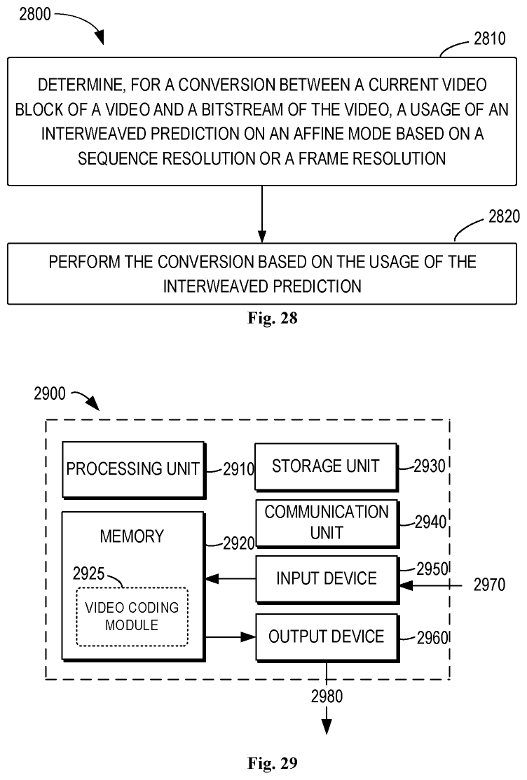

FIG. 28 illustrates a flowchart of a method 2800 for video processing in accordance with embodiments of the present disclosure. The method 2800 is implemented during a conversion between a video unit or video block of a video and a bitstream of the video.

At block 2810, for a conversion between a current video block of a video and a bitstream of the video, a usage of an interweaved prediction on an affine mode is determined based on a sequence resolution or a frame resolution.

At block 2820, the conversion is performed based on the usage of the interweaved prediction. In some embodiments, the conversion includes encoding the current video block into the bitstream.

Alternatively, or in addition, in some embodiments, the conversion includes decoding the current video block from the bitstream.

The method 2800 enables determining the usage of interweaved prediction on affine mode based on sequence/frame resolution. Thus, the coding efficiency and/or coding effectiveness can be improved.

According to further embodiments of the present disclosure, a non-transitory computer-readable recording medium is provided. The non-transitory computer-readable recording medium stores a bitstream of a video which is generated by a method performed by an apparatus for video processing. In the method, a usage of an interweaved prediction on an affine mode is determined based on a sequence resolution or a frame resolution. The bitstream is generated based on the usage of the interweaved prediction.

According to still further embodiments of the present disclosure, a method for storing bitstream of a video is provided. In the method, a usage of an interweaved prediction on an affine mode is determined based on a sequence resolution or a frame resolution. The bitstream is generated based on the usage of the interweaved prediction. The bitstream is stored in a non-transitory computer-readable recording medium.

As used herein, a video block or video unit may refer to one of: a color component, a sub-picture, a slice, a tile, a coding tree unit (CTU), a CTU row, groups of CTUs, a coding unit (CU), a prediction unit (PU), a transform unit (TU), a coding tree block (CTB), a coding block (CB), a prediction block (PB), a transform block (TB), a block, a subblock of a block, a sub-region within a block, or a region containing more than one sample or pixel.

In some embodiments, whether to and/or how to apply an approach regarding at least one of: an interweave affine mode, a coding unit (CU) level overlapped block motion compensation (OBMC), a regression affine mode, or a subblock-based temporal motion vector prediction (SbTMVP) is based on a syntax element in the bitstream. For example, whether to and/or how to apply the method 2600, the method 2700 and/or the method 2800 may be based on the syntax element in the bitstream.

In some embodiments, the syntax element is at at least one of: a sequence level, a group of pictures level, a picture level, a slice level, or a tile group level, or wherein the syntax element is included in at least one of: a sequence header, a picture header, a sequence parameter set (SPS), a video parameter set (VPS), a decoded parameter set (DPS), decoding capability information (DCI), a picture parameter set (PPS), an adaptation parameter set (APS), a slice header, or a tile group header.

In some embodiments, whether to and/or how to apply an approach regarding at least one of: an interweave affine mode, a coding unit (CU) level overlapped block motion compensation (OBMC), a regression affine mode, or a subblock-based temporal motion vector prediction (SbTMVP) is based on at least one of: a message in the bitstream, a position of a video unit, a block dimension of the current video block, a block dimension of a neighboring block of the current video block, a block shape of the current video block, a block shape of a neighboring block of the current video block, a coded mode of a block, an indication of a color format, a coding tree structure, a slice or tile group type, a picture type, a color component, a temporal layer identifier (ID), or profiles or levels or tiers of a standard. For example, whether to and/or how to apply the method 2600, the method 2700 and/or the method 2800 may be based on at least one of: a message in the bitstream, a position of a video unit, a block dimension of the current video block, a block dimension of a neighboring block of the current video block, a block shape of the current video block, a block shape of a neighboring block of the current video block, a coded mode of a block, an indication of a color format, a coding tree structure, a slice or tile group type, a picture type, a color component, a temporal layer ID, or profiles or levels or tiers of a standard.

In some embodiments, the message is included in at least one of: a decoded parameter set (DPS), a sequence parameter set (SPS), a video parameter set (VPS), a picture parameter set (PPS), an adaptation parameter set (APS), a picture header, a slice header, a tile group header, a largest coding unit (LCU), a coding unit (CU), a LCU row, a group of LCUs, a transform unit (TU), a prediction unit (PU) block, or a video coding unit.

In some embodiments, the video unit comprises one of: a coding unit (CU), a prediction unit (PU), a transform unit (TU), a block or a video coding unit.

In some embodiments, the coded mode comprises at least one of: an intra block copy (IBC) mode, a non-IBC inter mode, or a non-IBC subblock mode.

In some embodiments, the color format comprises one of: a 4:2:0 format or a 4:4:4 format.

In some embodiments, the approach such as the method 2600, the method 2700 and/or the method 2800 is applied to at least one of a chroma component or a luma component.

It is to be understood that the method 2600 and/or the method 2700 and/or the method 2800 can be applied separately, or in any combination. With these methods, the coding efficiency and coding effectiveness can be improved.

Implementations of the present disclosure can be described in view of the following clauses, the features of which can be combined in any reasonable manner.

Clause 1. A method for video processing, comprising: determining, for a conversion between a current video block of a video and a bitstream of the video, information regarding applying a subblock-boundary based deblocking or filtering process to the current video block based on a slice type; and performing the conversion based on the information, wherein the information indicates at least one of: whether a kind of subblock-boundary based deblocking or filtering process is applied, or how the kind of subblock-boundary based deblocking or filtering process is applied.

Clause 2. The method of clause 1, wherein the information is based on whether a frame is a generalized P or B (GPB) frame.

Clause 3. The method of clause 1 or 2, wherein the information is further based on a picture order count (POC) distance between a frame and its nearest reference frame.

Clause 4. A method for video processing, comprising: determining, for a conversion between a current video block of a video and a bitstream of the video, a usage of at least one of an interweaved affine prediction or a template matching affine based on at least one of: a slice type, a frame type, or a picture order count (POC) distance between a slice or a frame and its nearest reference frame; and performing the conversion based on the usage of the at least one of the interweaved affine prediction or the template matching affine.

Clause 5. The method of clause 4, wherein reference pictures or reference frames or reference slices of to-be-coded pictures or frames or slices are collected from a forward direction in term of POC, the slice type of a current slice or the frame type of a current frame is a generalized P or B (GPB) slice or frame.

Clause 6. The method of clause 4 or 5, wherein for a generalized P or B (GPB) slice or frame, a POC distance between the GPB slice or frame and its nearest reference frame is larger than one or the GPB slice or frame is a GPB frame in random-access configuration case, and the at least one of the interweaved affine prediction or the template matching affine is not applied to the GPB slice or frame.

Clause 7. The method of clause 4 or 5, wherein for a generalized P or B (GPB) slice or frame, a POC distance between the GPB slice or frame and its nearest reference frame is larger than or smaller than a predefined value, and the at least one of the interweaved affine prediction or the template matching affine is applied to the GPB slice or frame.

Clause 8. A method for video processing, comprising: determining, for a conversion between a current video block of a video and a bitstream of the video, a usage of an interweaved prediction on an affine mode based on a sequence resolution or a frame resolution; and performing the conversion based on the usage of the interweaved prediction.

Clause 9. The method of any of clauses 1-8, wherein a video block or video unit comprises one of: a color component, a sub-picture, a slice, a tile, a coding tree unit (CTU), a CTU row, groups of CTUs, a coding unit (CU), a prediction unit (PU), a transform unit (TU), a coding tree block (CTB), a coding block (CB), a prediction block (PB), a transform block (TB), a block, a subblock of a block, a sub-region within a block, or a region containing more than one sample or pixel.

Clause 10. The method of any of clauses 1-9, wherein whether to and/or how to apply an approach regarding at least one of: an interweave affine mode, a coding unit (CU) level overlapped block motion compensation (OBMC), a regression affine mode, or a subblock-based temporal motion vector prediction (SbTMVP) is based on a syntax element in the bitstream.

Clause 11. The method of clause 10, wherein the syntax element is at at least one of: a sequence level, a group of pictures level, a picture level, a slice level, or a tile group level, or wherein the syntax element is included in at least one of: a sequence header, a picture header, a sequence parameter set (SPS), a video parameter set (VPS), a decoded parameter set (DPS), decoding capability information (DCI), a picture parameter set (PPS), an adaptation parameter set (APS), a slice header, or a tile group header.

Clause 12. The method of any of clauses 1-9, wherein whether to and/or how to apply an approach regarding at least one of: an interweave affine mode, a coding unit (CU) level overlapped block motion compensation (OBMC), a regression affine mode, or a subblock-based temporal motion vector prediction (SbTMVP) is based on at least one of: a message in the bitstream, a position of a video unit, a block dimension of the current video block, a block dimension of a neighboring block of the current video block, a block shape of the current video block, a block shape of a neighboring block of the current video block, a coded mode of a block, an indication of a color format, a coding tree structure, a slice or tile group type, a picture type, a color component, a temporal layer identifier (ID), or profiles or levels or tiers of a standard.

Clause 13. The method of clause 12, wherein the message is included in at least one of: a decoded parameter set (DPS), a sequence parameter set (SPS), a video parameter set (VPS), a picture parameter set (PPS), an adaptation parameter set (APS), a picture header, a slice header, a tile group header, a largest coding unit (LCU), a coding unit (CU), a LCU row, a group of LCUs, a transform unit (TU), a prediction unit (PU) block, or a video coding unit.

Clause 14. The method of clause 12, wherein the video unit comprises one of: a coding unit (CU), a prediction unit (PU), a transform unit (TU), a block or a video coding unit.

Clause 15. The method of clause 12, wherein the coded mode comprises at least one of: an intra block copy (IBC) mode, a non-IBC inter mode, or a non-IBC subblock mode.

Clause 16. The method of clause 12, wherein the color format comprises one of: a 4:2:0 format or a 4:4:4 format.

Clause 17. The method of clause 12, wherein the approach is applied to at least one of a chroma component or a luma component.

Clause 18. The method of any of clauses 1-17, wherein the conversion comprises encoding the current video block into the bitstream.

Clause 19. The method of any of clauses 1-17, wherein the conversion comprises decoding the current video block from the bitstream.

Clause 20. An apparatus for video processing comprising a processor and a non-transitory memory with instructions thereon, wherein the instructions upon execution by the processor, cause the processor to perform a method in accordance with any of clauses 1-19.

Clause 21. A non-transitory computer-readable storage medium storing instructions that cause a processor to perform a method in accordance with any of clauses 1-19.

Clause 22. A non-transitory computer-readable recording medium storing a bitstream of a video which is generated by a method performed by an apparatus for video processing, wherein the method comprises: determining information regarding applying a subblock-boundary based deblocking or filtering process to a current video block of the video based on a slice type; and generating the bitstream based on the information, wherein the information indicates at least one of: whether a kind of subblock-boundary based deblocking or filtering process is applied, or how the kind of subblock-boundary based deblocking or filtering process is applied.

Clause 23. A method for storing a bitstream of a video, comprising: determining information regarding applying a subblock-boundary based deblocking or filtering process to a current video block of the video based on a slice type; generating the bitstream based on the information; and storing the bitstream in a non-transitory computer-readable recording medium, wherein the information indicates at least one of: whether a kind of subblock-boundary based deblocking or filtering process is applied, or how the kind of subblock-boundary based deblocking or filtering process is applied.

Clause 24. A non-transitory computer-readable recording medium storing a bitstream of a video which is generated by a method performed by an apparatus for video processing, wherein the method comprises: determining a usage of at least one of an interweaved affine prediction or a template matching affine based on at least one of: a slice type, a frame type, or a picture order count (POC) distance between a slice or a frame and its nearest reference frame; and generating the bitstream based on the usage of the at least one of the interweaved affine prediction or the template matching affine.

Clause 25. A method for storing a bitstream of a video, comprising: determining a usage of at least one of an interweaved affine prediction or a template matching affine based on at least one of: a slice type, a frame type, or a picture order count (POC) distance between a slice or a frame and its nearest reference frame; generating the bitstream based on the usage of the at least one of the interweaved affine prediction or the template matching affine; and storing the bitstream in a non-transitory computer-readable recording medium.

Clause 26. A non-transitory computer-readable recording medium storing a bitstream of a video which is generated by a method performed by an apparatus for video processing, wherein the method comprises: determining a usage of an interweaved prediction on an affine mode based on a sequence resolution or a frame resolution; and generating the bitstream based on the usage of the interweaved prediction.

Clause 27. A method for storing a bitstream of a video, comprising: determining a usage of an interweaved prediction on an affine mode based on a sequence resolution or a frame resolution; generating the bitstream based on the usage of the interweaved prediction; and storing the bitstream in a non-transitory computer-readable recording medium.

### Example Device

FIG. 29 illustrates a block diagram of a computing device 2900 in which various embodiments of the present disclosure can be implemented. The computing device 2900 may be implemented as or included in the source device 110 (or the video encoder 114 or 200) or the destination device 120 (or the video decoder 124 or 300).

It would be appreciated that the computing device 2900 shown in FIG. 29 is merely for purpose of illustration, without suggesting any limitation to the functions and scopes of the embodiments of the present disclosure in any manner.

As shown in FIG. 29, the computing device 2900 includes a general-purpose computing device 2900. The computing device 2900 may at least comprise one or more processors or processing units 2910, a memory 2920, a storage unit 2930, one or more communication units 2940, one or more input devices 2950, and one or more output devices 2960.

In some embodiments, the computing device 2900 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2900 can support any type of interface to a user (such as “wearable” circuitry and the like).

The processing unit 2910 may be a physical or virtual processor and can implement various processes based on programs stored in the memory 2920. In a multi-processor system, multiple processing units execute computer executable instructions in parallel so as to improve the parallel processing capability of the computing device 2900. The processing unit 2910 may also be referred to as a central processing unit (CPU), a microprocessor, a controller or a microcontroller.

The computing device 2900 typically includes various computer storage medium. Such medium can be any medium accessible by the computing device 2900, including, but not limited to, volatile and non-volatile medium, or detachable and non-detachable medium. The memory 2920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2930 may be any detachable or non-detachable medium and may include a machine-readable medium such as a memory, flash memory drive, magnetic disk or another other media, which can be used for storing information and/or data and can be accessed in the computing device 2900.

The computing device 2900 may further include additional detachable/non-detachable, volatile/non-volatile memory medium. Although not shown in FIG. 29, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2940 communicates with a further computing device via the communication medium. In addition, the functions of the components in the computing device 2900 can be implemented by a single computing cluster or multiple computing machines that can communicate via communication connections. Therefore, the computing device 2900 can operate in a networked environment using a logical connection with one or more other servers, networked personal computers (PCs) or further general network nodes.

The input device 2950 may be one or more of a variety of input devices, such as a mouse, keyboard, tracking ball, voice-input device, and the like. The output device 2960 may be one or more of a variety of output devices, such as a display, loudspeaker, printer, and the like. By means of the communication unit 2940, the computing device 2900 can further communicate with one or more external devices (not shown) such as the storage devices and display device, with one or more devices enabling the user to interact with the computing device 2900, or any devices (such as a network card, a modem and the like) enabling the computing device 2900 to communicate with one or more other computing devices, if required. Such communication can be performed via input/output (I/O) interfaces (not shown).

In some embodiments, instead of being integrated in a single device, some or all components of the computing device 2900 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2900 may be used to implement video encoding/decoding in embodiments of the present disclosure. The memory 2920 may include one or more video coding modules 2925 having one or more program instructions. These modules are accessible and executable by the processing unit 2910 to perform the functionalities of the various embodiments described herein.

In the example embodiments of performing video encoding, the input device 2950 may receive video data as an input 2970 to be encoded. The video data may be processed, for example, by the video coding module 2925, to generate an encoded bitstream. The encoded bitstream may be provided via the output device 2960 as an output 2980.

In the example embodiments of performing video decoding, the input device 2950 may receive an encoded bitstream as the input 2970. The encoded bitstream may be processed, for example, by the video coding module 2925, to generate decoded video data. The decoded video data may be provided via the output device 2960 as the output 2980.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

What is claimed is:

1. A method for video processing, comprising:
determining, for a conversion between a current video block of a video and a bitstream of the video, a usage of at least one of an interweaved affine prediction or a template matching affine based on at least one of: a slice type, a frame type, or a picture order count (POC) distance between a slice or a frame and its nearest reference frame; and
performing the conversion based on the usage of the at least one of the interweaved affine prediction or the template matching affine.

2. The method of claim 1, wherein reference pictures or reference frames or reference slices of to-be-coded pictures or frames or slices are collected from a forward direction in term of POC, the slice type of a current slice or the frame type of a current frame is a generalized P or B (GPB) slice or frame.

3. The method of claim 1, wherein for a generalized P or B (GPB) slice or frame, a POC distance between the GPB slice or frame and its nearest reference frame is larger than one or the GPB slice or frame is a GPB frame in random-access configuration case, and the at least one of the interweaved affine prediction or the template matching affine is not applied to the GPB slice or frame.

4. The method of claim 1, wherein for a generalized P or B (GPB) slice or frame, a POC distance between the GPB slice or frame and its nearest reference frame is larger than or smaller than a predefined value, and the at least one of the interweaved affine prediction or the template matching affine is applied to the GPB slice or frame.

5. The method of claim 1, wherein a video block or video unit comprises one of: a color component, a sub-picture, a slice, a tile, a coding tree unit (CTU), a CTU row, groups of CTUs, a coding unit (CU), a prediction unit (PU), a transform unit (TU), a coding tree block (CTB), a coding block (CB), a prediction block (PB), a transform block (TB), a block, a subblock of a block, a sub-region within a block, or a region containing more than one sample or pixel.

6. The method of claim 1, wherein whether to and/or how to apply an approach regarding at least one of: an interweave affine mode, a coding unit (CU) level overlapped block motion compensation (OBMC), a regression affine mode, or a subblock-based temporal motion vector prediction (SbTMVP) is based on a syntax element in the bitstream.

7. The method of claim 6, wherein the syntax element is at at least one of: a sequence level, a group of pictures level, a picture level, a slice level, or a tile group level, or
wherein the syntax element is included in at least one of: a sequence header, a picture header, a sequence parameter set (SPS), a video parameter set (VPS), a decoded parameter set (DPS), decoding capability information (DCI), a picture parameter set (PPS), an adaptation parameter set (APS), a slice header, or a tile group header.

8. The method of claim 1, wherein whether to and/or how to apply an approach regarding at least one of: an interweave affine mode, a coding unit (CU) level overlapped block motion compensation (OBMC), a regression affine mode, or a subblock-based temporal motion vector prediction (SbTMVP) is based on at least one of:
a message in the bitstream, a position of a video unit, a block dimension of the current video block, a block dimension of a neighboring block of the current video block, a block shape of the current video block, a block shape of a neighboring block of the current video block, a coded mode of a block, an indication of a color format, a coding tree structure, a slice or tile group type, a picture type, a color component, a temporal layer identifier (ID), or profiles or levels or tiers of a standard.

9. The method of claim 8, wherein the message is included in at least one of: a decoded parameter set (DPS), a sequence parameter set (SPS), a video parameter set (VPS), a picture parameter set (PPS), an adaptation parameter set (APS), a picture header, a slice header, a tile group header, a largest coding unit (LCU), a coding unit (CU), a LCU row, a group of LCUs, a transform unit (TU), a prediction unit (PU) block, or a video coding unit.

10. The method of claim 8, wherein the video unit comprises one of: a coding unit (CU), a prediction unit (PU), a transform unit (TU), a block or a video coding unit.

11. The method of claim 8, wherein the coded mode comprises at least one of: an intra block copy (IBC) mode, a non-IBC inter mode, or a non-IBC subblock mode.

12. The method of claim 8, wherein the color format comprises one of: a 4:2:0 format or a 4:4:4 format.

13. The method of claim 8, wherein the approach is applied to at least one of a chroma component or a luma component.

14. The method of claim 1, wherein the conversion comprises encoding the current video block into the bitstream.

15. The method of claim 1, wherein the conversion comprises decoding the current video block from the bitstream.

16. The method of claim 1, wherein the conversion comprises: generating the bitstream from the video, and
wherein the method further comprises: storing the bitstream in a non-transitory computer-readable recording medium.

17. An apparatus for video processing comprising a processor and a non-transitory memory with instructions thereon, wherein the instructions upon execution by the processor, cause the processor to:
determine, for a conversion between a current video block of a video and a bitstream of the video, information regarding applying a subblock-boundary based deblocking or filtering process to the current video block based on a slice type; and
perform the conversion based on the information,
wherein the information indicates at least one of: whether a kind of subblock-boundary based deblocking or filtering process is applied, or how the kind of subblock-boundary based deblocking or filtering process is applied.

18. The apparatus of claim 17, wherein reference pictures or reference frames or reference slices of to-be-coded pictures or frames or slices are collected from a forward direction in term of POC, the slice type of a current slice or the frame type of a current frame is a generalized P or B (GPB) slice or frame.

19. The apparatus of claim 17, wherein for a generalized P or B (GPB) slice or frame, a POC distance between the GPB slice or frame and its nearest reference frame is larger than one or the GPB slice or frame is a GPB frame in random-access configuration case, and the at least one of the interweaved affine prediction or the template matching affine is not applied to the GPB slice or frame.

20. A non-transitory computer-readable storage medium storing instructions that cause a processor to:
determine, for a conversion between a current video block of a video and a bitstream of the video, information regarding applying a subblock-boundary based deblocking or filtering process to the current video block based on a slice type; and
perform the conversion based on the information,
wherein the information indicates at least one of: whether a kind of subblock-boundary based deblocking or filtering process is applied, or how the kind of subblock-boundary based deblocking or filtering process is applied.
